(19) United States
(12) Patent Application Publication
(10) Pub. No.: US 2024/0383797 A1
(43) Pub. Date: Nov. 21, 2024

(54) LITHIUM-FREE ION EXCHANGEABLE GLASSES

(71) Applicant: CORNING INCORPORATED, CORNING, NY (US)

(72) Inventors: TIMOTHY MICHAEL GROSS, PAINTED POST, NY (US); ALEXANDRA LAI CHING KAO ANDREWS MITCHELL, ITHACA, NY (US)

(21) Appl. No.: 18/659,318

(22) Filed: May 9, 2024

Related U.S. Application Data
(60) Provisional application No. 63/542,818, filed on Oct. 6, 2023.
(60) Provisional application No. 63/467,386, filed on May 18, 2023.

(51) Int. Cl. C03C 3/097; C03C 21/00

(52) U.S. Cl. CPC C03C 3/097; C03C 21/002; C03C 2203/52

(57) ABSTRACT

A glass composition includes: from 50 mol % to 70 mol % SiO₂; from 15 mol % to 30 mol % Al₂O₃; from 5 mol % to 20 mol % Na₂O; from 0 mol % to 15 mol % MgO; and from 0 mol % to 15 mol % CaO. The glass composition is free or substantially free of Li (i.e., Li₂O). The sum of MgO and CaO in the glass composition may be from 0 mol % to 30 mol %.

### CROSS-REFERENCE TO RELATED APPLICATIONS

This application claims the benefit of priority under 35 U.S.C. § 119 of U.S. Provisional Application Ser. No. 63/542,818 filed on Oct. 6, 2023 and U.S. Provisional Application Ser. No. 63/467,386 filed on May 18, 2023, the contents of each of which are relied upon and incorporated herein by reference in their entireties.

### FIELD

The present specification generally relates to glass compositions and, in particular, to lithium-free or substantially lithium-free, ion exchangeable glass compositions having improved mechanical durability.

### TECHNICAL BACKGROUND

Glass articles, such as cover glasses, glass backplanes, housings, and the like, are employed in both consumer and commercial electronic devices, such as smart phones, smart watches, and tablets. The mobile nature of these portable devices makes the devices and the glass articles included therein particularly vulnerable to accidental drops on hard surfaces, such as the ground. Moreover, glass articles, such as cover glasses, may include “touch” functionality for which the glass article will be contacted by various objects including a user's fingers and/or stylus devices. Accordingly, desirably the glass articles are sufficiently robust to endure accidental dropping and regular contact without damage, such as scratching. Additionally, when dropped, the glass article may forcefully fragment, causing damage and negatively impacting the functionality of the device.

Accordingly, a continual need exists for glasses that have improved mechanical properties.

### SUMMARY

According to a first aspect, A1, a glass composition may comprise: greater than or equal to 50 mol % and less than or equal to 70 mol % SiO₂; greater than or equal to 15 mol % and less than or equal to 30 mol % Al₂O₃; greater than or equal to 5 mol % and less than or equal to 20 mol % Na₂O; greater than or equal to 0 mol % and less than or equal to 15 mol % MgO; and greater than or equal to 0 mol % and less than or equal to 15 mol % CaO, wherein the glass composition is free or substantially free of Li; and RO is greater than 0 mol % and less than or equal to 30 mol %, wherein RO is the sum of MgO and CaO.

A second aspect A2 includes the glass composition according to the first aspect A1, wherein the glass composition comprises greater than or equal to 16 mol % and less than or equal to 28 mol % Al₂O₃.

A third aspect A3 includes the glass composition according to either the first or second aspects A1-A2, wherein the glass composition comprises greater than or equal to 7 mol % and less than or equal to 18 mol % Na₂O.

A fourth aspect A4 includes the glass composition according to any of the first through third aspects A1-A3, wherein the glass composition comprises greater than 0 mol % and less than or equal to 13 mol % MgO.

A fifth aspect A5 includes the glass composition according to any of the first through fourth aspects A1-A4, wherein the glass composition comprises greater than 0 mol % and less than or equal to 13 mol % CaO.

A sixth aspect A6 includes the glass composition according to any of the first through fifth aspects A1-A5, wherein RO is greater than or equal to 1 mol % and less than or equal to 25 mol %.

A seventh aspect A7 includes the glass composition according to any of the first through sixth aspects A1-A6, wherein (Na₂O+RO)/Al₂O₃ is greater than or equal to 0.5 and less than or equal to 1.5.

An eighth aspect A8 includes the glass composition according to any of the first through seventh aspects A1-A7, wherein the glass composition comprises greater than 0 mol % and less than or equal to 5 mol % P₂O₅.

A ninth aspect A9 includes the glass composition according to any of the first through eighth aspects A1-A8, wherein the glass composition comprises greater than 0 mol % and less than or equal to 10 mol % Y₂O₃.

A tenth aspect A10 includes the glass composition according to any of the first through ninth aspects A1-A9, wherein the glass composition comprises greater than 0 mol % and less than or equal to 5 mol % ZrO₂.

An eleventh aspect A11 includes the glass composition according to any of the first through tenth aspects A1-A10, wherein the glass composition comprises greater than 0 mol % and less than or equal to 1 mol % SnO₂.

A twelfth aspect A12 includes the glass composition according to any of the first through eleventh aspects A1-A11, wherein the glass composition has a Young's Modulus greater than or equal to 60 GPa.

A thirteenth aspect A13 includes the glass composition according to any of the first through twelfth aspects A1-A12, wherein the glass composition has a fracture toughness greater than or equal to 0.75 MPa·m^{1/2}.

A fourteenth aspect A14 includes the glass composition according to any of the first through thirteenth aspects A1-A13, wherein the strain point is greater than or equal to 600° C.

According to a fifteenth aspect, A15, a glass article may comprise: greater than or equal to 50 mol % and less than or equal to 70 mol % SiO₂; greater than or equal to 15 mol % and less than or equal to 30 mol % Al₂O₃; greater than or equal to 5 mol % and less than or equal to 20 mol % Na₂O; greater than or equal to 0 mol % and less than or equal to 15 mol % MgO; and greater than or equal to 0 mol % and less than or equal to 15 mol % CaO, wherein the glass composition is free or substantially free of Li; and RO is greater than 0 mol % and less than or equal to 30 mol %, wherein RO is the sum of MgO and CaO.

A sixteenth aspect A16 includes the glass composition according to the fifteenth aspect A15, wherein the glass composition article greater than or equal to 16 mol % and less than or equal to 28 mol % Al₂O₃.

A seventeenth aspect A17 includes the glass composition according to either the fifteenth or sixteenth aspects A15-A16, wherein the glass article comprises greater than or equal to 7 mol % and less than or equal to 18 mol % Na₂O.

An eighteenth aspect A18 includes the glass composition according to any of the fifteenth through seventeenth aspects A15-A17, wherein the glass article comprises greater than 0 mol % and less than or equal to 13 mol % MgO.

A nineteenth aspect A19 includes the glass composition according to any of the fifteenth through eighteenth aspects A15-A18, wherein the glass article comprises greater than or equal to 0 mol % and less than or equal to 13 mol % CaO.

A twentieth aspect A20 includes the glass composition according to any of the fifteenth through nineteenth aspects A15-A19, wherein RO is greater than or equal to 1 mol % and less than or equal to 25 mol %.

A twenty-first aspect A21 includes the glass composition according to any of the fifteenth through twentieth aspects A15-A20, wherein (Na₂O+RO)/Al₂O₃ is greater than or equal to 0.5 and less than or equal to 1.5.

A twenty-second aspect A22 includes the glass composition according to any of the fifteenth through twenty-first aspects A15-A21, wherein the glass article comprises greater than 0 mol % and less than or equal to 2 mol % P₂O₅.

A twenty-third aspect A23 includes the glass composition according to any of the fifteenth through twenty-second aspects A15-A22, wherein the glass article comprises greater than 0 mol % and less than or equal to 10 mol % Y₂O₃.

A twenty-fourth aspect A24 includes the glass composition according to any of the fifteenth through twenty-third aspects A15-A23, wherein the glass article comprises greater than 0 mol % and less than or equal to 5 mol % ZrO₂.

A twenty-fifth aspect A25 includes the glass composition according to any of the fifteenth through twenty-fourth aspects A15-A24, wherein the glass article comprises greater than 0 mol % and less than or equal to 1 mol % SnO₂.

A twenty-sixth aspect A26 includes the glass composition according to any of the fifteenth through twenty-fifth aspects A15-A25, wherein the glass article is an ion exchanged glass article.

A twenty-seventh aspect A27 includes the glass composition according to the twenty-sixth aspect A26, wherein the ion exchanged glass article comprises a surface compressive stress greater than or equal to 350 MPa.

A twenty-eighth aspect A28 includes the glass composition according to either the twenty-sixth or twenty-seventh aspects A26-A27, wherein the glass article comprises a depth of compression greater than or equal to 80 μm.

A twenty-ninth aspect A29 includes the glass composition according to any of the twenty-sixth through twenty-eighth aspects A26-A28, wherein the glass article has a thickness t and comprises a depth of compression greater than or equal to 0.05 t.

A thirtieth aspect A30 includes the glass composition according to any of the twenty-sixth through twenty-ninth aspects A26-A29, wherein the ion exchanged glass article comprises a central tension greater than or equal to 75 MPa, as measured at an article thickness of 0.6 mm.

According to a thirty-first aspect, A31, a method of forming a glass article may comprise: heating a glass composition, the glass composition comprising: greater than or equal to 50 mol % and less than or equal to 70 mol % SiO₂; greater than or equal to 15 mol % and less than or equal to 30 mol % Al₂O₃; greater than or equal to 5 mol % and less than or equal to 20 mol % Na₂O; greater than or equal to 0 mol % and less than or equal to 15 mol % MgO; and greater than or equal to 0 mol % and less than or equal to 15 mol % CaO, wherein the glass composition is free or substantially free of Li; and RO is greater than 0 mol % and less than or equal to 30 mol %, wherein RO is the sum of MgO and CaO; and cooling the glass composition to form the glass article.

A thirty-second aspect A32 includes the method of forming a glass article according to the thirty-first aspect A31, further comprising strengthening the glass article in a first ion exchange bath at a temperature greater than or equal 500° C. for a time period greater than or equal to 1 hour and less than or equal to 32 hours to form an ion exchanged glass article.

A thirty-third aspect A33 includes the method of forming a glass article according to either the thirty-first or thirty-second aspects A31-A32, further comprising strengthening the glass article in a second ion exchange bath at a temperature greater than or equal to 300° C. for a time period greater than or equal to 1 hour and less than or equal to 32 hours to form an ion exchanged glass article.

A thirty-fourth aspect A34 includes the method of forming a glass article according to either the thirty-second or thirty-third aspects A32-A33, wherein the ion exchanged glass article comprises a surface compressive stress greater than or equal to 350 MPa.

A thirty-fifth aspect A35 includes the method of forming a glass article according to the thirty-fourth aspect A34, wherein the ion exchanged glass article comprises a surface compressive stress less than or equal to 900 MPa.

A thirty-sixth aspect A36 includes the method of forming a glass article according to any of the thirty-second through thirty-fifth aspects A32-A35, wherein the ion exchanged glass article comprises a depth of compression greater than or equal to 80 μm.

A thirty-seventh aspect A37 includes the method of forming a glass article according to any of the thirty-second through thirty-sixth aspects A32-A36, wherein the ion exchanged glass article has a thickness t and comprises a depth of compression greater than or equal to 0.05 t.

A thirty-eighth aspect A38 includes the method of forming a glass article according to any of the thirty-second through thirty-seventh aspects A32-A37, wherein the ion exchanged glass article comprises a central tension greater than or equal to 75 MPa, as measured at an article thickness of 0.6 mm.

A thirty-ninth aspect A39 includes the method of forming a glass article according to any of the thirty-third through thirty-eighth aspects A33-A38, wherein the first ion exchange bath, the second ion exchange bath, or both comprises KNO₃.

A fortieth aspect A40 includes the method of forming a glass article according to any of the thirty-third through thirty-ninth aspects A33-A39, wherein the first ion exchange bath, the second ion exchange bath, or both comprises NaNO₃.

According to a forty-first aspect A41, a glass composition may comprise: greater than or equal to 50 mol % and less than or equal to 70 mol % SiO₂; greater than or equal to 17 mol % and less than or equal to 30 mol % Al₂O₃; greater than or equal to 5 mol % and less than or equal to 20 mol % Na₂O; greater than 0 mol % and less than or equal to 15 mol % MgO; greater than or equal to 0 mol % and less than or equal to 15 mol % CaO; and greater than or equal to 0 mol % and less than or equal to 5 mol % P₂O₅, wherein the glass composition is free or substantially free of Li and Fe₂O₃; and RO is greater than 0 mol % and less than or equal to 30 mol %, wherein RO is the sum of MgO and CaO.

A forty-second aspect A42 includes the glass composition of the forty-first aspect A41, wherein the glass composition comprises greater than or equal to 17.5 mol % and less than or equal to 27 mol % Al₂O₃.

A forty-third aspect A43 includes the glass composition of the forty-first aspect A41 or the forty-second aspect A42, wherein the glass composition comprises greater than or equal to 0.1 mol % and less than or equal to 4 mol % P₂O₅.

A forty-fourth aspect A44 includes the glass composition according to any of the forty-first through forty-third aspects A41-A43, wherein the glass composition comprises greater than or equal to 5 mol % and less than or equal to 17 mol % Na₂O.

A forty-fifth aspect A45 includes the glass composition according to any of the forty-first through forty-fourth aspects A41-A44, wherein the glass composition comprises greater than or equal to 0.01 mol % and less than or equal to 13 mol % MgO.

A forty-sixth aspect A46 includes the glass composition according to any of the forty-first through forty-fifth aspects A41-A45, wherein the glass composition comprises greater than 0 mol % and less than or equal to 13 mol % CaO.

A forty-seventh aspect A47 includes the glass composition according to any of the forty-first through forty-sixth aspects A41-A46, wherein RO is greater than or equal to 1 mol % and less than or equal to 25 mol %.

A forty-eighth aspect A48 includes the glass composition according to any of the forty-first through forty-seventh aspects A41-A47, wherein (Na₂O+RO)/Al₂O₃ is greater than or equal to 0.25 and less than or equal to 1.5.

A forty-ninth aspect A49 includes the glass composition according to any of the forty-first through forty-eighth aspects A41-A48, wherein the glass composition comprises greater than 0 mol % and less than or equal to 10 mol % Y₂O₃.

A fiftieth aspect A50 includes the glass composition according to any of the forty-first through forty-ninth aspects A41-A49, wherein the glass composition comprises greater than 0 mol % and less than or equal to 5 mol % ZrO₂.

A fifty-first aspect A51 includes the glass composition according to any of the forty-first through fiftieth aspects A41-A50, wherein the glass composition comprises greater than 0 mol % and less than or equal to 1 mol % SnO₂.

A fifty-second aspect A52 includes the glass composition according to any of the forty-first through fifty-first aspects A41-A51, wherein the glass composition is free or substantially free or Er₂O₃.

A fifty-third aspect A53 includes the glass composition according to any of the forty-first through fifty-second aspects A41-A52, wherein the glass composition comprises greater than 0 mol % and less than or equal to 2 mol % K₂O.

A fifty-fourth aspect A54 includes the glass composition according to any of the forty-first through fifty-third aspects A41-A53, wherein the glass composition comprises greater than 0 mol % and less than or equal to 15 mol % ZnO.

A fifty-fifth aspect A55 includes the glass composition according to any of the forty-first through fifty-fourth aspects A41-A54, wherein the glass composition comprises greater than 0 mol % and less than or equal to 2.5 mol % SrO.

A fifty-sixth aspect A56 includes the glass composition according to any of the forty-first through fifty-fifth aspects A41-A55, wherein the glass composition comprises greater than 0 mol % and less than or equal to 2.5 mol % BaO.

A fifty-seventh aspect A57 includes the glass composition according to any of the forty-first through fifty-sixth aspects A41-A56, wherein the glass composition comprises greater than 0 mol % and less than or equal to 2 mol % TiO₂.

A fifty-eighth aspect A58 includes the glass composition according to any of the forty-first through fifty-seventh aspects A41-A57, wherein the glass composition has a Young's Modulus greater than or equal to 60 GPa.

A fifty-ninth aspect A59 includes the glass composition according to any of the forty-first through fifty-eighth aspects A41-A58, wherein the glass composition has a fracture toughness greater than or equal to 0.75 MPa·m^{1/2}.

A sixtieth aspect A60 includes the glass composition according to any of the forty-first through fifty-ninth aspects A41-A59, wherein the strain point is greater than or equal to 600° C.

According to a sixty-first aspect A61, a glass article may comprise: greater than or equal to 50 mol % and less than or equal to 70 mol % SiO₂; greater than or equal to 17 mol % and less than or equal to 30 mol % Al₂O₃; greater than or equal to 5 mol % and less than or equal to 20 mol % Na₂O; greater than 0 mol % and less than or equal to 15 mol % MgO; greater than or equal to 0 mol % and less than or equal to 15 mol % CaO; and greater than or equal to 0 mol % and less than or equal to 5 mol % P₂O₅, wherein the glass composition is free or substantially free of Li and Fe₂O₃; and RO is greater than 0 mol % and less than or equal to 30 mol %, wherein RO is the sum of MgO and CaO.

A sixty-second aspect A62 includes the glass article according to the sixty-first aspect A61, wherein the glass article comprises greater than or equal to 17.5 mol % and less than or equal to 27 mol % Al₂O₃.

A sixty-third aspect A63 includes the glass article according to the sixty-first aspect A61 or the sixty-second aspect A62, wherein the glass article comprises greater than or equal to 0.1 mol % and less than or equal to 4 mol % P₂O₅.

A sixty-fourth aspect A64 includes the glass article according to any of the sixty-first through sixty-third aspects A61-A63, wherein the glass article comprises greater than or equal to 5 mol % and less than or equal to 17 mol % Na₂O.

A sixty-fifth aspect A65 includes the glass article according to any of the sixty-first through sixty-fourth aspects A61-A64, wherein the glass article comprises greater than or equal to 0.01 mol % and less than or equal to 13 mol % MgO.

A sixty-sixth aspect A66 includes the glass article according to any of the sixty-first through sixty-fifth aspects A61-A65, wherein the glass article comprises greater than 0 mol % and less than or equal to 13 mol % CaO.

A sixty-seventh aspect A67 includes the glass article according to any of the sixty-first through sixty-sixth aspects A61-A66, wherein RO is greater than or equal to 1 mol % and less than or equal to 25 mol %.

A sixty-eighth aspect A68 includes the glass article according to any of the sixty-first through sixty-seventh aspects A61-A67, wherein (Na₂O+RO)/Al₂O₃ is greater than or equal to 0.25 and less than or equal to 1.5.

A sixty-ninth aspect A69 includes the glass article according to any of the sixty-first through sixty-eighth aspects A61-A68, wherein the glass article comprises greater than 0 mol % and less than or equal to 10 mol % Y₂O₃.

A seventieth aspect A70 includes the glass article according to any of the sixty-first through sixty-ninth aspects A61-A69, wherein the glass article comprises greater than 0 mol % and less than or equal to 5 mol % ZrO₂.

A seventy-first aspect A71 includes the glass article according to any of the sixty-first through seventieth aspects A61-A70, wherein the glass article comprises greater than 0 mol % and less than or equal to 1 mol % SnO₂.

A seventy-second aspect A72 includes the glass article according to any of the sixty-first through seventy-first aspects A61-A71, wherein the glass article is free or substantially free of Er₂O₃.

A seventy-third aspect A73 includes the glass article according to any of the sixty-first through seventy-second aspects A61-A72, wherein the glass article comprises greater than 0 mol % and less than or equal to 2 mol % K₂O.

A seventy-fourth aspect A74 includes the glass article according to any of the sixty-first through seventy-third aspects A61-A73, wherein the glass article comprises greater than 0 mol % and less than or equal to 15 mol % ZnO.

A seventy-fifth aspect A75 includes the glass article according to any of the sixty-first through seventy-fourth aspects A61-A74, wherein the glass article comprises greater than 0 mol % and less than or equal to 2.5 mol % SrO.

A seventy-sixth aspect A76 includes the glass article according to any of the sixty-first through seventy-fifth aspects A61-A75, wherein the glass article comprises greater than 0 mol % and less than or equal to 2.5 mol % BaO.

A seventy-seventh aspect A77 includes the glass article according to any of the sixty-first through seventy-sixth aspects A61-A76, wherein the glass article comprises greater than 0 mol % and less than or equal to 2 mol % TiO₂.

A seventy-eighth aspect A78 includes the glass article according to any of the sixty-first through seventy-seventh aspects A61-A77, wherein the glass article is an ion exchanged glass article.

A seventy-ninth aspect A79 includes the glass article according to the seventy-eighth aspect A78, wherein the ion exchanged glass article comprises a surface compressive stress greater than or equal to 350 MPa.

An eightieth aspect A80 includes the glass article according to the seventy-eighth aspect A78 or the seventy-ninth aspect A79, wherein the glass article comprises a depth of compression greater than or equal to 80 μm.

An eighty-first aspect A81 includes the glass article according to any of the seventy-eighth through eightieth aspects A78-A80, wherein the glass article has a thickness t and comprises a depth of compression greater than or equal to 0.05 t.

An eighty-second aspect A82 includes the glass article according to any of the seventy-eighth through eighty-first aspects A78-A81, wherein the ion exchanged glass article comprises a central tension greater than or equal to 75 MPa, as measured at an article thickness of 0.6 mm.

According to an eighty-third aspect A83, a method of forming a glass article may comprise: heating a glass composition, the glass composition comprising: greater than or equal to 50 mol % and less than or equal to 70 mol % SiO₂; greater than or equal to 17 mol % and less than or equal to 30 mol % Al₂O₃; greater than or equal to 5 mol % and less than or equal to 20 mol % Na₂O; greater than 0 mol % and less than or equal to 15 mol % MgO; greater than or equal to 0 mol % and less than or equal to 15 mol % CaO; and greater than or equal to 0 mol % and less than or equal to 5 mol % P₂O₅, wherein the glass composition is free or substantially free of Li and Fe₂O₃; and RO is greater than 0 mol % and less than or equal to 30 mol %, wherein RO is the sum of MgO and CaO; and cooling the glass composition to form the glass article.

An eighty-fourth aspect A84 includes the method according to the eighty-third aspect A83, further comprising strengthening the glass article in a first ion exchange bath at a temperature greater than or equal 500° C. for a time period greater than or equal to 1 hour and less than or equal to 32 hours to form an ion exchanged glass article.

An eighty-fifth aspect A85 includes the method according to the eighty-fourth aspect A84, further comprising strengthening the glass article in a second ion exchange bath at a temperature greater than or equal to 300° C. for a time period greater than or equal to 0.05 hour and less than or equal to 32 hours to form an ion exchanged glass article.

An eighty-sixth aspect A86 includes the method according to the eighty-fourth aspect A84 or the eighty-fifth aspect A85, wherein the ion exchanged glass article comprises a surface compressive stress greater than or equal to 350 MPa.

An eighty-seventh aspect A87 includes the method according to the eighty-sixth aspect A86, wherein the ion exchanged glass article comprises a surface compressive stress less than or equal to 900 MPa.

An eighty-eighth aspect A88 includes the method according to any of the eighty-fourth through eighty-seventh aspects A84-A87, wherein the ion exchanged glass article comprises a depth of compression greater than or equal to 80 μm.

An eighty-ninth aspect A89 includes the method according to any of the eighty-fourth through eighty-eighth aspects A84-A88, wherein the ion exchanged glass article has a thickness t and comprises a depth of compression greater than or equal to 0.05 t.

A ninetieth aspect A90 includes the method according to any of the eighty-fourth through eighty-ninth aspects A84-A89, wherein the ion exchanged glass article comprises a central tension greater than or equal to 75 MPa, as measured at an article thickness of 0.6 mm.

A ninety-first aspect A91 includes the method according to any of the eighty-fifth through ninetieth aspects A85-A90, wherein at least one of the first ion exchange bath and the second ion exchange bath comprises KNO₃, NaNO₃, Na₂SO₄, K₂SO₄, or combinations thereof.

Additional features and advantages of the glass compositions described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A is a representation of a non-frangible sample after a frangibility test;

FIG. 1B is another representation of a non-frangible sample after a frangibility test;

FIG. 2A is a representation of a borderline frangible sample after a frangibility test;

FIG. 2B is another representation of a borderline frangible sample after a frangibility test;

FIG. 3A is a representation of a frangible sample after a frangibility test;

FIG. 3B another representation of a frangible sample after a frangibility test;

FIG. 4 is a plan view of an electronic device incorporating any of the glass articles according to one or more embodiments described herein;

FIG. 5 is a perspective view of the electronic device of FIG. 4;

FIG. 6 is a plot of stress (y-axis: stress; in MPa) as a function of a depth of an ion exchanged glass article (x-axis: depth; in mm) made from a glass composition according to one or more embodiments described herein;

FIG. 7 is a plot of stress (y-axis: stress; in MPa) as a function of a depth of ion exchanged glass articles (x-axis: depth; in mm) made from comparative compositions and a glass composition, according to one or more embodiments described herein;

FIG. 8 is a plot of stress (y-axis: stress; in MPa) as a function of a depth of ion exchanged glass articles (x-axis: depth; in mm) made from glass compositions, according to one or more embodiments described herein;

FIG. 9A is a photograph of a glass made from a glass composition and subjected to a frangibility test, according to one or more embodiments described herein;

FIG. 9B is a photograph of a glass made from a glass composition and subjected to a frangibility test, according to one or more embodiments described herein;

FIG. 10 is a plot of stress (y-axis: stress; in MPa) as a function of a depth of an ion exchanged glass article (x-axis: depth; in mm) made from a glass composition, according to one or more embodiments described herein;

FIG. 11 is a photograph of a glass made from a glass composition and subjected to a frangibility test, according to one or more embodiments described herein;

FIG. 12 is a plot of stress (y-axis: stress; in MPa) as a function of a depth of an ion exchanged glass article (x-axis: depth; in mm) made from a glass composition, according to one or more embodiments described herein;

FIG. 13A is a photograph of a glass made from a glass composition and subjected to a frangibility test, according to one or more embodiments described herein;

FIG. 13B is a photograph of a glass made from a glass composition and subjected to a frangibility test, according to one or more embodiments described herein;

FIG. 14 is a plot of stress (y-axis: stress; in MPa) as a function of a depth of ion exchanged glass articles (x-axis: depth; in mm) made from glass compositions according to one or more embodiments described herein;

FIG. 15A is a photograph of a glass made from a glass composition and subjected to a frangibility test, according to one or more embodiments described herein;

FIG. 15B is a photograph of a glass made from a glass composition and subjected to a frangibility test, according to one or more embodiments described herein;

FIG. 16 is a plot of stress (y-axis: stress; in MPa) as a function of a depth of an ion exchanged glass article (x-axis: depth; in mm) made from a glass composition according to one or more embodiments described herein;

FIG. 17 is a plot of stress (y-axis: stress; in MPa) as a function of a depth of an ion exchanged glass article (x-axis: depth; in mm) made from a glass composition according to one or more embodiments described herein;

FIG. 18 is a photograph of a glass made from a glass composition and subjected to a frangibility test, according to one or more embodiments described herein; and

FIG. 19 is a plot of stress (y-axis: stress; in MPa) as a function of a depth of ion exchanged glass articles (x-axis: depth; in mm) made from glass compositions according to one or more embodiments described herein.

### DETAILED DESCRIPTION

Reference will now be made in detail to various embodiments of ion exchangeable glass compositions having improved mechanical durability. According to embodiments, a glass composition may comprise greater than or equal to 50 mol % and less than or equal to 70 mol % SiO₂; greater than or equal to 15 mol % and less than or equal to 30 mol % Al₂O₃; greater than or equal to 5 mol % and less than or equal to 20 mol % Na₂O; greater than or equal to 0 mol % and less than or equal to 15 mol % MgO; and greater than or equal to 0 mol % and less than or equal to 15 mol % CaO. The glass composition is free or substantially free of Li. RO (i.e., MgO+CaO) is greater than 0 mol % and less than or equal to 30 mol %. Various embodiments of ion exchangeable glass compositions and glass articles formed therefrom will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass compositions and resultant glass articles described herein, the concentrations of constituent components (i.e., SiO₂, Al₂O₃, and the like) are specified in mole percent (mol %) on an oxide basis, unless otherwise specified.

The term “substantially free,” when used to describe the concentration and/or absence of a particular constituent component in a glass composition and the resultant glass article, means that the constituent component is not intentionally added to the glass composition and the resultant glass article. However, the glass composition and the resultant glass article may contain traces of the constituent component as a contaminant or tramp in amounts of less than 0.05 weight percent (wt %). As noted herein, the remainder of the application specifies the concentrations of constituent component in mol %. The contaminant or tramp amounts of the constituent components are listed in wt % for manufacturing purposes and one skilled in the art would understand the contaminant and tramp amounts being listed in wt %.

The terms “0 mol %” and “free,” when used to describe the concentration and/or absence of a particular constituent component in a glass composition and the resultant glass article, means that the constituent component is not present in glass composition and the resultant glass article.

Fracture toughness (K_{IC}) represents the ability of a glass composition to resist fracture. Fracture toughness is measured on a non-strengthened glass article, such as measuring the K_{IC} value prior to ion exchange treatment of the glass article, thereby representing a feature of a glass article prior to ion exchange. The fracture toughness test methods described herein are not suitable for glasses that have been exposed to ion exchange treatment. But, fracture toughness measurements performed as described herein on the same glass article prior to ion exchange treatment correlate to fracture toughness after ion exchange treatment, and are accordingly used as such. The chevron notched short bar (CNSB) method utilized to measure the K_{IC} value is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*m is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Unless otherwise specified, all fracture toughness values were measured by chevron notched short bar (CNSB) method.

Density, as described herein, is measured by the buoyancy method of ASTM C693-93.

The term “coefficient of thermal expansion” and “CTE,” as described herein, is measured in accordance with ASTM E228-85 over the temperature range of 0° C. to 300° C. and is expressed in terms of “×10⁻⁷/° C.”

The term “strain point,” as used herein, refers to the temperature at which the viscosity of the glass composition is 1×10^{14.68} poise as measured in accordance with ASTM C598.

The term “melting point,” as used herein, refers to the temperature at which the viscosity of the glass composition is 200 poise as measured as described below with respect to the Vogel-Fulcher-Tamman relation.

The term “softening point,” as used herein, refers to the temperature at which the viscosity of the glass composition is 1×10^{7.6} poise. The softening point is measured according to the parallel plate viscosity method which measures the viscosity of inorganic glass from 10⁷ to 10⁹ poise as a function of temperature, similar to ASTM C1351M.

The term “annealing point” or “effective annealing temperature” as used herein, refers to the temperature at which the viscosity of the glass composition is 1×10^{13.18} poise as measured in accordance with ASTM C598.

The elastic modulus (also referred to as Young's modulus) of the glass composition, as described herein, is provided in units of gigapascals (GPa) and is measured in accordance with ASTM C623.

The shear modulus of the glass composition, as described herein, is provided in units of gigapascals (GPa). The shear modulus of the glass composition is measured in accordance with ASTM C623.

Poisson's ratio, as described herein, is measured in accordance with ASTM C623.

Refractive index, as described herein, is measured in accordance with ASTM E1967.

Surface compressive stress is measured with a surface stress meter (FSM) such as commercially available instruments such as the FSM-6000, manufactured by Orihara Industrial Co., Ltd. (Japan). Surface stress measurements rely upon the measurement of the stress optical coefficient (SOC), which is related to the birefringence of the glass article. SOC, in turn, is measured according to Procedure C (Glass Disc Method) described in ASTM standard C770-16, entitled “Standard Test Method for Measurement of Glass Stress-Optical Coefficient,” the contents of which are incorporated herein by reference in their entirety. The central tension (CT) values are measured using a SCALP technique known in the art. The values reported for central tension (CT) herein refer to the central tension at half the thickness of the glass, unless otherwise indicated.

In the figures, compression or compressive stress (CS) is expressed as a positive (i.e., >0) stress, and tension or tensile stress or central tension (CT) is expressed as a negative (i.e., <0) stress. Throughout this description, however, when particular values are given, CS and CT may be expressed as positive or absolute values (i.e., as recited herein, CS=|CS|, and CT=|CT|).

As used herein, “depth of compression” (DOC) refers to the depth at which the stress within the glass article changes from compressive to tensile. At the DOC, the stress crosses from a compressive stress to a tensile stress and thus exhibits a stress value of zero. DOC values given herein are measured using the refracted near-field (RNF) method, unless otherwise indicated. Depth of compression may be measured using a Scattered Light Polariscope (SCALP), such as a SCALP-05 portable scattered light polariscope.

When the RNF method is utilized to measure the stress profile, the CT value provided by SCALP is utilized in the RNF method. In particular, the stress profile measured by RNF is force balanced and calibrated to the CT value provided by a SCALP measurement. The RNF method is described in U.S. Pat. No. 8,854,623, entitled “Systems and methods for measuring a profile characteristic of a glass sample”, which is incorporated herein by reference in its entirety. In particular, the RNF method includes placing the glass article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal.

As used herein, “depth of layer” (DOL) refers to the depth within a glass article at which an ion of metal oxide diffuses into the glass article where the concentration of the ion reaches a minimum value. DOL values given herein are measured using a surface stress meter (FSM) such as commercially available instruments such as the FSM-6000.

As used herein, the term “knee region” refers to a part of a stress profile of an ion exchanged glass article that starts at the first slope change in the compressive stress region and ends at the depth where the stress changes from compressive stress to tensile stress.

As used herein, the term “knee” refers to the depth of an ion exchanged glass at which the knee region begins.

As used herein, the term “knee stress” refers to the stress at which the knee region begins.

The term “Vogel-Fulcher-Tamman (‘VFT’) relation,” as used herein, describes the temperature dependence of the viscosity and is represented by the following equation:

$$log η = A + \frac{B}{T - {T}_{o}}$$

where η is viscosity. To determine VFT A, VFT B, and VFT Tₒ, the viscosity of the glass composition is measured over a given temperature range. The raw data of viscosity versus temperature is then fit with the VFT equation by least-squares fitting to obtain A, B, and Tₒ. With these values, a viscosity point (i.e., 200 P Temperature (“melting point”), 35,000 P Temperature, and 200,000 P Temperature) at any temperature above softening point may be calculated.

The term “liquidus viscosity,” as used herein, refers to the viscosity of the glass composition at the onset of devitrification (i.e., at the liquidus temperature as determined with the gradient furnace method according to ASTM C829-81).

The term “liquidus temperature,” as used herein, refers to the temperature at which the glass composition begins to devitrify as determined with the gradient furnace method according to ASTM C829-81.

As used herein, the “frangibility limit” refers to the central tension or stored strain energy above which the glass article exhibits frangible behavior. “Frangibility” or “frangible behavior” refers to specific fracture behavior when a material is subjected to an impact or insult. As utilized herein, a glass article is considered “non-frangible” when it exhibits no branching in a test area as a result of a frangibility test. As utilized herein, a branch originates at the impact point, and a fragment is considered to be within the test area is any part of the fragment extends into the test area. The fragments, bifurcations, and branches are counted based on any 25 mm by 25 mm square centered on the impact point. Thus, a glass article is considered non-frangible if it does not show any branching for any 25 mm by 25 mm square centered on the impact point where the breakage is created according to the procedure described below. A glass article is considered “borderline frangible” or close to the frangibility limit if a glass article shows less than or equal to 5 braches for any 25 mm by 25 mm square centered on the impact point. A glass article is considered “frangible” if a glass article shows more than 5 branches for any 25 mm by 25 mm square centered on the impact point. In a frangibility test, an impact probe is brought in to contact with the multi-phase glass, with the depth to which the impact probe extends into the multi-phase glass increasing in successive contact iterations. The step-wise increase in depth of the impact probe allows the flaw produced by the impact probe to reach the tension region while preventing the application of excessive external force that would prevent the accurate determination of the frangible behavior of the glass article. In embodiments, the depth of the impact probe in the multi-phase glass may increase by about 5 μm in each iteration, with the impact probe being removed from contact with the glass article between each iteration. The test area is any 25 mm by 25 mm square centered at the impact point. While coatings, adhesive layers, and the like may be used in conjunction with the multi-phase glass described herein, such external restraints are not used in determining the frangibility or frangible behavior of the multi-phase glass. In embodiments, a film that does not affect the fracture behavior of the multi-phase glass may be applied to the multi-phase glass prior to the frangibility test to prevent the ejection of fragments from the multi-phase glass.

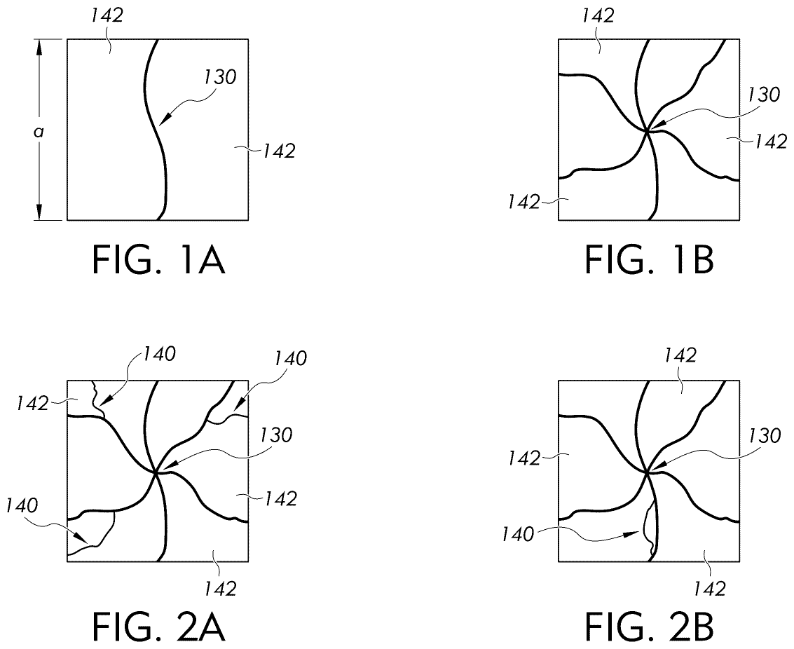

FIG. 1A depicts a non-frangible test result. As shown in FIG. 1A, the test area is a square that is centered at the impact point 130, where the length of a side of the square a is 25 mm. The sample shown in FIG. 1A includes two fragments 142 and no branches. Since the sample shown in FIG. 1A does not have any branches, it is considered non-frangible.

FIG. 1B depicts another non-frangible test result. As shown in FIG. 1B, the non-frangible sample is centered at the impact point 130 and includes six fragments 142 and no branches. Since the sample shown in FIG. 1B contains no branches, it is considered non-frangible.

A borderline frangible sample is depicted in FIG. 2A. The sample shown in FIG. 2A is centered at the impact point 130 and includes nine fragments 142 and three branches 140. Since the sample shown in FIG. 2A contains five or less branches, it is considered borderline frangible.

Another borderline frangible sample is depicted in FIG. 2B. As shown in FIG. 2B, the sample is centered at the impact point 130 and includes seven fragments 142 and one branch 140. Since the sample shown in FIG. 2B contains five or less branches, is considered borderline frangible.

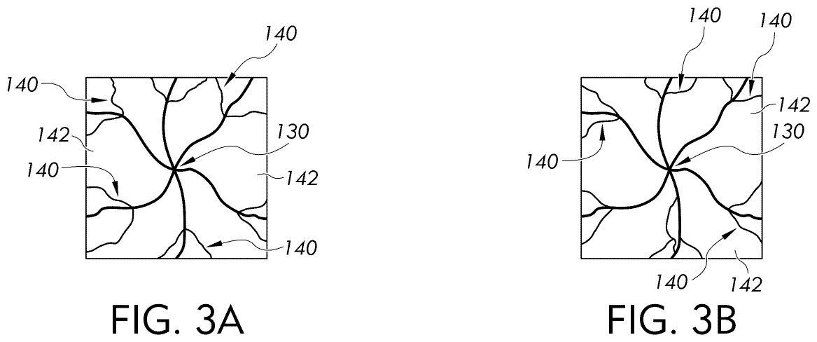

A frangible sample is depicted in FIG. 3A. The sample is centered at the impact point 130 and includes seventeen fragments 142 having twelve branches 140. Since the sample shown in FIG. 3A contains more than 5 branches, it is considered frangible.

Another frangible sample is depicted in FIG. 3B. The sample is centered at the impact point 130 and includes nineteen fragments 142 having twelve crack branches 140. Since the sample depicted in FIG. 3B contains more than 5 branches, the sample is considered frangible.

In the frangibility test described herein, the impact is delivered to the surface of the glass article with a force that is just sufficient to release the internally stored energy present within the strengthened glass article. That is, the point impact force is sufficient to create at least one new crack at the surface of the strengthened glass sheet and extend the crack through the compressive stress layer into the region that is under central tension (CT).

Chemical strengthening processes have been used to achieve high strength and high toughness in alkali silicate glasses. For example, Li₂O, which has a relatively high field strength as compared to other alkali oxides such as Na₂O, may be included in the glass compositions to impart relatively higher Young's modulus and fracture toughness and enable ion exchangeability. However, lithium prices are increasing due to the rapid adoption of electric vehicles.

Disclosed herein are glass compositions and glass articles formed therefrom which mitigate the aforementioned problems. Specifically, the glass compositions and the resultant glass articles disclosed herein are lithium-free or substantially lithium-free and comprise Na₂O, Al₂O₃ and alkaline earth oxides (i.e., MgO and CaO), which results in ion exchangeable glass compositions having improved Young's modulus and fracture toughness.

The glass compositions and resultant glass articles described herein may be described as aluminosilicate glass compositions and articles and comprise SiO₂ and Al₂O₃. The glass compositions and resultant glass articles described herein also include alkaline earth oxides (i.e., MgO and/or CaO) to increase Young's modulus and/or fracture toughness. The glass compositions and resultant glass articles described herein are free or substantially free of Li and instead include Na₂O to enable the ion exchangeability of the glass compositions.

SiO₂ is the primary glass former in the glass compositions described herein and may function to stabilize the network structure of the glass articles. The concentration of SiO₂ in the glass compositions and resultant glass articles should be sufficiently high (i.e., greater than or equal to 50 mol %) to provide basic glass forming capability. The amount of SiO₂ may be limited (i.e., less than or equal to 70 mol %) to control the liquidus temperature of the glass composition, as the liquidus temperature of pure SiO₂ or high SiO₂ glasses is undesirably high. Thus, limiting the concentration of SiO₂ may aid in improving the meltability and the formability of the resulting glass article.

Accordingly, in embodiments, the glass composition and resultant glass article may comprise greater than or equal to 50 mol % and less than or equal to 70 mol % SiO₂. In embodiments, the concentration of SiO₂ in the glass composition and the resultant glass article may be greater than or equal to 50 mol %, greater than or equal to 52 mol %, or even greater than or equal to 54 mol %. In embodiments, the concentration of SiO₂ in the glass composition and the resultant glass article may be less than or equal to 70 mol %, less than or equal to 67 mol %, less than or equal to 65 mol %, or even less than or equal to 63 mol %. In embodiments, the concentration of SiO₂ in the glass composition and the resultant glass article may be greater than or equal to 50 mol % and less than or equal to 70 mol %, greater than or equal to 50 mol % and less than or equal to 67 mol %, greater than or equal to 50 mol % and less than or equal to 65 mol %, greater than or equal to 50 mol % and less than or equal to 63 mol %, greater than or equal to 52 mol % and less than or equal to 70 mol %, greater than or equal to 52 mol % and less than or equal to 67 mol %, greater than or equal to 52 mol % and less than or equal to 65 mol %, greater than or equal to 52 mol % and less than or equal to 63 mol %, greater than or equal to 54 mol % and less than or equal to 70 mol %, greater than or equal to 54 mol % and less than or equal to 67 mol %, greater than or equal to 54 mol % and less than or equal to 65 mol %, or even greater than or equal to 54 mol % and less than or equal to 63 mol %, or any and all sub-ranges formed from any of these endpoints.

Like SiO₂, Al₂O₃ may also stabilize the glass network and additionally provides improved mechanical properties and chemical durability to the resulting glass article. The amount of Al₂O₃ may also be tailored to the control the viscosity of the glass composition. The concentration of Al₂O₃ should be sufficiently high (i.e., greater than or equal to 15 mol %) such that the glass composition and the resultant glass article have the desired Young's Modulus (i.e., greater than or equal to 60 GPa) and the desired fracture toughness (greater than or equal to 0.75 MPa·m^{1/2}). However, if the amount of Al₂O₃ is too high (i.e., greater than 30 mol %), the viscosity of the melt may increase, thereby diminishing the formability of the glass composition. In embodiments, the glass composition and resultant glass article may comprise greater than or equal to 15 mol % and less than or equal to 30 mol % Al₂O₃. In embodiments, the glass composition and resultant glass article may comprise greater than or equal to 16 mol % and less than or equal to 28 mol % Al₂O₃. In embodiments, the concentration of Al₂O₃ in the glass composition and resultant glass article may be greater than or equal to 15 mol %, greater than or equal to 16 mol %, greater than or equal to 17 mol %, or even greater than or equal to 18 mol %. In embodiments, the concentration of Al₂O₃ in the glass composition and the resultant glass article may be less than or equal 30 mol %, less than or equal to 27 mol %, less than or equal to 24 mol %, or even less than or equal to 21 mol %. In embodiments, the concentration of Al₂O₃ in the glass composition and the resultant glass article may be greater than or equal 15 mol % and less than or equal to 30 mol %, greater than or equal 15 mol % and less than or equal to 27 mol %, greater than or equal 15 mol % and less than or equal to 24 mol %, greater than or equal 15 mol % and less than or equal to 21 mol %, greater than or equal 16 mol % and less than or equal to 30 mol %, greater than or equal 16 mol % and less than or equal to 27 mol %, greater than or equal 16 mol % and less than or equal to 24 mol %, greater than or equal 16 mol % and less than or equal to 21 mol %, greater than or equal 17 mol % and less than or equal to 30 mol %, greater than or equal 17 mol % and less than or equal to 27 mol %, greater than or equal 17 mol % and less than or equal to 24 mol %, greater than or equal 17 mol % and less than or equal to 21 mol %, greater than or equal 18 mol % and less than or equal to 30 mol %, greater than or equal 18 mol % and less than or equal to 27 mol %, greater than or equal 18 mol % and less than or equal to 24 mol %, or even greater than or equal 18 mol % and less than or equal to 21 mol %, or any and all sub-ranges formed from any of these endpoints.

In embodiments, the glass composition and resultant glass article may comprise greater than or equal to 17 mol % and less than or equal to 30 mol % Al₂O₃. In embodiments, the glass composition and resultant glass article may comprise greater than or equal to 17.5 mol % and less than or equal to 27 mol % Al₂O₃. In embodiments, the concentration of Al₂O₃ in the glass composition and resultant glass article may be greater than or equal to 17 mol %, greater than or equal to 17.5 mol %, or even greater than or equal to 18 mol %. In embodiments, the concentration of Al₂O₃ in the glass composition and the resultant glass article may be less than or equal 30 mol %, less than or equal to 27 mol %, less than or equal to 24 mol %, or even less than or equal to 21 mol %. In embodiments, the concentration of Al₂O₃ in the glass composition and the resultant glass article may be greater than or equal 17 mol % and less than or equal to 30 mol % Al₂O₃, greater than or equal to 17 mol % and less than or equal to 27 mol % Al₂O₃, greater than or equal to 17 mol % and less than or equal to 24 mol % Al₂O₃, greater than or equal to 17 mol % and less than or equal to 21 mol % Al₂O₃, greater than or equal to 17.5 mol % and less than or equal to 30 mol % Al₂O₃, greater than or equal to 17.5 mol % and less than or equal to 27 mol % Al₂O₃, greater than or equal to 17.5 mol % and less than or equal to 24 mol % Al₂O₃, greater than or equal to 17.5 mol % and less than or equal to 21 mol % Al₂O₃, greater than or equal to 18 mol % and less than or equal to 30 mol % Al₂O₃, greater than or equal to 18 mol % and less than or equal to 27 mol % Al₂O₃, greater than or equal to 18 mol % and less than or equal to 24 mol % Al₂O₃, or even greater than or equal to 18 mol % and less than or equal to 21 mol % Al₂O₃, or any and all sub-ranges formed from any of these endpoints.

As described hereinabove, the glass compositions and the resultant glass articles may contain alkali oxides, such as Na₂O, to enable the ion exchangeability of the glass compositions. Na₂O aids in the ion exchangeability of the glass composition. In embodiments, the glass composition and the resultant glass article may comprise greater than or equal to 5 mol % and less than or equal to 20 mol % Na₂O. In embodiments, the glass composition and the resultant glass article may comprise greater than or equal to 7 mol % and less than or equal to 18 mol % Na₂O. In embodiments, the concentration of Na₂O in the glass composition and the resultant glass article may be greater than or equal to 5 mol %, greater than or equal to 6 mol %, greater than or equal to 7 mol %, greater than or equal to 8 mol %, or even greater than or equal to 9 mol %. In embodiments, the concentration of Na₂O in the glass composition and the resultant glass article may be less than or equal to 20 mol %, less than or equal to 18 mol % or even less than or equal to 16 mol %. In embodiments, the concentration of Na₂O in the glass composition and the resultant glass article may be greater than or equal to 5 mol % and less than or equal to 20 mol %, greater than or equal to 5 mol % and less than or equal to 18 mol %, greater than or equal to 5 mol % and less than or equal to 16 mol %, greater than or equal to 6 mol % and less than or equal to 20 mol %, greater than or equal to 6 mol % and less than or equal to 18 mol %, greater than or equal to 6 mol % and less than or equal to 16 mol %, greater than or equal to 7 mol % and less than or equal to 20 mol %, greater than or equal to 7 mol % and less than or equal to 18 mol %, greater than or equal to 7 mol % and less than or equal to 16 mol %, greater than or equal to 8 mol % and less than or equal to 20 mol %, greater than or equal to 8 mol % and less than or equal to 18 mol %, greater than or equal to 8 mol % and less than or equal to 16 mol %, greater than or equal to 9 mol % and less than or equal to 20 mol %, greater than or equal to 9 mol % and less than or equal to 18 mol %, or even greater than or equal to 9 mol % and less than or equal to 16 mol %, or any and all sub-ranges formed from any of these endpoints.

In embodiments, the glass composition and the resultant glass article may comprise greater than or equal to 5 mol % and less than or equal to 17 mol % Na₂O. In embodiments, the concentration of Na₂O in the glass composition and the resultant glass article may be greater than or equal to 5 mol %, greater than or equal to 6 mol %, greater than or equal to 7 mol %, greater than or equal to 8 mol %, or even greater than or equal to 9 mol %. In embodiments, the concentration of Na₂O in the glass composition and the resultant glass article may be less than or equal to 20 mol %, less than or equal to 17 mol %, or even less than or equal to 15 mol %. In embodiments, the concentration of Na₂O in the glass composition and the resultant glass article may be greater than or equal to 5 mol % and less than or equal to 20 mol %, greater than or equal to 5 mol % and less than or equal to 17 mol %, greater than or equal to 5 mol % and less than or equal to 15 mol %, greater than or equal to 6 mol % and less than or equal to 20 mol %, greater than or equal to 6 mol % and less than or equal to 17 mol %, greater than or equal to 6 mol % and less than or equal to 15 mol %, greater than or equal to 7 mol % and less than or equal to 20 mol %, greater than or equal to 7 mol % and less than or equal to 17 mol %, greater than or equal to 7 mol % and less than or equal to 15 mol %, greater than or equal to 8 mol % and less than or equal to 20 mol %, greater than or equal to 8 mol % and less than or equal to 17 mol %, greater than or equal to 8 mol % and less than or equal to 15 mol %, greater than or equal to 9 mol % and less than or equal to 20 mol %, greater than or equal to 9 mol % and less than or equal to 17 mol %, or even greater than or equal to 9 mol % and less than or equal to 15 mol %, or any and all sub-ranges formed from any of these endpoints.

In embodiments, the glass compositions and the resultant glass articles may contain other alkali oxides, such as K₂O, to enable ion exchangeability, increase diffusivity, and lower liquidus temperature. In embodiments, the glass composition and the resultant glass article may comprise greater than or equal to 0 mol % and less than or equal to 2 mol % K₂O. In embodiments, the concentration of K₂O in the glass composition and the resultant glass article may be greater than or equal to 0 mol %, greater than or equal to 0.05 mol %, greater than or equal to 0.1 mol %, greater than or equal to 0.25 mol %, or even greater than or equal to 0.5 mol %. In embodiments, the concentration of K₂O in the glass composition and the resultant glass article may be less than or equal to 2 mol %, less than or equal to 1.5 mol %, less than or equal to 1 mol %, or even less than or equal to 0.5 mol %. In embodiments, the concentration of K₂O in the glass composition and the resultant glass article may be greater than or equal to 0 mol % and less than or equal to 2 mol %, greater than or equal to 0 mol % and less than or equal to 1.5 mol %, greater than or equal to 0 mol % and less than or equal to 1 mol %, greater than or equal to 0 mol % and less than or equal to 0.5 mol %, greater than or equal to 0.05 mol % and less than or equal to 2 mol %, greater than or equal to 0.05 mol % and less than or equal to 1.5 mol %, greater than or equal to 0.05 mol % and less than or equal to 1 mol %, greater than or equal to 0.05 mol % and less than or equal to 0.5 mol %, greater than or equal to 0.1 mol % and less than or equal to 2 mol %, greater than or equal to 0.1 mol % and less than or equal to 1.5 mol %, greater than or equal to 0.1 mol % and less than or equal to 1 mol %, greater than or equal to 0.1 mol % and less than or equal to 0.5 mol %, greater than or equal to 0.25 mol % and less than or equal to 2 mol %, greater than or equal to 0.25 mol % and less than or equal to 1.5 mol %, greater than or equal to 0.25 mol % and less than or equal to 1 mol %, greater than or equal to 0.25 mol % and less than or equal to 0.5 mol %, greater than or equal to 0.5 mol % and less than or equal to 2 mol %, greater than or equal to 0.5 mol % and less than or equal to 1.5 mol %, or even greater than or equal to 0.5 mol % and less than or equal to 1 mol %, or any and all sub-ranges formed from any of these endpoints. In embodiments, the glass composition and the resultant glass article may be free or substantially free of K₂O.

As described hereinabove, the glass compositions and the resultant glass article may contain alkaline earth oxides (i.e., MgO and/or CaO) to increase Young's modulus and/or fracture toughness. RO is the sum (in mol %) of MgO and CaO present in the glass composition and the resultant glass article (i.e., RO=MgO (mol %)+CaO (mol %)). These alkaline earth oxides aid in lowering the viscosity of a glass composition, which enhances the formability. Compared to the alkali oxide components, the alkaline earth oxides increase the strain point, the Young's modulus, and the fracture toughness. The alkaline earth oxides may also improve the ion exchangeability. However, when too much of these alkali oxides are added to the glass composition, the diffusivity of sodium ions in the resultant glass article decreases which, in turn, adversely impacts the ion exchange performance (i.e., the ability to ion exchange) of the resultant glass article.

In embodiments, the concentration of RO in the glass composition and the resultant glass article may be greater 0 mol % and less than or equal to 30 mol %. In embodiments, the concentration of RO in the glass composition and the resultant glass article may be greater than or equal to 1 mol % and less than or equal to 25 mol %. In embodiments, the concentration of RO in the glass composition and the resultant glass article may be greater than 0 mol %, greater than or equal to 1 mol %, greater than or equal to 3 mol %, greater than or equal to 5 mol %, or even greater than or equal to 7 mol %. In embodiments, the concentration of RO in the glass composition and the resultant glass article may be less than or equal to 30 mol %, less than or equal to 20 mol %, or even less than or equal to 15 mol %. In embodiments, the concentration of RO in the glass composition and the resultant glass article may be greater than 0 mol % and less than or equal to 30 mol %, greater than 0 mol % and less than or equal to 20 mol %, greater than 0 mol % and less than or equal to 15 mol %, greater than or equal to 1 mol % and less than or equal to 30 mol %, greater than or equal to 1 mol % and less than or equal to 20 mol %, greater than or equal to 1 mol % and less than or equal to 15 mol %, greater than or equal to 3 mol % and less than or equal to 30 mol %, greater than or equal to 3 mol % and less than or equal to 20 mol %, greater than or equal to 3 mol % and less than or equal to 15 mol %, greater than or equal to 5 mol % and less than or equal to 30 mol %, greater than or equal to 5 mol % and less than or equal to 20 mol %, greater than or equal to 5 mol % and less than or equal to 15 mol %, greater than or equal to 7 mol % and less than or equal to 30 mol %, greater than or equal to 7 mol % and less than or equal to 20 mol %, or even greater than or equal to 7 mol % and less than or equal to 15 mol %, or any and all sub-ranges formed from any of these endpoints.

In embodiments, the glass composition and the resultant glass article may comprise greater than or equal to 0 mol % and less than or equal to 15 mol % MgO. In embodiments, the glass composition and the resultant glass article may comprise greater than 0 mol % and less than or equal to 13 mol % MgO. In embodiments, the concentration of MgO in the glass composition and the resultant glass article may be greater than or equal to 0 mol %, greater than or equal to 0.01 mol %, greater than or equal to 0.1 mol %, greater than or equal to 0.5 mol %, greater than or equal to 3 mol %, or even greater than or equal to 5 mol %. In embodiments, the concentration of MgO in the glass composition and the resultant glass article may be less than or equal to 15 mol %, less than or equal to 13 mol %, less than or equal to 10 mol %, less than or equal to 7 mol %, or even less than or equal to 5 mol %. In embodiments, the concentration of MgO in the glass composition and the resultant glass article may be greater than or equal to 0 mol % and less than or equal to 15 mol %, greater than or equal to 0 mol % and less than or equal to 13 mol %, greater than or equal to 0 mol % and less than or equal to 10 mol %, greater than or equal to 0 mol % and less than or equal to 7 mol %, greater than or equal to 0 mol % and less than or equal to 5 mol %, greater than or equal to 0.01 mol % and less than or equal to 15 mol %, greater than or equal to 0.01 mol % and less than or equal to 13 mol %, greater than or equal to 0.01 mol % and less than or equal to 10 mol %, greater than or equal to 0.01 mol % and less than or equal to 7 mol %, greater than or equal to 0.01 mol % and less than or equal to 5 mol %, greater than or equal to 0.1 mol % and less than or equal to 15 mol %, greater than or equal to 0.1 mol % and less than or equal to 13 mol %, greater than or equal to 0.1 mol % and less than or equal to 10 mol %, greater than or equal to 0.1 mol % and less than or equal to 7 mol %, greater than or equal to 0.1 mol % and less than or equal to 5 mol %, greater than or equal to 0.5 mol % and less than or equal to 15 mol %, greater than or equal to 0.5 mol % and less than or equal to 13 mol %, greater than or equal to 0.5 mol % and less than or equal to 10 mol %, greater than or equal to 0.5 mol % and less than or equal to 7 mol %, greater than or equal to 0.5 mol % and less than or equal to 5 mol %, greater than or equal to 3 mol % and less than or equal to 15 mol %, greater than or equal to 3 mol % and less than or equal to 13 mol %, greater than or equal to 3 mol % and less than or equal to 10 mol %, greater than or equal to 3 mol % and less than or equal to 7 mol %, greater than or equal to 3 mol % and less than or equal to 5 mol %, greater than or equal to 5 mol % and less than or equal to 15 mol %, greater than or equal to 5 mol % and less than or equal to 13 mol %, greater than or equal to 5 mol % and less than or equal to 10 mol %, or even greater than or equal to 5 mol % and less than or equal to 7 mol %, or any and all sub-ranges formed from any of these endpoints. In embodiments, the glass composition and the resultant glass article may be free or substantially free of MgO.

In embodiments, the glass composition and the resultant glass article may comprise greater than 0 mol % and less than or equal to 15 mol % MgO. In embodiments, the glass composition and the resultant glass article may comprise greater than or equal to 0.01 mol % and less than or equal to 13 mol % MgO.

In embodiments, the glass composition and the resultant glass article may comprise greater than or equal to 0 mol % and less than or equal to 15 mol % CaO. In embodiments, the glass composition and the resultant glass article may comprise greater than 0 mol % and less than or equal to 13 mol % CaO. In embodiments, the concentration of CaO in the glass composition and the resultant glass article may be greater than or equal to 0 mol %, greater than or equal to 0.01 mol %, greater than or equal to 0.1 mol %, greater than or equal to 0.5 mol %, greater than or equal to 1 mol %, greater than or equal to 3 mol %, or even greater than or equal to 5 mol %. In embodiments, the concentration of CaO in the glass composition and the resultant glass article may be less than or equal to 15 mol %, less than or equal to 13 mol %, less than or equal to 10 mol %, less than or equal to 7 mol %, or even less than or equal to 5 mol %. In embodiments, the concentration of CaO in the glass composition and the resultant glass article may be greater than or equal to 0 mol % and less than or equal to 15 mol %, greater than or equal to 0 mol % and less than or equal to 13 mol %, greater than or equal to 0 mol % and less than or equal to 10 mol %, greater than or equal to 0 mol % and less than or equal to 7 mol %, greater than or equal to 0 mol % and less than or equal to 5 mol %, greater than or equal to 0.01 mol % and less than or equal to 15 mol %, greater than or equal to 0.01 mol % and less than or equal to 13 mol %, greater than or equal to 0.01 mol % and less than or equal to 10 mol %, greater than or equal to 0.01 mol % and less than or equal to 7 mol %, greater than or equal to 0.01 mol % and less than or equal to 5 mol %, greater than or equal to 0.1 mol % and less than or equal to 15 mol %, greater than or equal to 0.1 mol % and less than or equal to 13 mol %, greater than or equal to 0.1 mol % and less than or equal to 10 mol %, greater than or equal to 0.1 mol % and less than or equal to 7 mol %, greater than or equal to 0.1 mol % and less than or equal to 5 mol %, greater than or equal to 0.5 mol % and less than or equal to 15 mol %, greater than or equal to 0.5 mol % and less than or equal to 13 mol %, greater than or equal to 0.5 mol % and less than or equal to 10 mol %, greater than or equal to 0.5 mol % and less than or equal to 7 mol %, greater than or equal to 0.5 mol % and less than or equal to 5 mol %, greater than or equal to 3 mol % and less than or equal to 15 mol %, greater than or equal to 3 mol % and less than or equal to 13 mol %, greater than or equal to 3 mol % and less than or equal to 10 mol %, greater than or equal to 3 mol % and less than or equal to 7 mol %, greater than or equal to 3 mol % and less than or equal to 5 mol %, greater than or equal to 5 mol % and less than or equal to 15 mol %, greater than or equal to 5 mol % and less than or equal to 13 mol %, greater than or equal to 5 mol % and less than or equal to 10 mol %, or even greater than or equal to 5 mol % and less than or equal to 7 mol %, or any and all sub-ranges formed from any of these endpoints. In embodiments, the glass composition and the resultant glass article may be free or substantially free of CaO.

In embodiments, the glass compositions and the resultant glass articles may contain other alkaline earth oxides, such as ZnO, SrO, and BaO.

In embodiments, the glass composition and the resultant glass article may comprise greater than or equal to 0 mol % and less than or equal to 15 mol % ZnO. In embodiments, the concentration of ZnO in the glass composition and the resultant glass article may be greater than or equal to 0 mol %, greater than or equal to 0.01 mol %, greater than or equal to 0.1 mol %, greater than or equal to 0.5 mol %, greater than or equal to 3 mol %, or even greater than or equal to 5 mol %. In embodiments, the concentration of ZnO in the glass composition and the resultant glass article may be less than or equal to 15 mol %, less than or equal to 13 mol %, less than or equal to 10 mol %, less than or equal to 7 mol %, or even less than or equal to 5 mol %. In embodiments, the concentration of ZnO in the glass composition and the resultant glass article may be greater than or equal to 0 mol % and less than or equal to 15 mol %, greater than or equal to 0 mol % and less than or equal to 13 mol %, greater than or equal to 0 mol % and less than or equal to 10 mol %, greater than or equal to 0 mol % and less than or equal to 7 mol %, greater than or equal to 0 mol % and less than or equal to 5 mol %, greater than or equal to 0.01 mol % and less than or equal to 15 mol %, greater than or equal to 0.01 mol % and less than or equal to 13 mol %, greater than or equal to 0.01 mol % and less than or equal to 10 mol %, greater than or equal to 0.01 mol % and less than or equal to 7 mol %, greater than or equal to 0.01 mol % and less than or equal to 5 mol %, greater than or equal to 0.1 mol % and less than or equal to 15 mol %, greater than or equal to 0.1 mol % and less than or equal to 13 mol %, greater than or equal to 0.1 mol % and less than or equal to 10 mol %, greater than or equal to 0.1 mol % and less than or equal to 7 mol %, greater than or equal to 0.1 mol % and less than or equal to 5 mol %, greater than or equal to 0.5 mol % and less than or equal to 15 mol %, greater than or equal to 0.5 mol % and less than or equal to 13 mol %, greater than or equal to 0.5 mol % and less than or equal to 10 mol %, greater than or equal to 0.5 mol % and less than or equal to 7 mol %, greater than or equal to 0.5 mol % and less than or equal to 5 mol %, greater than or equal to 3 mol % and less than or equal to 15 mol %, greater than or equal to 3 mol % and less than or equal to 13 mol %, greater than or equal to 3 mol % and less than or equal to 10 mol %, greater than or equal to 3 mol % and less than or equal to 7 mol %, greater than or equal to 3 mol % and less than or equal to 5 mol %, greater than or equal to 5 mol % and less than or equal to 15 mol %, greater than or equal to 5 mol % and less than or equal to 13 mol %, greater than or equal to 5 mol % and less than or equal to 10 mol %, or even greater than or equal to 5 mol % and less than or equal to 7 mol %, or any and all sub-ranges formed from any of these endpoints. In embodiments, the glass composition and the resultant glass article may be free or substantially free of ZnO.

In embodiments, the glass composition and the resultant glass article may comprise greater than or equal to 0 mol % and less than or equal to 2.5 mol % SrO. In embodiments, the concentration of SrO in the glass composition and the resultant glass article may be greater than or equal to 0 mol %, greater than or equal to 0.1 mol %, or even greater than or equal to 0.5 mol %. In embodiments, the concentration of SrO in the glass composition and the resultant glass article may be less than or equal to 2.5 mol %, less than or equal to 2 mol %, less than or equal to 1.5 mol %, or even less than or equal to 1 mol %. In embodiments, the concentration of SrO in the glass composition and the resultant glass article may be greater than or equal to 0 mol % and less than or equal to 2.5 mol %, greater than or equal to 0 mol % and less than or equal to 2 mol %, greater than or equal to 0 mol % and less than or equal to 1.5 mol %, greater than or equal to 0 mol % and less than or equal to 1 mol %, greater than or equal to 0.1 mol % and less than or equal to 2.5 mol %, greater than or equal to 0.1 mol % and less than or equal to 2 mol %, greater than or equal to 0.1 mol % and less than or equal to 1.5 mol %, greater than or equal to 0.1 mol % and less than or equal to 1 mol %, greater than or equal to 0.5 mol % and less than or equal to 2.5 mol %, greater than or equal to 0.5 mol % and less than or equal to 2 mol %, greater than or equal to 0.5 mol % and less than or equal to 1.5 mol %, or even greater than or equal to 0.5 mol % and less than or equal to 1 mol %, or any and all sub-ranges formed from any of these endpoints. In embodiments, the glass composition and the resultant glass article may be free or substantially free of SrO.

In embodiments, the glass composition and the resultant glass article may comprise greater than or equal to 0 mol % and less than or equal to 2.5 mol % BaO. In embodiments, the concentration of BaO in the glass composition and the resultant glass article may be greater than or equal to 0 mol %, greater than or equal to 0.1 mol %, or even greater than or equal to 0.5 mol %. In embodiments, the concentration of BaO in the glass composition and the resultant glass article may be less than or equal to 2.5 mol %, less than or equal to 2 mol %, less than or equal to 1.5 mol %, or even less than or equal to 1 mol %. In embodiments, the concentration of BaO in the glass composition and the resultant glass article may be greater than or equal to 0 mol % and less than or equal to 2.5 mol %, greater than or equal to 0 mol % and less than or equal to 2 mol %, greater than or equal to 0 mol % and less than or equal to 1.5 mol %, greater than or equal to 0 mol % and less than or equal to 1 mol %, greater than or equal to 0.1 mol % and less than or equal to 2.5 mol %, greater than or equal to 0.1 mol % and less than or equal to 2 mol %, greater than or equal to 0.1 mol % and less than or equal to 1.5 mol %, greater than or equal to 0.1 mol % and less than or equal to 1 mol %, greater than or equal to 0.5 mol % and less than or equal to 2.5 mol %, greater than or equal to 0.5 mol % and less than or equal to 2 mol %, greater than or equal to 0.5 mol % and less than or equal to 1.5 mol %, or even greater than or equal to 0.5 mol % and less than or equal to 1 mol %, or any and all sub-ranges formed from any of these endpoints. In embodiments, the glass composition and the resultant glass article may be free or substantially free of BaO.

The glass compositions and the resultant glass articles described herein are free or substantially free of Li (i.e., Li₂O).

The total amount of Na₂O+RO in the glass composition and the resultant glass article may be limited (i.e., less than or equal to 30 mol %) to prevent devitrification of the glass composition. In embodiments, the glass composition and the resultant glass article may be peraluminous (i.e., the amount of Al₂O₃ in the glass composition is greater than the sum of Na₂O and RO), which may increase the fracture toughness of the glass composition such that the glass compositions are more resistant to damage and/or failure. In embodiments, the total amount of (Na₂O+RO)/Al₂O₃ in the glass composition and the resultant glass article may be greater than or equal to 0.5, greater than or equal to 0.65, greater than or equal to 0.8, or even greater than or equal to 0.95. In embodiments, the total amount of (Na₂O+RO)/Al₂O₃ in the glass composition may be less than or equal to 1.5, less than or equal to 1.4, or even less than or equal to 1.3. In embodiments, the total amount of (Na₂O+RO)/Al₂O₃ in the glass composition may be greater than or equal to 0.5 and less than or equal to 1.5, greater than or equal to 0.5 and less than or equal to 1.4, greater than or equal to 0.5 and less than or equal to 1.3, greater than or equal to 0.65 and less than or equal to 1.5, greater than or equal to 0.65 and less than or equal to 1.4, greater than or equal to 0.65 and less than or equal to 1.3, greater than or equal to 0.8 and less than or equal to 1.5, greater than or equal to 0.8 and less than or equal to 1.4, greater than or equal to 0.8 and less than or equal to 1.3, greater than or equal to 0.95 and less than or equal to 1.5, greater than or equal to 0.95 and less than or equal to 1.4, or even greater than or equal to 0.95 and less than or equal to 1.3, or any and all sub-ranges formed from any of these endpoints.

In embodiments, the total amount of (Na₂O+RO)/Al₂O₃ in the glass composition and the resultant glass article may be greater than or equal to 0.25, greater than or equal to 0.5, greater than or equal to 0.65, greater than or equal to 0.8, or even greater than or equal to 0.95. In embodiments, the total amount of (Na₂O+RO)/Al₂O₃ in the glass composition and the resultant glass article may be less than or equal to 1.5, less than or equal to 1.4, or even less than or equal to 1.3. In embodiments, the total amount of (Na₂O+RO)/Al₂O₃ in the glass composition and the resultant glass article may be greater than or equal to 0.25 and less than or equal to 1.5, greater than or equal to 0.25 and less than or equal to 1.4, greater than or equal to 0.25 and less than or equal to 1.3, greater than or equal to 0.5 and less than or equal to 1.5, greater than or equal to 0.5 and less than or equal to 1.4, greater than or equal to 0.5 and less than or equal to 1.3, greater than or equal to 0.65 and less than or equal to 1.5, greater than or equal to 0.65 and less than or equal to 1.4, greater than or equal to 0.65 and less than or equal to 1.3, greater than or equal to 0.8 and less than or equal to 1.5, greater than or equal to 0.8 and less than or equal to 1.4, greater than or equal to 0.8 and less than or equal to 1.3, greater than or equal to 0.95 and less than or equal to 1.5, greater than or equal to 0.95 and less than or equal to 1.4, or even greater than or equal to 0.95 and less than or equal to 1.3, or any and all sub-ranges formed from any of these endpoints.

Like SiO₂ and Al₂O₃, P₂O₅ may be added to the glass composition and the resultant glass article as a network former, thereby reducing the meltability and formability of the glass composition. Thus, P₂O₅ may be added in amounts that do not overly decrease these properties. In other embodiments, P₂O₅ may be added to the glass composition and the resultant glass article to decrease the liquidus temperature, thereby improving formability. The addition of P₂O₅ may also increase the diffusivity of ions in the glass article during ion exchange treatment, thereby increasing the efficiency of these treatments. In embodiments, the glass composition and resultant glass article may comprise greater than 0 mol % and less than or equal to 5 mol % P₂O₅. In embodiments, the concentration of P₂O₅ in the glass composition and resultant glass article may be greater than or equal to 0 mol %, greater than or equal to 0.05 mol %, greater than or equal to 0.1 mol %, or even greater than or equal to 0.15 mol %. In embodiments, the concentration of P₂O₅ in the glass composition and resultant glass article may be less than or equal to 5 mol %, less than or equal to 4 mol %, less than or equal to 3 mol %, less than or equal to 2 mol %, or even less than or equal to 1 mol %. In embodiments, the concentration of P₂O₅ in the glass composition and resultant glass article may be greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0 mol % and less than or equal to 1 mol %, greater than or equal to 0.05 mol % and less than or equal to 5 mol %, greater than or equal to 0.05 mol % and less than or equal to 4 mol %, greater than or equal to 0.05 mol % and less than or equal to 3 mol %, greater than or equal to 0.05 mol % and less than or equal to 2 mol %, greater than or equal to 0.05 mol % and less than or equal to 1 mol %, greater than or equal to 0.1 mol % and less than or equal to 5 mol %, greater than or equal to 0.1 mol % and less than or equal to 4 mol %, greater than or equal to 0.1 mol % and less than or equal to 3 mol %, greater than or equal to 0.1 mol % and less than or equal to 2 mol %, greater than or equal to 0.1 mol % and less than or equal to 1 mol %, greater than or equal to 0.15 mol % and less than or equal to 5 mol %, greater than or equal to 0.15 mol % and less than or equal to 4 mol %, greater than or equal to 0.15 mol % and less than or equal to 3 mol %, or even greater than or equal to 0.15 mol % and less than or equal to 2 mol %, greater than or equal to 0.15 mol % and less than or equal to 1 mol %, or any and all sub-ranges formed from any of these endpoints. In embodiments, the glass composition and the resultant glass article may be free or substantially free of P₂O₅.

In embodiments, the concentration of P₂O₅ in the glass composition and resultant glass article may be greater than or equal to 0 mol %, greater than or equal to 0.1 mol %, greater than or equal to 0.2 mol %, or even greater than or equal to 0.4 mol %. In embodiments, the concentration of P₂O₅ in the glass composition and resultant glass article may be less than or equal to 5 mol %, less than or equal to 4 mol %, less than or equal to 3 mol %, less than or equal to 2 mol %, or even less than or equal to 1 mol %. In embodiments, the concentration of P₂O₅ in the glass composition and resultant glass article may be greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0 mol % and less than or equal to 1 mol %, greater than or equal to 0.1 mol % and less than or equal to 5 mol %, greater than or equal to 0.1 mol % and less than or equal to 4 mol %, greater than or equal to 0.1 mol % and less than or equal to 3 mol %, greater than or equal to 0.1 mol % and less than or equal to 2 mol %, greater than or equal to 0.1 mol % and less than or equal to 1 mol %, greater than or equal to 0.2 mol % and less than or equal to 5 mol %, greater than or equal to 0.2 mol % and less than or equal to 4 mol %, greater than or equal to 0.2 mol % and less than or equal to 3 mol %, greater than or equal to 0.2 mol % and less than or equal to 2 mol %, greater than or equal to 0.2 mol % and less than or equal to 1 mol %, greater than or equal to 0.4 mol % and less than or equal to 5 mol %, greater than or equal to 0.4 mol % and less than or equal to 4 mol %, greater than or equal to 0.4 mol % and less than or equal to 3 mol %, or even greater than or equal to 0.4 mol % and less than or equal to 2 mol %, or even greater than or equal to 0.4 mol % and less than or equal to 1 mol %, or any and all sub-ranges formed from any of these endpoints.

The glass compositions and resultant glass articles described herein may include Y₂O₃ to increase the Young's modulus and/or fracture toughness of the glass compositions and the resultant glass articles described herein. In embodiments, the glass composition and the resultant glass article may comprise greater than 0 mol % and less than or equal to 10 mol % Y₂O₃. In embodiments, the concentration of Y₂O₃ in the glass composition and the resultant glass article may be greater than or equal to 0 mol %, greater than or equal to 0.1 mol %, greater than or equal to 0.5 mol %, or even greater than or equal to 1 mol %. In embodiments, the concentration of Y₂O₃ in the glass composition and the resultant glass article may be less than or equal to 10 mol %, less than or equal to 7 mol %, less than or equal to 5 mol %, or even less than or equal to 3 mol %. In embodiments, the concentration of Y₂O₃ in the glass composition and the resultant glass article may be greater than or equal to 0 mol % and less than or equal to 10 mol %, greater than or equal to 0 mol % and less than or equal to 7 mol %, greater than or equal to 0 mol % and less than or equal to 5 mol %, greater than or equal to 0 mol % and less than or equal to 3 mol %, greater than or equal to 0.1 mol % and less than or equal to 10 mol %, greater than or equal to 0.1 mol % and less than or equal to 7 mol %, greater than or equal to 0.1 mol % and less than or equal to 5 mol %, greater than or equal to 0.1 mol % and less than or equal to 3 mol %, greater than or equal to 0.5 mol % and less than or equal to 10 mol %, greater than or equal to 0.5 mol % and less than or equal to 7 mol %, greater than or equal to 0.5 mol % and less than or equal to 5 mol %, greater than or equal to 0.5 mol % and less than or equal to 3 mol %, greater than or equal to 1 mol % and less than or equal to 10 mol %, greater than or equal to 1 mol % and less than or equal to 7 mol %, greater than or equal to 1 mol % and less than or equal to 5 mol %, or even greater than or equal to 1 mol % and less than or equal to 3 mol %, or any and all sub-ranges formed from any of these endpoints. In embodiments, the glass composition and the resultant glass article may be free or substantially free of Y₂O₃.

The glass compositions and resultant glass articles described herein may include ZrO₂ to increase the Young's modulus and/or fracture toughness of the glass compositions and the resultant glass articles described herein. In embodiments, the concentration of ZrO₂ in the glass composition may be greater than 0 mol % and less than or equal to 5 mol %. In embodiments, the concentration of ZrO₂ in the glass composition and the resultant glass article may be greater than or equal to 0 mol %, greater than or equal to 0.05 mol %, greater than or equal to 0.1 mol %, greater than or equal to 0.15 mol %, or even greater than or equal to 0.2 mol %. In embodiments, the concentration of ZrO₂ in the glass composition may be less than or equal to 5 mol %, less than or equal to 4 mol %, less than or equal to 3 mol %, less than or equal to 2 mol %, or even less than or equal to 1 mol %. In embodiments, the concentration of ZrO₂ in the glass composition may be greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0 mol % and less than or equal to 2 mol %, greater than or equal to 0 mol % and less than or equal to 1 mol %, greater than or equal to 0.05 mol % and less than or equal to 5 mol %, greater than or equal to 0.05 mol % and less than or equal to 4 mol %, greater than or equal to 0.05 mol % and less than or equal to 3 mol %, greater than or equal to 0.05 mol % and less than or equal to 2 mol %, greater than or equal to 0.05 mol % and less than or equal to 1 mol %, greater than or equal to 0.1 mol % and less than or equal to 5 mol %, greater than or equal to 0.1 mol % and less than or equal to 4 mol %, greater than or equal to 0.1 mol % and less than or equal to 3 mol %, greater than or equal to 0.1 mol % and less than or equal to 2 mol %, greater than or equal to 0.1 mol % and less than or equal to 1 mol %, greater than or equal to 0.15 mol % and less than or equal to 5 mol %, greater than or equal to 0.15 mol % and less than or equal to 4 mol %, greater than or equal to 0.15 mol % and less than or equal to 3 mol %, greater than or equal to 0.15 mol % and less than or equal to 2 mol %, greater than or equal to 0.15 mol % and less than or equal to 1 mol %, greater than or equal to 0.2 mol % and less than or equal to 5 mol %, greater than or equal to 0.2 mol % and less than or equal to 4 mol %, greater than or equal to 0.2 mol % and less than or equal to 3 mol %, greater than or equal to 0.2 mol % and less than or equal to 2 mol %, or even greater than or equal to 0.2 mol % and less than or equal to 1 mol %, or any and all sub-ranges formed from any of these endpoints. In embodiments, the glass composition may be substantially free of ZrO₂.

The glass compositions and resultant glass articles described herein may include TiO₂. While not wishing to be bound by theory, TiO₂ may increase the Young's modulus and/or fracture toughness of the glass compositions and the resultant glass articles described herein. In embodiments, the glass compositions and the resultant glass article may comprise greater than or equal to 0 mol % and less than or equal to 2 mol % TiO₂. In embodiments, the concentration of TiO₂ in the glass composition and the resultant glass article may be greater than or equal to 0 mol %, greater than or equal to 0.05 mol %, greater than or equal to 0.1 mol %, greater than or equal to 0.25 mol %, or even greater than or equal to 0.5 mol %. In embodiments, the concentration of TiO₂ in the glass composition and the resultant glass article may be less than or equal to 2 mol %, less than or equal to 1.5 mol %, less than or equal to 1 mol %, or even less than or equal to 0.5 mol %. In embodiments, the concentration of TiO₂ in the glass composition and the resultant glass article may be greater than or equal to 0 mol % and less than or equal to 2 mol %, greater than or equal to 0 mol % and less than or equal to 1.5 mol %, greater than or equal to 0 mol % and less than or equal to 1 mol %, greater than or equal to 0 mol % and less than or equal to 0.5 mol %, greater than or equal to 0.05 mol % and less than or equal to 2 mol %, greater than or equal to 0.05 mol % and less than or equal to 1.5 mol %, greater than or equal to 0.05 mol % and less than or equal to 1 mol %, greater than or equal to 0.05 mol % and less than or equal to 0.5 mol %, greater than or equal to 0.1 mol % and less than or equal to 2 mol %, greater than or equal to 0.1 mol % and less than or equal to 1.5 mol %, greater than or equal to 0.1 mol % and less than or equal to 1 mol %, greater than or equal to 0.1 mol % and less than or equal to 0.5 mol %, greater than or equal to 0.25 mol % and less than or equal to 2 mol %, greater than or equal to 0.25 mol % and less than or equal to 1.5 mol %, greater than or equal to 0.25 mol % and less than or equal to 1 mol %, greater than or equal to 0.25 mol % and less than or equal to 0.5 mol %, greater than or equal to 0.5 mol % and less than or equal to 2 mol %, greater than or equal to 0.5 mol % and less than or equal to 1.5 mol %, or even greater than or equal to 0.5 mol % and less than or equal to 1 mol %, or any and all sub-ranges formed from any of these endpoints. In embodiments, the glass composition and the resultant glass article may be free or substantially free of TiO₂.

In embodiments, the glass compositions described herein may further include one or more fining agents. In embodiments, the fining agents may include, for example, SnO₂. In embodiments, the concentration of SnO₂ in the glass composition may be greater than 0 mol % and less than or equal to 1 mol %. In embodiments, the concentration of SnO₂ in the glass composition and the resultant glass article may be greater than or equal to 0 mol %, greater than or equal to 0.05 mol %, or even greater than or equal to 0.1 mol %. In embodiments, the concentration of SnO₂ in the glass composition may be less than or equal to 1 mol %, less than or equal to 0.5 mol %, less than or equal to 0.4 mol %, less than or equal to 0.3 mol %, or even less than or equal to 0.2 mol %. In embodiments, the concentration of SnO₂ in the glass composition may be greater than or equal to 0 mol % and less than or equal to 1 mol %, greater than or equal to 0 mol % and less than or equal to 0.5 mol %, greater than or equal to 0 mol % and less than or equal to 0.4 mol %, greater than or equal to 0 mol % and less than or equal to 0.3 mol %, greater than or equal to 0 mol % and less than or equal to 0.2 mol %, greater than or equal to 0.05 mol % and less than or equal to 1 mol %, greater than or equal to 0.05 mol % and less than or equal to 0.5 mol %, greater than or equal to 0.05 mol % and less than or equal to 0.4 mol %, greater than or equal to 0.05 mol % and less than or equal to 0.3 mol %, greater than or equal to 0.05 mol % and less than or equal to 0.2 mol %, greater than or equal to 0.1 mol % and less than or equal to 1 mol %, greater than or equal to 0.1 mol % and less than or equal to 0.5 mol %, greater than or equal to 0.1 mol % and less than or equal to 0.4 mol %, greater than or equal to 0.1 mol % and less than or equal to 0.3 mol %, or even greater than or equal to 0.1 mol % and less than or equal to 0.2 mol %, or any and all sub-ranges formed from any of these endpoints. In embodiments, the glass composition may be substantially free of SnO₂.

In embodiments, the glass compositions and resultant glass articles described herein may be free or substantially free of Fe₂O₃. In embodiments, the glass compositions and resultant glass articles described herein may be free or substantially free of Er₂O₃.

In embodiments, the glass composition may comprise: greater than or equal to 50 mol % and less than or equal to 70 mol % SiO₂; greater than or equal to 15 mol % and less than or equal to 30 mol % Al₂O₃; greater than or equal to 5 mol % and less than or equal to 20 mol % Na₂O; greater than or equal to 0 mol % and less than or equal to 15 mol % MgO; and greater than or equal to 0 mol % and less than or equal to 15 mol % CaO, wherein the glass composition is free or substantially free of Li; and RO is greater than 0 mol % and less than or equal to 30 mol %, wherein RO is the sum of MgO and CaO.

In embodiments, the glass composition may comprise: greater than or equal to 50 mol % and less than or equal to 70 mol % SiO₂; greater than or equal to 16 mol % and less than or equal to 28 mol % Al₂O₃; greater than or equal to 7 mol % and less than or equal to 18 mol % Na₂O; greater than or equal to 0 mol % and less than or equal to 13 mol % MgO; and greater than or equal to 0 mol % and less than or equal to 13 mol % CaO, wherein the glass composition is free or substantially free of Li; and RO is greater than 1 mol % and less than or equal to 25 mol %, wherein RO is the sum of MgO and CaO

In embodiments, the glass composition may comprise: greater than or equal to 50 mol % and less than or equal to 70 mol % SiO₂; greater than or equal to 16 mol % and less than or equal to 28 mol % Al₂O₃; greater than or equal to 7 mol % and less than or equal to 18 mol % Na₂O; greater than or equal to 0 mol % and less than or equal to 15 mol % MgO; and greater than or equal to 0 mol % and less than or equal to 15 mol % CaO, wherein the glass composition is free or substantially free of Li; and RO is greater than 0 mol % and less than or equal to 30 mol %, wherein RO is the sum of MgO and CaO.

In embodiments, the glass composition may comprise: greater than or equal to 50 mol % and less than or equal to 70 mol % SiO₂; greater than or equal to 18 mol % and less than or equal to 26 mol % Al₂O₃; greater than or equal to 9 mol % and less than or equal to 16 mol % Na₂O; greater than or equal to 0 mol % and less than or equal to 15 mol % MgO; and greater than or equal to 0 mol % and less than or equal to 15 mol % CaO, wherein the glass composition is free or substantially free of Li; and RO is greater than 0 mol % and less than or equal to 30 mol %, wherein RO is the sum of MgO and CaO.

In embodiments, the glass composition may comprise: greater than or equal to 50 mol % and less than or equal to 70 mol % SiO₂; greater than or equal to 17 mol % and less than or equal to 30 mol % Al₂O₃; greater than or equal to 5 mol % and less than or equal to 20 mol % Na₂O; greater than 0 mol % and less than or equal to 15 mol % MgO; greater than or equal to 0 mol % and less than or equal to 15 mol % CaO; and greater than or equal to 0 mol % and less than or equal to 5 mol % P₂O₅, wherein the glass composition is free or substantially free of Li and Fe₂O₃; and RO is greater than 0 mol % and less than or equal to 30 mol %, wherein RO is the sum of MgO and CaO.

In embodiments, the glass composition may comprise: greater than or equal to 50 mol % and less than or equal to 70 mol % SiO₂; greater than or equal to 17 mol % and less than or equal to 30 mol % Al₂O₃; greater than or equal to 5 mol % and less than or equal to 20 mol % Na₂O; greater than 0 mol % and less than or equal to 15 mol % MgO; greater than or equal to 0 mol % and less than or equal to 15 mol % CaO; and greater than or equal to 0.1 mol % and less than or equal to 5 mol % P₂O₅, wherein the glass composition is free or substantially free of Li and Fe₂O₃; and RO is greater than 0 mol % and less than or equal to 30 mol %, wherein RO is the sum of MgO and CaO.

In embodiments, the glass composition may comprise: greater than or equal to 50 mol % and less than or equal to 70 mol % SiO₂; greater than or equal to 17 mol % and less than or equal to 30 mol % Al₂O₃; greater than or equal to 5 mol % and less than or equal to 17 mol % Na₂O; greater than 0 mol % and less than or equal to 15 mol % MgO; greater than or equal to 0 mol % and less than or equal to 15 mol % CaO; and greater than or equal to 0 mol % and less than or equal to 5 mol % P₂O₅, wherein the glass composition is free or substantially free of Li and Fe₂O₃; and RO is greater than 0 mol % and less than or equal to 30 mol %, wherein RO is the sum of MgO and CaO.

In embodiments, the glass composition may comprise: greater than or equal to 50 mol % and less than or equal to 70 mol % SiO₂; greater than or equal to 17 mol % and less than or equal to 30 mol % Al₂O₃; greater than or equal to 5 mol % and less than or equal to 20 mol % Na₂O; greater than 0 mol % and less than or equal to 15 mol % MgO; greater than or equal to 0 mol % and less than or equal to 15 mol % CaO; and greater than or equal to 0 mol % and less than or equal to 5 mol % P₂O₅, wherein the glass composition is free or substantially free of Li, Fe₂O₃, and Er₂O₃; and RO is greater than 0 mol % and less than or equal to 30 mol %, wherein RO is the sum of MgO and CaO.

The articles formed from the glass compositions described herein may be any suitable shape or thickness, which may vary depending on the particular application for use of the glass composition. Glass sheet embodiments may have a thickness greater than or equal to 30 μm, greater than or equal to 50 μm, greater than or equal to 100 μm, greater than or equal to 250 μm, greater than or equal to 500 μm, greater than or equal to 750 μm, or even greater than or equal to 1 mm. In embodiments, the glass sheet embodiments may have a thickness less than or equal to 6 mm, less than or equal to 5 mm, less than or equal to 4 mm, less than or equal to 3 mm, or even less than or equal to 2 mm. In embodiments, the glass sheet embodiments may have a thickness greater than or equal to 30 μm and less than or equal to 6 mm, greater than or equal to 30 μm and less than or equal to 5 mm, greater than or equal to 30 μm and less than or equal to 4 mm, greater than or equal to 30 μm and less than or equal to 3 mm, greater than or equal to 30 μm and less than or equal to 2 mm, greater than or equal to 50 μm and less than or equal to 6 mm, greater than or equal to 50 μm and less than or equal to 5 mm, greater than or equal to 50 μm and less than or equal to 4 mm, greater than or equal to 50 μm and less than or equal to 3 mm, greater than or equal to 50 μm and less than or equal to 2 mm, greater than or equal to 100 μm and less than or equal to 6 mm, greater than or equal to 100 μm and less than or equal to 5 mm, greater than or equal to 100 μm and less than or equal to 4 mm, greater than or equal to 100 μm and less than or equal to 3 mm, greater than or equal to 100 μm and less than or equal to 2 mm, greater than or equal to 250 μm and less than or equal to 6 mm, greater than or equal to 250 μm and less than or equal to 5 mm, greater than or equal to 250 μm and less than or equal to 4 mm, greater than or equal to 250 μm and less than or equal to 3 mm, greater than or equal to 250 μm and less than or equal to 2 mm, greater than or equal to 500 μm and less than or equal to 6 mm, greater than or equal to 500 μm and less than or equal to 5 mm, greater than or equal to 500 μm and less than or equal to 4 mm, greater than or equal to 500 μm and less than or equal to 3 mm, greater than or equal to 500 μm and less than or equal to 2 mm, greater than or equal to 750 μm and less than or equal to 6 mm, greater than or equal to 750 μm and less than or equal to 5 mm, greater than or equal to 750 μm and less than or equal to 4 mm, greater than or equal to 750 μm and less than or equal to 3 mm, greater than or equal to 750 μm and less than or equal to 2 mm, greater than or equal to 1 mm and less than or equal to 6 mm, greater than or equal to 1 mm and less than or equal to 5 mm, greater than or equal to 1 mm and less than or equal to 4 mm, greater than or equal to 1 mm and less than or equal to 3 mm, or even greater than or equal to 1 mm and less than or equal to 2 mm, or any and all sub-ranges formed from any of these endpoints.

As discussed hereinabove, the glass compositions and the resultant glass articles described herein may have increased fracture toughness such that the glass compositions and the resultant glass articles are more resistant to damage. In embodiments, the glass composition and the resultant glass article may have a K_{Ic} fracture toughness greater than or equal to 0.75 MPa·m^{1/2}, greater than or equal to 0.80 MPa·m^{1/2}, greater than or equal to 0.85 MPa·m^{1/2}, or even greater than or equal to 0.90 MPa·m^{1/2}.

In embodiments, the glass composition and the resultant glass article may have a density greater than or equal to 2.30 g/cm³, greater than or equal to 2.40 g/cm³, or even greater than or equal to 2.45 g/cm³. In embodiments, the glass composition and the resultant glass article may have a density less than or equal to 2.90 g/cm³, less than or equal to 2.80 g/cm³, or even less than or equal to 2.75 g/cm³. In embodiments, the glass composition and the resultant glass article may have a density greater than or equal to 2.30 g/cm³ and less than or equal to 2.90 g/cm³, greater than or equal to 2.30 g/cm³ and less than or equal to 2.80 g/cm³, greater than or equal to 2.30 g/cm³ and less than or equal to 2.75 g/cm³, greater than or equal to 2.40 g/cm³ and less than or equal to 2.90 g/cm³, greater than or equal to 2.40 g/cm³ and less than or equal to 2.80 g/cm³, greater than or equal to 2.40 g/cm³ and less than or equal to 2.75 g/cm³, greater than or equal to 2.45 g/cm³ and less than or equal to 2.90 g/cm³, greater than or equal to 2.45 g/cm³ and less than or equal to 2.80 g/cm³, or even greater than or equal to 2.45 g/cm³ and less than or equal to 2.75 g/cm³, or any and all sub-ranges formed from any of these endpoints.

As described in further detail below, exchanging Na⁺ ions in the resultant glass article with K⁺ ions in a molten salt bath is relatively slow. Accordingly, it may be desirable to increase the ion exchange rate by ion exchanging the glass article at relatively high temperatures (i.e., greater than or equal to 500° C.). However, ion exchanging the glass article at relatively high temperature may result in stress relaxation, if the ion exchanged article has a strain point that is within about 100° C. of the ion exchange process temperatures. To prevent an undesirable amount of stress relaxation, the glass composition and resultant glass articles herein have a relatively high strain point (i.e., greater than or equal to 600° C.). In embodiments, the glass composition and the resultant glass article may have a strain point greater than or equal to 600° C., greater than or equal to 650° C., or even greater than or equal to 700° C. In embodiments, the glass composition and the resultant glass article may have a strain point less than or equal to 800° C., less than or equal to 775° C., or even less than or equal to 750° C. In embodiments, the glass composition and the resultant glass article may have a strain point greater than or equal to 600° C. and less than or equal to 800° C., greater than or equal to 600° C. and less than or equal to 775° C., greater than or equal to 600° C. and less than or equal to 750° C., greater than or equal to 650° C. and less than or equal to 800° C., greater than or equal to 650° C. and less than or equal to 775° C., greater than or equal to 650° C. and less than or equal to 750° C., greater than or equal to 700° C. and less than or equal to 800° C., greater than or equal to 700° C. and less than or equal to 775° C., or even greater than or equal to 700° C. and less than or equal to 750° C., or any and all sub-ranges formed from any of these endpoints.

In embodiments, the glass composition and the resultant glass article may have an annealing point greater than or equal to 700° C. or even greater than or equal to 725° C. In embodiments, the glass composition and the resultant glass article may have an annealing point less than or equal to 825° C. or even less than or equal to 800° C. In embodiments, the glass composition and the resultant glass article may have an annealing point greater than or equal to 700° C. and less than or equal to 825° C., greater than or equal to 700° C. and less than or equal to 800° C., greater than or equal to 725° C. and less than or equal to 825° C., or even greater than or equal to 725° C. and less than or equal to 800° C., or any and all sub-ranges formed from any of these endpoints.

In embodiments, the glass composition and the resultant glass article may have a Young's modulus greater than or equal to 60 GPa, greater than or equal to 65 GPa, or even greater than or equal to 70 GPa. In embodiments, the glass composition and the resultant glass article may have a Young's modulus less than or equal to 110 GPa, less than or equal to 100 GPa, or even less than or equal to 90 GPa. In embodiments, the glass composition and the resultant glass article may have a Young's modulus greater than or equal to 60 GPa and less than or equal to 110 GPa, greater than or equal to 60 GPa and less than or equal to 100 GPa, greater than or equal to 60 GPa and less than or equal to 90 GPa, greater than or equal to 65 GPa and less than or equal to 110 GPa, greater than or equal to 65 GPa and less than or equal to 100 GPa, greater than or equal to 65 GPa and less than or equal to 90 GPa, greater than or equal to 70 GPa and less than or equal to 110 GPa, greater than or equal to 70 GPa and less than or equal to 100 GPa, or even greater than or equal to 70 GPa and less than or equal to 90 GPa, or any and all sub-ranges formed from any of these endpoints.

In embodiments, the glass composition and the resultant glass article may have a shear modulus greater than or equal to 20 GPa, greater than or equal to 25 GPa, or even greater than or equal to 30 GPa. In embodiments, the glass composition and the resultant glass article may have a shear modulus less than or equal to 50 GPa, less than or equal to 45 GPa, or even less than or equal to 40 GPa. In embodiments, the glass composition and the resultant glass article may have a shear modulus greater than or equal to 20 GPa and less than or equal to 50 GPa, greater than or equal to 20 GPa and less than or equal to 45 GPa, greater than or equal to 20 GPa and less than or equal to 40 GPa, greater than or equal to 25 GPa and less than or equal to 50 GPa, greater than or equal to 25 GPa and less than or equal to 45 GPa, greater than or equal to 25 GPa and less than or equal to 40 GPa, greater than or equal to 30 GPa and less than or equal to 50 GPa, greater than or equal to 30 GPa and less than or equal to 45 GPa, or even greater than or equal to 30 GPa and less than or equal to 40 GPa, or any and all sub-ranges formed from any of these endpoints.

In embodiments, the glass compositions and the resultant glass articles described herein may have a relatively high Poisson's ratio, which increases the fracture energy such that the glass compositions are more resistant to damage. In embodiments, the glass composition and the resultant glass article may have a Poisson's ratio greater than or equal to 0.19, greater than or equal to 0.20, or even greater than or equal to 0.21. In embodiments, the glass composition and the resultant glass article may have a Poisson's ratio less than or equal to 0.26, less than or equal to 0.25, or even less than or equal to 0.24. In embodiments, the glass composition and the resultant glass article may have a Poisson's ratio greater than or equal to 0.19 and less than or equal to 0.26, greater than or equal to 0.19 and less than or equal to 0.25, greater than or equal to 0.19 and less than or equal to 0.24, greater than or equal to 0.20 and less than or equal to 0.26, greater than or equal to 0.20 and less than or equal to 0.25, greater than or equal to 0.20 and less than or equal to 0.24, greater than or equal to 0.21 and less than or equal to 0.26, greater than or equal to 0.21 and less than or equal to 0.25, or even greater than or equal to 0.21 and less than or equal to 0.24, or any and all sub-ranges formed from any of these endpoints.

In embodiments, the glass composition and the resultant glass article may have a refractive index greater than or equal to 1.4, greater than or equal to 1.45, or even greater than or equal to 1.5. In embodiments, the glass composition and the resultant glass article may have a refractive index less than or equal to 1.7 or even less than or equal to 1.6. In embodiments, the glass composition and the resultant glass article may have a refractive index greater than or equal to 1.4 and less than or equal to 1.7, greater than or equal to 1.4 and less than or equal to 1.6, greater than or equal to 1.45 and less than or equal to 1.7, greater than or equal to 1.45 and less than or equal to 1.6, greater than or equal to 1.5 and less than or equal to 1.7, or even greater than or equal to 1.5 and less than or equal to 1.6, or any and all sub-ranges formed from any of these endpoints.

In embodiments, the glass composition and the resultant glass article may have a stress optical coefficient (SOC) greater than or equal to 2.40 nm/mm/MPa or even greater than or equal to 2.55 nm/mm/MPa. In embodiments, the glass composition and the resultant glass article may have a SOC less than or equal to 3.50 nm/mm/MPa or even less than or equal to 3.25 nm/mm/MPa. In embodiments, the glass composition and the resultant glass article may have a SOC greater than or equal to 2.40 nm/mm/MPa and less than or equal to 3.50 nm/mm/MPa, greater than or equal to 2.40 nm/mm/MPa and less than or equal to 3.25 nm/mm/MPa, greater than or equal to 2.55 nm/mm/MPa and less than or equal to 3.50 nm/mm/MPa, or even greater than or equal to 2.55 nm/mm/MPa and less than or equal to 3.25 nm/mm/MPa, or any and all sub-ranges formed from any of these endpoints.

In embodiments, the glass composition and the resultant glass article may have a liquidus viscosity greater than or equal to 0.5 kP, greater than or equal to 1 kP, greater than or equal to 5 kP, greater than or equal to 10 kP, greater than or equal to 25 kP, or even greater than or equal to 35 kP. In embodiments, the glass composition and the resultant glass article may have a liquidus viscosity less than or equal to 300 kP, less than or equal to 250 kP, less than or equal to 200 kP, less than or equal to 150 kP, or even less than or equal to 100 kP. In embodiments, the glass composition and the resultant glass article may have a liquidus viscosity greater than or equal to 0.5 kP and less than or equal to 300 kP, greater than or equal to 0.5 kP and less than or equal to 250 kP, greater than or equal to 0.5 kP and less than or equal to 200 kP, greater than or equal to 0.5 kP and less than or equal to 150 kP, greater than or equal to 0.5 kP and less than or equal to 100 kP, greater than or equal to 1 kP and less than or equal to 300 kP, greater than or equal to 1 kP and less than or equal to 250 kP, greater than or equal to 1 kP and less than or equal to 200 kP, greater than or equal to 1 kP and less than or equal to 150 kP, greater than or equal to 1 kP and less than or equal to 100 kP, greater than or equal to 5 kP and less than or equal to 300 kP, greater than or equal to 5 kP and less than or equal to 250 kP, greater than or equal to 5 kP and less than or equal to 200 kP, greater than or equal to 5 kP and less than or equal to 150 kP, greater than or equal to 5 kP and less than or equal to 100 kP, greater than or equal to 10 kP and less than or equal to 300 kP, greater than or equal to 10 kP and less than or equal to 250 kP, greater than or equal to 10 kP and less than or equal to 200 kP, greater than or equal to 10 kP and less than or equal to 150 kP, greater than or equal to 10 kP and less than or equal to 100 kP, greater than or equal to 25 kP and less than or equal to 300 kP, greater than or equal to 25 kP and less than or equal to 250 kP, greater than or equal to 25 kP and less than or equal to 200 kP, greater than or equal to 25 kP and less than or equal to 150 kP, greater than or equal to 25 kP and less than or equal to 100 kP, greater than or equal to 35 kP and less than or equal to 300 kP, greater than or equal to 35 kP and less than or equal to 250 kP, greater than or equal to 35 kP and less than or equal to 200 kP, greater than or equal to 35 kP and less than or equal to 150 kP, or even greater than or equal to 35 kP and less than or equal to 100 kP, or any and all sub-ranges formed from any of these endpoints. These ranges of viscosities allow the glass compositions to be formed into sheets by a variety of different techniques including, without limitation, fusion forming, slot draw, floating, rolling, and other sheet-forming processes known to those in the art. However, it should be understood that other processes may be used for forming other articles (i.e., other than sheets).

In embodiments, the glass composition and the resultant glass article may have a K_{Ic} fracture toughness greater than or equal to 0.75 MPa·m^{1/2}, a density greater than or equal to 2.30 g/cm³ and less than or equal to 2.90 g/cm³, an annealing point greater than or equal to 700° C. and less than or equal to 825° C., a Young's modulus greater than or equal to 60 GPa and less than or equal to 110 GPa, a shear modulus greater than or equal to 20 GPa and less than or equal to 50 GPa, a Poisson's ratio greater than or equal to 0.19 and less than or equal to 0.26, a refractive index greater than or equal to 1.4 and less than or equal to 1.7, a stress optical coefficient (SOC) greater than or equal to 2.40 nm/mm/MPa and less than or equal to 3.50 nm/mm/MPa, and a liquidus viscosity greater than or equal to 0.5 kP and less than or equal to 300 kP.

In embodiments, the process for making a glass article includes heat treating the glass composition as described herein at one or more preselected temperatures for one or more preselected times to melt the glass composition and cooling the glass composition. In embodiments, the heat treatment for making a glass article may include (i) heating a glass composition at a rate of 1-100° C./min to glass melting temperature; (ii) maintaining the glass composition at the glass melting temperature for a time greater than or equal to 4 hours and less than or equal to 100 hours to produce a glass article; and (iii) cooling the formed glass article to room temperature. In embodiments, the glass melting temperature may be greater than or equal to 1500° C. and less than or equal to 1700° C.

In embodiments, the glass compositions described herein are ion exchangeable to facilitate strengthening the glass article made from the glass compositions. In typical ion exchange processes, smaller metal ions in the glass article are replaced or “exchanged” with larger metal ions of the same valence within a layer that is close to the outer surface of the glass article. The replacement of smaller ions with larger ions creates a compressive stress within the layer of the glass article. In embodiments, the metal ions are monovalent metal ions (i.e., Na⁺, K⁺, and the like), and ion exchange is accomplished by immersing the glass article in a bath comprising at least one molten salt of the larger metal ion that is to replace the smaller metal ion in the glass article. Alternatively, other monovalent ions such as Ag⁺, Tl⁺, Cu⁺, and the like may be exchanged for monovalent ions. The ion exchange process or processes that are used to strengthen the glass article may include, but are not limited to, immersion in a single bath or multiple baths of like or different compositions with washing and/or annealing steps between immersions. In embodiments, there may be a first ion exchange step and a second ion exchange step.

Upon exposure to the glass article, the first ion exchange solution may, according to embodiments, be at a temperature greater than or equal to 500° C. and less than or equal to 700° C., greater than or equal to 505° C. and less than or equal to 675° C., greater than or equal to 510° C. and less than or equal to 650° C., greater than or equal to 515° C. and less than or equal to 625° C., greater than or equal to 520° C. and less than or equal to 620° C., greater than or equal to 525° C. and less than or equal to 615° C., or even greater than or equal to 530° C. and less than or equal to 610° C., or any and all sub-ranges between the foregoing values.

In embodiments, the glass article may be exposed to the first ion exchange solution for a duration greater than or equal to 0.25 hours and less than or equal to 32 hours, greater than or equal to 0.25 hours and less than or equal to 28 hours, greater than or equal to 0.25 hours and less than or equal to 24 hours, greater than or equal to 0.25 hours and less than or equal to 20 hours, greater than or equal to 0.25 hours and less than or equal to 16 hours, greater than or equal to 1 hour and less than or equal to 32 hours, greater than or equal to 1 hour and less than or equal to 28 hours, greater than or equal to 1 hour and less than or equal to 24 hours, greater than or equal to 1 hour and less than or equal to 20 hours, greater than or equal to 1 hour and less than or equal to 16 hours, greater than or equal to 4 hours and less than or equal to 32 hours, greater than or equal to 4 hours and less than or equal to 28 hours, or even greater than or equal to 4 hours and less than or equal to 24 hours, greater than or equal to 4 hours and less than or equal to 20 hours, or any and all sub-ranges formed from any of these endpoints.

Upon exposure to the glass article, the second ion exchange solution may, according to embodiments, be at a temperature greater than or equal to 350° C. and less than or equal to 700° C., greater than or equal to 360° C. and less than or equal to 675° C., greater than or equal to 370° C. and less than or equal to 650° C., greater than or equal to 360° C. and less than or equal to 625° C., greater than or equal to 370° C. and less than or equal to 620° C., greater than or equal to 375° C. and less than or equal to 615° C., greater than or equal to 400° C. and less than or equal to 610° C., greater than or equal to 410° C. and less than or equal to 600° C., greater than or equal to 420° C. and less than or equal to 590° C., greater than or equal to 430° C. and less than or equal to 575° C., or even greater than or equal to 440° C. and less than or equal to 550° C., or any and all sub-ranges between the foregoing values. In embodiments, the second ion exchange solution may be at a temperature greater than or equal to 350° C. and less than or equal to 530° C., greater than or equal to 360° C. and less than or equal to 510° C., greater than or equal to 370° C. and less than or equal to 490° C., greater than or equal to 360° C. and less than or equal to 470° C., greater than or equal to 370° C. and less than or equal to 450° C., greater than or equal to 375° C. and less than or equal to 430° C., or even greater than or equal to 400° C. and less than or equal to 410° C., or any and all sub-ranges between the foregoing values.

In embodiments, the glass article may be exposed to the second ion exchange solution for a duration greater than or equal to 0.25 hours and less than or equal to 32 hours, greater than or equal to 0.25 hours and less than or equal to 28 hours, greater than or equal to 0.25 hours and less than or equal to 24 hours, greater than or equal to 0.25 hours and less than or equal to 20 hours, greater than or equal to 0.25 hours and less than or equal to 16 hours, greater than or equal to 1 hour and less than or equal to 32 hours, greater than or equal to 1 hour and less than or equal to 28 hours, greater than or equal to 1 hour and less than or equal to 24 hours, greater than or equal to 1 hour and less than or equal to 20 hours, greater than or equal to 1 hour and less than or equal to 16 hours, greater than or equal to 4 hours and less than or equal to 32 hours, greater than or equal to 4 hours and less than or equal to 28 hours, or even greater than or equal to 4 hours and less than or equal to 24 hours, greater than or equal to 4 hours and less than or equal to 20 hours, or any and all sub-ranges formed from any of these endpoints. In embodiments, the glass article may be exposed to the second ion exchange solution for a duration greater than or equal to 0.05 hour and less than or equal to 32 hours, greater than or equal to 0.05 hour and less than or equal to 24 hours, greater than or equal to 0.05 hour and less than or equal to 18 hours, greater than or equal to 0.05 hour and less than or equal to 12 hours, greater than or equal to 0.05 hour and less than or equal to 6 hours, greater than or equal to 0.05 hour and less than or equal to 2 hours, greater than or equal to 0.1 hour and less than or equal to 32 hours, greater than or equal to 0.1 hour and less than or equal to 24 hours, greater than or equal to 0.1 hour and less than or equal to 18 hours, greater than or equal to 0.1 hour and less than or equal to 12 hours, greater than or equal to 0.1 hour and less than or equal to 6 hours, greater than or equal to 0.1 hour and less than or equal to 2 hours, greater than or equal to 0.5 hour and less than or equal to 32 hours, greater than or equal to 0.5 hour and less than or equal to 24 hours, greater than or equal to 0.5 hour and less than or equal to 18 hours, greater than or equal to 0.5 hour and less than or equal to 12 hours, greater than or equal to 0.5 hour and less than or equal to 6 hours, greater than or equal to 0.5 hour and less than or equal to 2 hours, greater than or equal to 1 hour and less than or equal to 32 hours, greater than or equal to 1 hour and less than or equal to 24 hours, greater than or equal to 1 hour and less than or equal to 18 hours, greater than or equal to 1 hour and less than or equal to 12 hours, greater than or equal to 1 hour and less than or equal to 6 hours, or even greater than or equal to 1 hour and less than or equal to 2 hours, or any and all sub-ranges formed from any of these endpoints.

In embodiments, at least one of the first ion exchange bath and the second ion exchange bath may comprise KNO₃, NaNO₃, or combinations thereof. In embodiments, at least one of the first ion exchange bath and the first ion exchange bath may comprise KNO₃, NaNO₃, Na₂SO₄, and K₂SO₄, or combinations thereof. While not wishing to be bound by theory, a mixed-bath including nitrates, sulfates, or other Na and/or K salts may be used at relatively high temperature (e.g., greater than 530° C.) because nitrates may decompose at these relatively high temperatures.

In embodiments, the relatively increased Young's Modulus and K_{Ic} fracture toughness of the glass compositions described herein enables improved stress profiles (i.e., surface compressive stress, depth of layer, and maximum central tension) for the resultant glass articles, leading to improved mechanical performance.

In embodiments, a glass article made from the glass composition may have a surface compressive stress, after ion exchange strengthening, greater than or equal to 350 MPa. In embodiments, a glass article made from the glass composition may have a surface compressive stress, after ion exchange strengthening, greater than or equal to 350 MPa, greater than or equal to 400 MPa, greater than or equal to 450 MPa, greater than or equal to 500 MPa, or even greater than or equal to 550 MPa. In embodiments, a glass article made from the glass composition may have a surface compressive stress, after ion exchange strengthening, less than or equal to 900 MPa, less than or equal to 800 MPa, or even less than or equal to 700 MPa. In embodiments, a glass article made from the glass composition may have a surface compressive stress, after ion exchange strengthening, greater than or equal to 350 MPa and less than or equal to 900 MPa, greater than or equal to 350 MPa and less than or equal to 800 MPa, greater than or equal to 350 MPa and less than or equal to 700 MPa, greater than or equal to 400 MPa and less than or equal to 900 MPa, greater than or equal to 400 MPa and less than or equal to 800 MPa, greater than or equal to 400 MPa and less than or equal to 700 MPa, greater than or equal to 450 MPa and less than or equal to 900 MPa, greater than or equal to 450 MPa and less than or equal to 800 MPa, greater than or equal to 450 MPa and less than or equal to 700 MPa, greater than or equal to 500 MPa and less than or equal to 900 MPa, greater than or equal to 500 MPa and less than or equal to 800 MPa, greater than or equal to 500 MPa and less than or equal to 700 MPa, greater than or equal to 550 MPa and less than or equal to 900 MPa, greater than or equal to 550 MPa and less than or equal to 800 MPa, or even greater than or equal to 550 MPa and less than or equal to 700 MPa, or any and all sub-ranges formed from any of these endpoints.

In embodiments, a glass article made from the glass composition may have a depth of layer, after ion exchange strengthening, greater than or equal to 20 μm. In embodiments, a glass article made from the glass composition may have a depth of layer, after ion exchange strengthening, greater than or equal to 20 μm, greater than or equal to 25 μm, or even greater than or equal to 30 μm. In embodiments, a glass article made from the glass composition may have a depth of layer, after ion exchange strengthening, less than or equal to 300 μm, less than or equal to 290 μm, less than or equal to 280 μm, or even less than or equal to 270 μm. In embodiments, a glass article made from the glass composition may have a depth of layer, after ion exchange strengthening, greater than or equal to 20 μm and less than or equal to 300 μm, greater than or equal to 20 μm and less than or equal to 290 μm, greater than or equal to 20 μm and less than or equal to 280 μm, greater than or equal to 20 μm and less than or equal to 270 μm, greater than or equal to 25 μm and less than or equal to 300 μm, greater than or equal to 25 μm and less than or equal to 290 μm, greater than or equal to 25 μm and less than or equal to 280 μm, greater than or equal to 25 μm and less than or equal to 270 μm, greater than or equal to 30 μm and less than or equal to 300 μm, greater than or equal to 30 μm and less than or equal to 290 μm, greater than or equal to 30 μm and less than or equal to 280 μm, or even greater than or equal to 30 μm and less than or equal to 270 μm, or any and all sub-ranges formed from any of these endpoints.

In embodiments, a glass article made from the glass composition may have a depth of compression, after ion exchange strengthening, greater than or equal to 80 μm. In embodiments, a glass article made from the glass composition may have a depth of compression, after ion exchange strengthening, greater than or equal to 45 μm, greater than or equal to 50 μm, or even greater than or equal to 55 μm. In embodiments, a glass article made from the glass composition may have a depth of compression, after ion exchange strengthening, less than or equal to 140 μm, less than or equal to 135 μm, less than or equal to 130 μm, or even less than or equal to 135 μm. In embodiments, a glass article made from the glass composition may have a depth of compression, after ion exchange strengthening, greater than or equal to 45 μm and less than or equal to 140 μm, greater than or equal to 45 μm and less than or equal to 135 μm, greater than or equal to 45 μm and less than or equal to 130 μm, greater than or equal to 45 μm and less than or equal to 125 μm, greater than or equal to 50 μm and less than or equal to 140 μm, greater than or equal to 50 μm and less than or equal to 135 μm, greater than or equal to 50 μm and less than or equal to 130 μm, greater than or equal to 50 μm and less than or equal to 125 μm, greater than or equal to 55 μm and less than or equal to 140 μm, greater than or equal to 55 μm and less than or equal to 135 μm, greater than or equal to 55 μm and less than or equal to 130 μm, or even greater than or equal to 55 μm and less than or equal to 125 μm, or any and all sub-ranges formed from any of these endpoints.

In embodiments, a glass article made from the glass composition has a thickness t and may have a depth of compression, after ion exchange strengthening, greater than or equal to 0.05 t. In embodiments, a glass article made from the glass composition may have a depth of compression greater than or equal to 0.05 t or even greater than or equal to 0.1 t. In embodiments, a glass article made from the glass composition may have a depth of compression, after ion exchange strengthening, less than or equal to 0.3 t or even less than or equal to 0.25 t. In embodiments, a glass article made from the glass composition may have a depth of compression, after ion exchange strengthening, greater than or equal to 0.05 t and less than or equal to 0.3 t, greater than or equal to 0.05 t and less than or equal to 0.25 t, greater than or equal to 0.1 t and less than or equal to 0.3 t, or even greater than or equal to 0.1 t and less than or equal to 0.25 t, or any and all sub-ranges formed from any of these endpoints.

In embodiments, a glass article made from the glass composition may have a central tension, after ion exchange strengthening greater than or equal to 75 MPa, as measured at an article thickness of 0.6 mm. In embodiments, a glass article made from the glass composition may have a central tension, after ion exchange strengthening, greater than or equal to 30 MPa, greater than or equal to 35 MPa, greater than or equal to 40 MPa, greater than or equal to 45 MPa, or even greater than or equal to 50 MPa, as measured at an article thickness of 0.6 mm. In embodiments, a glass article made from the glass composition may have a central tension, after ion exchange strengthening, less than or equal to 250 MPa or even less than or equal to 225 MPa, as measured at an article thickness of 0.8 mm. In embodiments, a glass article made from the glass composition may have a central tension after ion exchange strengthening greater than or equal to 30 MPa and less than or equal to 250 MPa, greater than or equal to 30 MPa and less than or equal to 225 MPa, greater than or equal to 35 MPa and less than or equal to 250 MPa, greater than or equal to 35 MPa and less than or equal to 225 MPa, greater than or equal to 40 MPa and less than or equal to 250 MPa, greater than or equal to 40 MPa and less than or equal to 225 MPa, greater than or equal to 45 MPa and less than or equal to 250 MPa, greater than or equal to 45 MPa and less than or equal to 225 MPa, greater than or equal to 50 MPa and less than or equal to 250 MPa, or even greater than or equal to 50 MPa and less than or equal to 225 MPa, or any and all sub-ranges formed from any of these endpoints, as measured at an article thickness of 0.6 mm.

In embodiments, a glass article made from the glass composition may, after ion exchange strengthening, have a surface compressive stress greater than or equal to 350 MPa, a depth of layer greater than or equal to 20 μm and less than or equal to 300 μm, a depth of compression greater than or equal to 45 μm and less than or equal to 140 μm, and a central tension greater than or equal to 30 MPa and less than or equal to 250 MPa, as measured at an article thickness of 0.6 mm.

As described herein, the glass articles are ion exchanged at relatively high temperatures (i.e., greater than or equal to 500° C.) to offset the relatively slow rate of exchanging Na⁺ ions in the resultant glass article with K⁺ ions in a molten salt bath. However, while not wishing to be bound by theory, ion exchanging the glass article at relatively high temperature may result in stress relaxation, as evidenced by a knee region in the stress profile of the ion exchanged glass article. To prevent an undesirable amount of stress relaxation, the glass composition and resultant glass articles herein have a relatively high strain point (i.e., greater than or equal to 600° C.).

In embodiments, a glass article made from the glass composition may have a knee, after ion exchange strengthening, greater than or equal to 1 μm and less than or equal to 30 μm, as measured at an article thickness of about 0.5 mm to about 1 mm. In embodiments, a glass article made from the glass composition may have a knee, after ion exchange strengthening, greater than or equal to 1 μm, greater than or equal to 3 μm, or even greater than or equal to 7 μm. In embodiments, a glass article made from the glass composition may have a knee, after ion exchange strengthening, less than or equal to 30 μm or even less than or equal to 25 μm. In embodiments, a glass article made from the glass composition may have a knee after ion exchange strengthening greater than or equal to 1 μm and less than or equal to 30 μm, greater than or equal to 1 μm and less than or equal to 25 μm, greater than or equal to 3 μm and less than or equal to 30 μm, greater than or equal to 3 μm and less than or equal to 25 μm, greater than or equal to 5 μm and less than or equal to 30 μm, or even greater than or equal to 5 μm and less than or equal to 25 μm, or any and all sub-ranges formed from any of these endpoints.

In embodiments, a glass article made from the glass composition may have a knee stress, after ion exchange strengthening greater than or equal to 50 MPa and less than or equal to 500 MPa, as measured at an article thickness of about 0.5 mm to about 1 mm. In embodiments, a glass article made from the glass composition may have a knee stress, after ion exchange strengthening, greater than or equal to 50 MPa, greater than or equal to 75 MPa, greater than or equal to 100 MPa, greater than or equal to 125 MPa, or even greater than or equal to 150 MPa. In embodiments, a glass article made from the glass composition may have a knee stress, after ion exchange strengthening, less than or equal to 500 MPa or even less than or equal to 400 MPa. In embodiments, a glass article made from the glass composition may have a knee stress after ion exchange strengthening greater than or equal to 50 MPa and less than or equal to 500 MPa, greater than or equal to 50 MPa and less than or equal to 400 MPa, greater than or equal to 75 MPa and less than or equal to 500 MPa, greater than or equal to 75 MPa and less than or equal to 400 MPa, greater than or equal to 100 MPa and less than or equal to 500 MPa, greater than or equal to 100 MPa and less than or equal to 400 MPa, greater than or equal to 125 MPa and less than or equal to 500 MPa, greater than or equal to 125 MPa and less than or equal to 400 MPa, greater than or equal to 150 MPa and less than or equal to 500 MPa, or even greater than or equal to 150 MPa and less than or equal to 400 MPa or any and all sub-ranges formed from any of these endpoints.

In embodiments, the glass compositions and resultant glass articles may have a knee, after ion exchange strengthening, greater than or equal to 1 μm and less than or equal to 30 μm and a knee stress, after ion exchange strengthening greater than or equal to 50 MPa and less than or equal to 500 MPa.

The glass compositions and resultant glass articles described herein may be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, watches and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (i.e., smartphones, tablet computers, watches, personal computers, ultrabooks, televisions, and cameras), an architectural glass, and/or an automotive glass may comprise a glass article as described herein.

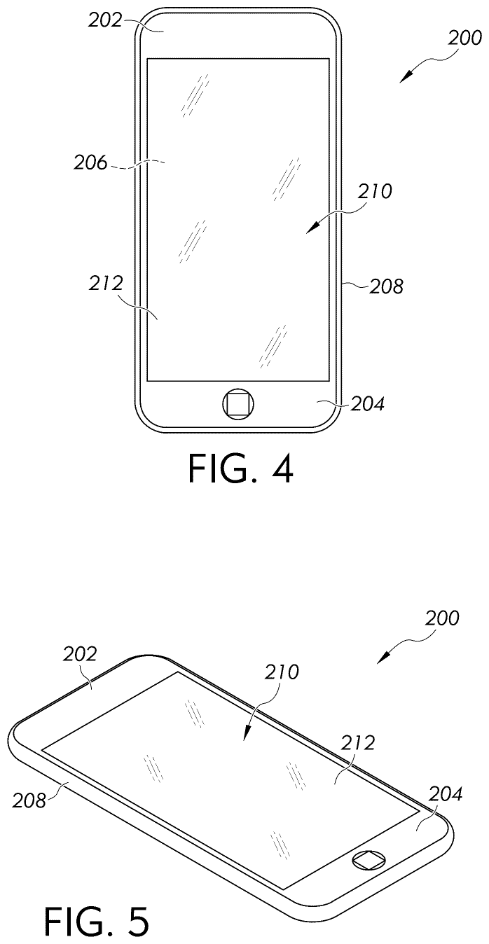

An exemplary electronic device incorporating any of the glass articles disclosed herein is shown in FIGS. 3 and 4. Specifically, FIGS. 3 and 4 show a consumer electronic device 200 including a housing 202 having front 204, back 206, and side surfaces 108; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In embodiments, at least a portion of at least one of the cover substrate 212 and the housing 202 may include any of the glass articles disclosed herein.

### EXAMPLES

In order that various embodiments be more readily understood, reference is made to the following examples, which are intended to illustrate various embodiments of the glass compositions described herein.

Table 1 shows example glass compositions and a comparative glass composition (in terms of mol %) and the respective properties of the glass compositions. Glass articles were formed having the examples glass compositions E1-E80 and comparative glass compositions C1 and C2.

TABLE 1

| Example | E1 | E2 | E3 | E4 | E5 | E6 | E7 |
|---|---|---|---|---|---|---|---|
| SiO₂ | 64.15 | 64.11 | 63.61 | 63.97 | 63.29 | 63.91 | 62.05 |
| Al₂O₃ | 17.92 | 18.00 | 17.91 | 17.92 | 17.94 | 17.91 | 19.03 |
| P₂O₅ | 0.99 | 1.97 | 0.98 | 1.97 | 0.97 | 1.97 | 0.99 |
| Na₂O | 11.26 | 11.27 | 11.48 | 11.36 | 11.59 | 11.26 | 11.73 |
| MgO | 5.49 | 4.48 | 2.91 | 2.29 | 0.12 | 0.10 | 6.05 |
| CaO | 0.04 | 0.03 | 2.95 | 2.34 | 5.94 | 4.70 | 0.04 |
| Y₂O₃ | — | — | — | — | — | — | — |
| ZrO₂ | — | — | — | — | — | — | — |
| SnO₂ | 0.01 | 0.01 | 0.01 | 0.01 | 0.01 | 0.01 | 0.01 |
| Sum | 100 | 100 | 100 | 100 | 100 | 100 | 100 |
| RO | 5.53 | 4.51 | 5.86 | 4.63 | 6.06 | 4.80 | 6.09 |
| (Na₂O + RO)/Al₂O₃ | 0.94 | 0.88 | 0.97 | 0.89 | 0.98 | 0.90 | 0.94 |
| Density (g/cm³) | 2.452 | 2.435 | 2.461 | 2.442 | 2.468 | 2.449 | 2.465 |
| CTE (×10⁻⁷/° C.) | — | — | — | — | — | — | — |
| Strain Point (° C.) | 706 | 707 | 706 | 709 | 724 | 724 | 703 |
| Anneal Point (° C.) | 755 | 760 | 755 | 762 | 772 | 777 | 751 |
| Softening Point (° C.) | — | — | — | — | — | — | 825 |
| Poisson's Ratio | 0.214 | 0.210 | 0.216 | 0.212 | 0.214 | 0.209 | 0.213 |
| Shear Modulus (GPa) | 32.1 | 31.4 | 31.9 | 31.2 | 31.6 | 31.0 | 31.9 |
| Young's Modulus (GPa) | 78.0 | 76.0 | 77.6 | 75.7 | 76.7 | 74.8 | 77.2 |
| SOC (nm/mm/MPa) | 2.977 | 3.051 | 2.96 | 3.024 | 2.94 | 3.022 | 2.942 |
| Refractive Index | 1.5078 | 1.5037 | 1.5101 | 1.5058 | 1.5128 | 1.5072 | 1.5102 |
| Zircon Breakdown (° C.) | 1235 | 1245 | 1180 | 1215 | 1150 | 1190 | 1220 |
| VFT A | −6.391 | −3.740 | −3.558 | −3.599 | −3.598 | −3.463 | −3.010 |
| VFT B | 15077 | 8821 | 8523 | 8561 | 8651 | 8281 | 6929 |
| VFT To | −111.6 | 216.1 | 225.1 | 238.3 | 204.2 | 262.8 | 322.0 |
| Liquidus Temp. (° C.) | 1360 | 1360 | 1330 | 1330 | >1330 | 1290 | 1395 |
| Liquidus Viscosity (P) | 7144 | 9354 | 14325 | 17487 | — | 39729 | 2801 |

| Example | E8 | E9 | E10 | E11 | E12 | E13 | E14 |
|---|---|---|---|---|---|---|---|
| SiO₂ | 62.15 | 61.71 | 62.17 | 61.64 | 62.02 | 63.11 | 63.55 |
| Al₂O₃ | 18.96 | 19.09 | 19.01 | 19.39 | 19.09 | 18.03 | 18.19 |
| P₂O₅ | 1.99 | 0.98 | 1.99 | — | 0.99 | 0.49 | 0.25 |
| Na₂O | 11.73 | 12.96 | 12.70 | 13.78 | 13.72 | 11.52 | 11.28 |
| MgO | 5.02 | 5.11 | 3.98 | 5.03 | 4.04 | 6.65 | 6.53 |
| CaO | 0.04 | 0.04 | 0.03 | 0.04 | 0.03 | 0.05 | 0.05 |
| Y₂O₃ | — | — | — | — | — | — | — |
| ZrO₂ | — | — | — | — | — | — | — |
| SnO₂ | 0.01 | 0.01 | 0.01 | 0.01 | 0.01 | 0.11 | 0.11 |
| Sum | 100 | 100 | 100 | 100 | 100 | 100 | 100 |
| RO | 5.06 | 5.15 | 4.01 | 5.07 | 4.07 | 6.70 | 6.58 |
| (Na₂O + RO)/Al₂O₃ | 0.89 | 0.95 | 0.88 | 0.97 | 0.93 | 1.01 | 0.98 |
| Density (g/cm³) | 2.447 | 2.457 | 2.443 | 2.471 | 2.457 | 2.459 | 2.463 |
| CTE (×10⁻⁷/° C.) | — | — | — | — | — | — | — |
| Strain Point (° C.) | 704 | 704 | 702 | 700 | 702 | 704 | 706 |
| Anneal Point (° C.) | 755 | 754 | 753 | 750 | 754 | 751 | 756 |
| Softening Point (° C.) | 832 | 831 | 830 | 827 | 831 | — | — |
| Poisson's Ratio | 0.213 | 0.220 | 0.208 | 0.216 | 0.210 | 0.224 | 0.223 |
| Shear Modulus (GPa) | 31.6 | 32.3 | 31.0 | 32.1 | 31.4 | 32.4 | 32.6 |
| Young's Modulus (GPa) | 76.8 | 78.8 | 74.9 | 78.2 | 75.8 | 79.3 | 79.9 |
| SOC (nm/mm/MPa) | 2.994 | 2.966 | 3.008 | 2.909 | 2.984 | 2.927 | 2.923 |
| Refractive Index | 1.5060 | 1.5090 | 1.5044 | 1.5121 | 1.5075 | 1.509 | 1.5115 |
| Zircon Breakdown (° C.) | 1190 | 1100 | 1230 | 1110 | 1115 | — | — |
| VFT A | −3.406 | −3.409 | −3.557 | −3.085 | −3.260 | −3.169 | −3.177 |
| VFT B | 7886 | 7833 | 8267 | 7025 | 7643 | 7374 | 7386 |
| VFT To | 264.0 | 267.8 | 248.5 | 312.3 | 285.5 | 294.3 | 292.8 |
| Liquidus Temp. (° C.) | 1400 | 1355 | 1355 | 1405 | 1320 | 1355 | 1355 |
| Liquidus Viscosity (P) | 3433 | 6252 | 8209 | 2210 | 13416 | 6073 | 5977 |

| Example | E15 | E16 | E17 | E18 | E19 | E20 | E21 |
|---|---|---|---|---|---|---|---|
| SiO₂ | 63.15 | 63.65 | 63.13 | 63.55 | 57.62 | 59.70 | 60.90 |
| Al₂O₃ | 18.09 | 18.22 | 18.05 | 18.10 | 19.34 | 18.99 | 19.03 |
| P₂O₅ | 0.49 | 0.25 | 0.49 | 0.25 | — | 0.23 | 0.47 |
| Na₂O | 11.59 | 11.26 | 11.58 | 11.29 | 13.58 | 15.14 | 14.50 |
| MgO | 3.25 | 3.22 | 0.13 | 0.13 | 9.25 | 5.73 | 4.91 |
| CaO | 3.30 | 3.24 | 6.45 | 6.53 | — | 0.05 | 0.04 |
| Y₂O₃ | — | — | — | — | — | — | — |
| ZrO₂ | — | — | — | — | — | — | — |
| SnO₂ | 0.11 | 0.11 | 0.11 | 0.11 | — | — | — |
| Sum | 100 | 100 | 100 | 100 | 100 | 100 | 100 |
| RO | 6.53 | 6.46 | 6.58 | 6.66 | 9.25 | 5.78 | 4.95 |
| (Na₂O + RO)/Al₂O₃ | 1.00 | 0.97 | 1.01 | 0.99 | | 1.10 | 1.02 |
| Density (g/cm³) | 2.467 | 2.475 | 2.478 | 2.483 | 2.485 | 2.469 | 2.467 |
| CTE (×10⁻⁷/° C.) | | | | | — | | |
| Strain Point (° C.) | 703 | 707 | 723 | 728 | — | 685 | 699 |
| Anneal Point (° C.) | 753 | 755 | 773 | 778 | — | 733 | 750 |
| Softening Point (° C.) | — | — | — | — | — | 973 | 988 |
| Poisson's Ratio | 0.220 | 0.221 | 0.219 | 0.219 | — | 0.219 | 0.219 |
| Shear Modulus (GPa) | 32.2 | 32.4 | 32.3 | 31.9 | — | 31.6 | 31.5 |
| Young's Modulus (GPa) | 78.6 | 79.2 | 78.9 | 77.8 | — | 76.9 | 76.7 |
| SOC (nm/mm/MPa) | 2.92 | 2.912 | 2.889 | 2.906 | — | 2.918 | 2.952 |
| Refractive Index | 1.512 | 1.5128 | 1.5142 | 1.5173 | — | 1.5120 | 1.5123 |
| Zircon Breakdown (° C.) | — | — | — | — | — | 1060 | 1105 |
| VFT A | −3.410 | −3.064 | −3.420 | −3.138 | — | −3.491 | −3.535 |
| VFT B | 8034 | 7217 | 7927 | 7449 | — | 8110 | 8176 |
| VFT To | 258.2 | 320.4 | 262.4 | 309.4 | — | 243.4 | 240.8 |
| Liquidus Temp. (° C.) | 1295 | 1300 | 1315 | 1305 | — | 1375 | 1340 |
| Liquidus Viscosity (P) | 21824 | 20081 | 12914 | 22081 | — | 4736 | 7996 |

| Example | E22 | E23 | E24 | E25 | E26 | E27 | E28 |
|---|---|---|---|---|---|---|---|
| SiO₂ | 60.16 | 60.38 | 58.49 | 59.34 | 62.89 | 62.84 | 61.36 |
| Al₂O₃ | 19.05 | 19.04 | 20.07 | 20.01 | 17.95 | 18.03 | 17.89 |
| P₂O₅ | 0.24 | 0.48 | 0.24 | 0.48 | 0.49 | 0.49 | 0.48 |
| Na₂O | 15.13 | 14.83 | 15.33 | 14.89 | 11.46 | 11.25 | 11.71 |
| MgO | 5.24 | 5.07 | 5.67 | 5.10 | 0.13 | 0.14 | 0.16 |
| CaO | 0.04 | 0.04 | 0.05 | 0.04 | 6.93 | 7.10 | 8.26 |
| Y₂O₃ | — | — | — | — | — | — | — |
| ZrO₂ | — | — | — | — | — | — | — |
| SnO₂ | — | — | — | — | 0.11 | 0.11 | 0.11 |
| Sum | 100 | 100 | 100 | 100 | 100 | 100 | 100 |
| RO | 5.28 | 5.11 | 5.72 | 5.14 | 7.06 | 7.24 | 8.42 |
| (Na₂O + RO)/Al₂O₃ | 1.07 | 1.05 | 1.05 | 1.00 | 1.03 | 1.03 | 1.12 |
| Density (g/cm³) | 2.474 | 2.469 | 2.481 | 2.477 | 2.481 | 2.487 | 2.494 |
| CTE (×10⁻⁷/° C.) | — | — | — | — | — | — | — |
| Strain Point (° C.) | 688 | 693 | 695 | 696 | — | — | — |
| Anneal Point (° C.) | 736 | 741 | 744 | 745 | — | — | — |
| Softening Point (° C.) | 976 | 982 | 973 | 979 | — | — | — |
| Poisson's Ratio | 0.219 | 0.216 | 0.221 | 0.220 | 0.216 | 0.214 | 0.219 |
| Shear Modulus (GPa) | 31.6 | 31.6 | 31.8 | 31.7 | 31.9 | 32.1 | 32.1 |
| Young's Modulus (GPa) | 77.0 | 76.9 | 77.6 | 77.4 | 77.6 | 77.8 | 78.3 |
| SOC (nm/mm/MPa) | 2.904 | 2.926 | 2.910 | 2.888 | 2.915 | 2.896 | 2.851 |
| Refractive Index | 1.5098 | 1.5108 | 1.5087 | 1.5097 | 1.5152 | 1.5161 | 1.5181 |
| Zircon Breakdown (° C.) | 1055 | 1075 | 1125 | 1040 | — | — | — |
| VFT A | −3.059 | −3.506 | −2.751 | −3.083 | −3.153 | −3.258 | −3.169 |
| VFT B | 7159 | 8072 | 6368 | 7035 | 7490 | 7506 | 7532 |
| VFT To | 292.2 | 243.5 | 356.6 | 315.0 | 294.4 | 295.6 | 271.8 |
| Liquidus Temp. (° C.) | 1345 | 1345 | >1400 | 1380 | 1330 | 1310 | 1315 |
| Liquidus Viscosity (P) | 5511 | 6636 | — | 3330 | 12009 | 13844 | 11251 |

| Example | E29 | E30 | E31 | E32 | E33 | E34 | E35 |
|---|---|---|---|---|---|---|---|
| SiO₂ | 61.33 | 62.30 | 61.63 | 60.19 | 59.91 | 59.67 | 59.84 |
| Al₂O₃ | 17.97 | 18.02 | 18.05 | 19.10 | 19.07 | 19.05 | 18.98 |
| P₂O₅ | 0.49 | 0.49 | 0.49 | 0.24 | 0.49 | 0.24 | 0.48 |
| Na₂O | 11.47 | 11.46 | 11.39 | 12.69 | 12.72 | 12.91 | 12.89 |
| MgO | 0.16 | 1.05 | 2.04 | 7.57 | 7.61 | 3.98 | 3.83 |
| CaO | 8.42 | 6.53 | 6.25 | 0.06 | 0.06 | 3.98 | 3.83 |
| Y₂O₃ | — | — | — | — | — | — | — |
| ZrO₂ | — | — | — | — | — | — | — |
| SnO₂ | 0.11 | 0.11 | 0.11 | — | — | — | — |
| RO | 8.58 | 7.58 | 8.29 | 7.63 | 7.67 | 7.96 | 7.66 |
| Sum | 100 | 100 | 100 | 100 | 100 | 100 | 100 |
| (Na₂O + RO)/Al₂O₃ | 1.12 | 1.06 | 1.09 | 1.06 | 1.07 | 1.10 | 1.08 |
| Density (g/cm³) | 2.5 | 2.484 | 2.494 | 2.483 | 2.48 | 2.495 | 2.493 |
| CTE (×10⁻⁷/° C.) | — | — | — | — | — | — | — |
| Strain Point (° C.) | — | — | — | 695 | 692 | 690 | 683 |
| Anneal Point (° C.) | — | — | — | 742 | 740 | 738 | 733 |
| Softening Point (° C.) | — | — | — | 963 | 966 | 961 | 962 |
| Poisson's ratio | 0.218 | 0.219 | 0.217 | 0.225 | 0.224 | 0.222 | 0.228 |
| Shear Modulus (GPa) | 32.1 | 32.1 | 32.3 | 32.6 | 32.5 | 32.5 | 32.4 |
| Young's Modulus (GPa) | 78.2 | 78.2 | 78.8 | 79.8 | 79.4 | 79.4 | 79.5 |
| SOC (nm/mm/MPa) | 2.854 | 2.896 | 2.862 | 2.884 | 2.898 | 2.851 | 2.863 |
| Refractive Index | 1.5196 | 1.5157 | 1.5184 | 1.5142 | 1.5140 | 1.5177 | 1.5186 |
| Zircon Breakdown (° C.) | — | — | — | — | — | — | — |
| VFT A | −2.679 | −3.233 | −3.125 | −3.002 | −2.631 | −2.926 | −3.242 |
| VFT B | 6358 | 7509 | 7178 | 6718 | 6092 | 6612 | 7286 |
| VFT To | 350.6 | 291.1 | 299.6 | 317.5 | 359.4 | 331.0 | 279.0 |
| Liquidus Temp. (° C.) | 1315 | 1300 | 1270 | — | — | 1230 | 1275 |
| Liquidus Viscosity (P) | 8202 | 16220 | 18696 | — | — | 26843 | 11827 |
| Fracture Toughness (MPa · m^{1/2}) | — | — | — | — | — | 0.8 | — |

| Example | E36 | E37 | E38 | E39 | E40 | E41 | E42 |
|---|---|---|---|---|---|---|---|
| SiO₂ | 59.71 | 57.77 | 60.30 | 59.61 | 60.56 | 59.59 | 60.52 |
| Al₂O₃ | 18.93 | 18.77 | 18.45 | 18.87 | 18.39 | 18.89 | 18.37 |
| P₂O₅ | 0.24 | 0.47 | 0.48 | 0.48 | 0.49 | 0.49 | 0.48 |
| Na₂O | 12.84 | 13.15 | 11.82 | 11.78 | 11.77 | 11.77 | 11.84 |
| MgO | 0.16 | 0.19 | 0.09 | 0.09 | 2.60 | 3.05 | 2.06 |
| CaO | 7.94 | 9.48 | 8.72 | 9.01 | 6.04 | 6.07 | 6.57 |
| Y₂O₃ | — | — | — | — | — | — | — |
| ZrO₂ | — | — | — | — | — | — | — |
| SnO₂ | — | — | — | — | — | — | 0.01 |
| Sum | 100 | 100 | 100 | 100 | 100 | 100 | 100 |
| RO | 7.10 | 9.67 | 8.81 | 9.10 | 8.64 | 9.12 | 8.63 |
| (Na₂O + RO)/Al₂O₃ | 1.11 | 1.22 | 1.12 | 1.11 | 1.11 | 1.11 | 1.11 |
| Density (g/cm³) | 2.506 | 2.502 | 2.507 | 2.515 | 2.500 | 2.505 | 2.501 |
| CTE (×10⁻⁷/° C.) | | | 68.4 | 69.4 | 66.4 | 66.1 | 67.3 |
| Strain Point (° C.) | 697 | 706 | 711 | 707 | 697 | 691 | 696 |
| Anneal Point (° C.) | 744 | 755 | 758 | 752 | 745 | 737 | 744 |
| Softening Point (°) | 972 | 978 | — | — | — | — | — |
| Poisson's Ratio | 0.225 | 0.220 | 0.223 | 0.226 | 0.224 | 0.226 | 0.225 |
| Shear Modulus (GPa) | 32.0 | 31.9 | 32.1 | 32.3 | 32.4 | 32.6 | 32.4 |
| Young's Modulus (GPa) | 78.5 | 77.8 | 78.6 | 79.1 | 79.3 | 80.0 | 79.4 |
| SOC (nm/mm/MPa) | 2.837 | 2.841 | 2.847 | 2.829 | 2.853 | 2.839 | 2.852 |
| Refractive Index | 1.5181 | 1.5192 | 1.5215 | 1.5231 | 1.5193 | 1.5213 | 1.5198 |
| Zircon Breakdown (° C.) | — | — | — | — | — | — | — |
| VFT A | −3.058 | −3.163 | −3.160 | −3.027 | −3.191 | −3.258 | −3.347 |
| VFT B | 6918 | 7249 | 7236 | 6903 | 7255 | 7308 | 7571 |
| VFT To | 311.1 | 291.4 | 286.6 | 295.4 | 284.6 | 277.4 | 264.4 |
| Liquidus Temp. (° C.) | 1370 | 1300 | 1300 | 1260 | 1230 | 1255 | 1240 |
| Liquidus Viscosity (P) | 2985 | 10563 | 9557 | 13469 | 30431 | 16514 | 25915 |

| Example | E43 | E44 | E45 | E46 | E47 | E48 | E49 |
|---|---|---|---|---|---|---|---|
| SiO₂ | 59.59 | 59.30 | 59.18 | 59.14 | 59.44 | 58.97 | 58.98 |
| Al₂O₃ | 18.85 | 18.89 | 18.85 | 18.72 | 18.84 | 18.90 | 18.61 |
| P₂O₅ | 0.49 | 0.24 | 0.24 | 0.24 | 0.24 | 0.24 | 0.24 |
| Na₂O | 11.86 | 13.32 | 13.34 | 13.16 | 13.39 | 13.44 | 13.31 |
| MgO | 2.06 | 3.97 | 3.91 | 3.79 | 3.91 | 3.93 | 3.99 |
| CaO | 7.00 | 3.88 | 3.82 | 3.78 | 3.79 | 3.89 | 3.80 |
| Y₂O₃ | — | 0.25 | 0.50 | 1.02 | — | — | — |
| ZrO₂ | — | — | — | — | 0.23 | 0.46 | 0.91 |
| SnO₂ | 0.01 | — | — | — | — | — | 0.01 |
| Sum | 100 | 100 | 100 | 100 | 100 | 100 | 100 |
| RO | 9.06 | 7.85 | 7.73 | 7.57 | 7.70 | 7.82 | 7.79 |
| (Na₂O + RO)/Al₂O₃ | 1.11 | 1.12 | 1.12 | 1.11 | 1.12 | 1.12 | 1.13 |
| Density (g/cm³) | 2.510 | 2.508 | 2.523 | 2.550 | 2.505 | 2.510 | 2.524 |
| CTE (×10⁻⁷/° C.) | 67.5 | 70.3 | 70.0 | 69.8 | 71.1 | 69.9 | 69.3 |
| Strain Point (° C.) | 695 | — | — | — | — | — | — |
| Anneal Point (° C.) | 741 | — | — | — | — | — | — |
| Softening Point (° C.) | — | — | — | — | — | — | — |
| Poisson's ratio | 0.226 | 0.224 | 0.225 | 0.227 | 0.225 | 0.225 | 0.223 |
| Shear Modulus (GPa) | 32.6 | 32.5 | 32.5 | 32.9 | 32.4 | 32.5 | 32.8 |
| Young's Modulus (GPa) | 79.8 | 79.4 | 79.8 | 80.6 | 79.4 | 79.6 | 80.2 |
| SOC (nm/mm/MPa) | 2.816 | 2.849 | 2.829 | 2.808 | 2.864 | 2.865 | 2.874 |
| Refractive Index | 1.522 | 1.5200 | 1.5217 | 1.5252 | — | — | — |
| Zircon Breakdown (° C.) | — | — | — | — | — | — | — |
| VFT A | −2.919 | −3.231 | −3.161 | −3.021 | −2.860 | −2.819 | −3.170 |
| VFT B | 6509 | 7220 | 6994 | 6586 | 6573 | 6461 | 6991 |
| VFT To | 344.8 | 280.1 | 296.4 | 324.4 | 322.1 | 328.6 | 298.3 |
| Liquidus Temp. (° C.) | 1260 | 1280 | 1255 | 1230 | 1275 | 1310 | >1330 |
| Liquidus Viscosity (P) | 15599 | 9766 | 13631 | 17845 | 10914 | 5818 | — |

| Example | E50 | E51 | E52 | E53 | E54 | E55 | E56 |
|---|---|---|---|---|---|---|---|
| SiO₂ | 58.44 | 58.56 | 58.44 | 58.62 | 58.48 | 58.77 | 58.59 |
| Al₂O₃ | 19.33 | 19.42 | 19.45 | 19.45 | 19.43 | 19.33 | 19.60 |
| P₂O₅ | 0.49 | 0.49 | 0.49 | 0.49 | 0.49 | 0.49 | 0.24 |
| Na₂O | 11.70 | 11.75 | 11.77 | 11.70 | 11.80 | 11.73 | 12.98 |
| MgO | 0.18 | 1.88 | 3.86 | 5.73 | 7.72 | 9.47 | 5.04 |
| CaO | 9.69 | 7.74 | 5.83 | 3.85 | 1.95 | 0.07 | 3.36 |
| Y₂O₃ | — | — | — | — | — | — | — |
| ZrO₂ | — | — | — | — | — | — | — |
| SnO₂ | 0.11 | 0.11 | 0.11 | 0.11 | 0.11 | 0.11 | — |
| Sum | 100 | 100 | 100 | 100 | 100 | 100 | 100 |
| RO | 9.87 | 9.62 | 9.69 | 9.58 | 9.67 | 9.45 | 8.40 |
| (Na₂O + RO)/Al₂O₃ | 1.12 | 1.10 | 1.10 | 1.09 | 1.10 | 1.10 | 1.09 |
| Density (g/cm³) | 2.524 | 2.518 | 2.513 | 2.507 | 2.500 | 2.496 | 2.502 |
| CTE (×10⁻⁷/° C.) | 69.1 | 67.2 | 65.6 | 63.9 | 62.3 | 61.0 | 66.3 |
| Strain Point (° C.) | 708 | 699 | 699 | 691 | 689 | 694 | 687 |
| Anneal Point (° C.) | 753 | 745 | 735 | 737 | 734 | 740 | 733 |
| Softening Point (° C.) | — | — | — | — | — | — | 963 |
| Poisson's Ratio | 0.226 | 0.229 | 0.228 | 0.228 | 0.229 | 0.227 | 0.228 |
| Shear Modulus (GPa) | 32.6 | 32.8 | 33.0 | 33.1 | 33.2 | 33.3 | 32.8 |
| Young's Modulus (GPa) | 79.9 | 80.4 | 80.9 | 81.3 | 81.8 | 81.8 | 80.5 |
| SOC (nm/mm/MPa) | 2.78 | 2.799 | 2.815 | 2.819 | 2.801 | 2.843 | 2.845 |
| Refractive Index | 1.5258 | 1.5235 | 1.5228 | 1.5210 | 1.5200 | 1.5180 | 1.5189 |
| Zircon Breakdown (° C.) | — | — | — | — | — | — | — |
| VFT A | −2.659 | −2.841 | −2.943 | −3.367 | −2.872 | — | −3.057 |
| VFT B | 5891 | 6317 | 6529 | 7340 | 6333 | — | 6964 |
| VFT To | 373.3 | 349.7 | 328.4 | 274.3 | 341.6 | — | 304.2 |
| Liquidus Temp. (° C.) | 1305 | 1310 | 1270 | 1350 | >1420 | — | 1270 |
| Liquidus Viscosity (P) | 4614 | 5457 | 9786 | 2859 | — | — | 14250 |

| Example | E57 | E58 | E59 | E60 | E61 | E62 | E63 |
|---|---|---|---|---|---|---|---|
| SiO₂ | 59.02 | 58.93 | 58.09 | 57.72 | 57.87 | 55.82 | 55.33 |
| Al₂O₃ | 19.57 | 19.53 | 20.03 | 19.97 | 20.08 | 19.90 | 19.63 |
| P₂O₅ | 0.24 | 0.24 | 0.24 | 0.24 | 0.24 | 0.23 | 0.23 |
| Na₂O | 12.78 | 12.79 | 12.71 | 13.00 | 12.91 | 12.26 | 12.48 |
| MgO | 4.09 | 3.31 | 5.20 | 4.39 | 3.47 | 0.22 | 2.43 |
| CaO | 4.14 | 5.04 | 3.56 | 4.53 | 5.26 | 11.41 | 9.75 |
| Y₂O₃ | — | — | — | — | — | — | — |
| ZrO₂ | — | — | — | — | — | — | — |
| SnO₂ | — | — | — | — | — | 0.10 | 0.10 |
| Sum | 100 | 100 | 100 | 100 | 100 | 100 | 100 |
| RO | 8.23 | 8.35 | 8.76 | 8.92 | 8.73 | 11.63 | 12.18 |
| (Na₂O + RO)/Al₂O₃ | 1.07 | 1.08 | 1.07 | 1.10 | 1.08 | 1.20 | 1.26 |
| Density (g/cm³) | 2.503 | 2.506 | 2.507 | 2.504 | 2.514 | — | — |
| CTE (×10⁻⁷/° C.) | 67.3 | 66.5 | 66.3 | 67.7 | 68.8 | — | — |
| Strain Point (° C.) | 690 | 679 | 692 | 696 | 690 | 699 | 676 |
| Anneal Point (° C.) | 738 | 726 | 738 | 743 | 737 | 745 | 721 |
| Softening Point (° C.) | 960 | 944 | 950 | 959 | 950 | — | — |
| Poisson's Ratio | 0.228 | 0.226 | 0.226 | 0.229 | 0.227 | 0.228 | 0.230 |
| Shear Modulus (GPa) | 32.7 | 32.6 | 33.0 | 33.0 | 33.2 | 33.0 | 33.1 |
| Young's Modulus (GPa) | 80.3 | 80.0 | 81.1 | 80.9 | 81.4 | 81.0 | 81.4 |
| SOC (nm/mm/MPa) | 2.833 | 2.823 | 2.819 | 2.800 | 2.801 | 2.754 | 2.736 |
| Refractive Index | 1.5201 | 1.5209 | 1.5213 | 1.5218 | 1.5231 | 1.5285 | 1.5271 |
| Zircon Breakdown (° C.) | — | — | — | — | — | — | — |
| VFT A | −3.297 | −3.297 | −3.097 | −2.929 | −3.282 | −2.883 | −2.933 |
| VFT B | 7320 | 7320 | 6928 | 6608 | 7178 | 6227 | 6347 |
| VFT To | 281.6 | 281.6 | 302.7 | 330.0 | 290.0 | 354.7 | 347.9 |
| Liquidus Temp. (° C.) | 1325 | 1260 | 1360 | 1335 | 1290 | 1290 | 1280 |
| Liquidus Viscosity (P) | 5228 | 15290 | 2856 | 4428 | 7863 | 5959 | 7517 |

| Example | E64 | E65 | E66 | E67 | E68 | E69 | E70 |
|---|---|---|---|---|---|---|---|
| SiO₂ | 58.90 | 57.27 | 56.93 | 56.03 | 56.39 | 56.38 | 55.47 |
| Al₂O₃ | 20.08 | 20.07 | 20.33 | 20.16 | 20.59 | 20.46 | 20.55 |
| P₂O₅ | 0.24 | 0.24 | 0.24 | 0.24 | 0.49 | 0.48 | 0.48 |
| Na₂O | 11.37 | 11.96 | 11.70 | 11.83 | 11.82 | 11.86 | 12.46 |
| MgO | 3.66 | 6.12 | 8.59 | 11.52 | 2.55 | 5.18 | 2.65 |
| CaO | 5.59 | 4.19 | 2.06 | 0.08 | 8.00 | 5.48 | 8.24 |
| Y₂O₃ | — | — | — | — | — | — | — |
| ZrO₂ | — | — | — | — | — | — | — |
| SnO₂ | 0.11 | 0.10 | 0.10 | 0.10 | 0.11 | 0.11 | 0.11 |
| Sum | 100 | 100 | 100 | 100 | 100 | 100 | 100 |
| RO | 9.25 | 10.31 | 10.65 | 11.60 | 10.55 | 10.66 | 10.89 |
| (Na₂O + RO)/Al₂O₃ | 1.03 | 1.11 | 1.10 | 1.16 | 1.09 | 1.10 | 1.14 |
| Density (g/cm³) | — | — | — | — | 2.532 | 2.527 | 2.545 |
| CTE (×10⁻⁷/° C.) | — | — | — | — | 67.1 | 63.7 | 70.7 |
| Strain Point (° C.) | 693 | 677 | 689 | 682 | — | 682 | 689 |
| Anneal Point (° C.) | 738 | 723 | 734 | 724 | — | 726 | 735 |
| Softening Point (° C.) | — | — | — | — | 921 | 938 | 934 |
| Poisson's Ratio | 0.229 | 0.229 | 0.234 | 0.230 | 0.229 | 0.229 | 0.229 |
| Shear Modulus (GPa) | 33.3 | 33.2 | 34.1 | 33.7 | 33.3 | 33.8 | 33.3 |
| Young's Modulus (GPa) | 81.9 | 81.6 | 84.3 | 83.0 | 81.9 | 83.1 | 81.8 |
| SOC (nm/mm/MPa) | 2.785 | 2.790 | 2.801 | 2.817 | 2.718 | 2.731 | 2.703 |
| Refractive Index | 1.5249 | 1.5239 | 1.5224 | 1.5203 | 1.5279 | 1.5264 | 1.5286 |
| Zircon Breakdown (° C.) | — | — | — | — | — | — | — |
| VFT A | −2.737 | −2.923 | −3.154 | −2.721 | −2.806 | −2.776 | −3.223 |
| VFT B | 6011 | 6287 | 6695 | 5866 | 6210 | 6118 | 6950 |
| VFT To | 362.8 | 342.1 | 316.9 | 372.5 | 365.0 | 364.6 | 310.0 |
| Liquidus Temp. (° C.) | 1240 | 1400 | >1420 | >1410 | >1305 | >1335 | 1280 |
| Liquidus Viscosity (P) | 13039 | 1046 | — | — | — | — | 8743 |

| Example | E71 | E72 | E73 | E74 | E75 | E76 | E77 |
|---|---|---|---|---|---|---|---|
| SiO₂ | 55.57 | 55.22 | 54.63 | 59.47 | 58.63 | 57.30 | 58.23 |
| Al₂O₃ | 20.54 | 20.90 | 21.08 | 18.42 | 18.31 | 18.05 | 19.26 |
| P₂O₅ | 0.48 | 0.47 | 0.48 | 0.25 | 0.25 | 0.25 | 0.49 |
| Na₂O | 12.49 | 12.22 | 12.44 | 12.44 | 12.31 | 12.04 | 11.04 |
| MgO | 5.24 | 2.69 | 5.56 | 3.59 | 3.63 | 3.62 | 3.64 |
| CaO | 5.53 | 8.33 | 5.64 | 3.69 | 3.73 | 3.68 | 5.68 |
| Y₂O₃ | — | — | — | 2.01 | 3.01 | 4.92 | 1.52 |
| ZrO₂ | — | — | — | — | — | — | — |
| SnO₂ | 0.11 | 0.11 | 0.11 | 0.10 | 0.10 | 0.10 | 0.10 |
| Sum | 100 | 100 | 100 | 100 | 100 | 100 | 100 |
| RO | 10.77 | 11.02 | 11.20 | 7.28 | 7.36 | 7.30 | 9.32 |
| (Na₂O + RO)/Al₂O₃ | 1.13 | 1.11 | 1.12 | 1.07 | 1.07 | 1.07 | 1.06 |
| Density (g/cm³) | 2.531 | 2.542 | 2.538 | 2.602 | 2.655 | 2.76 | 2.592 |
| CTE (×10⁻⁷/° C.) | — | — | — | 67.2 | 67.3 | 68.6 | 63.5 |
| Strain Point (° C.) | 685 | 687 | 671 | — | — | — | 697 |
| Anneal Point (° C.) | 730 | 732 | 718 | — | — | — | 744 |
| Softening Point (° C.) | 942 | 946 | 924 | — | — | — | — |
| Poisson's Ratio) | 0.233 | 0.228 | 0.231 | 0.223 | 0.232 | 0.232 | 0.229 |
| Shear Modulus (GPa) | 33.9 | 33.4 | 33.6 | 33.7 | 34.3 | 35.2 | 34.1 |
| Young's Modulus (GPa) | 83.6 | 82.1 | 82.9 | 82.4 | 84.4 | 86.7 | 83.8 |
| SOC (nm/mm/MPa) | 2.732 | 2.729 | 2.753 | 2.768 | 2.739 | 2.627 | 2.763 |
| Refractive Index | 1.5266 | 1.5294 | 1.5272 | 1.5334 | 1.5414 | 1.5570 | 1.5346 |
| Zircon Breakdown (° C.) | — | — | — | — | — | — | — |
| VFT A | −1.323 | −2.859 | −3.199 | −2.679 | −2.091 | −2.861 | −2.556 |
| VFT B | 3341 | 6158 | 6857 | 5721 | 4371 | 5910 | 5004 |
| VFT To | 651.3 | 351.5 | 293.5 | 376.7 | 506.1 | 379.8 | 452.5 |
| Liquidus Temp. l (° C.) | ~1370 | 1285 | >1320 | 1215 | 1310 | 1415 | 1190 |
| Liquidus Viscosity (P) | — | 5462 | — | 13981 | 2216 | 705 | 16968 |
| Fracture Toughness (MPa · m^{1/2}) | — | 0.81 | — | — | — | — | — |

| Example | E78 | E79 | E80 |
|---|---|---|---|
| SiO₂ | 58.02 | 57.52 | 60.1 |
| Al₂O₃ | 18.51 | 19.68 | 19.2 |
| P₂O₅ | 0.49 | 0.25 | — |
| Na₂O | 10.85 | 12.46 | 12.8 |
| MgO | 3.46 | 3.33 | 3.9 |
| CaO | 5.51 | 5.10 | 3.9 |
| Y₂O₃ | 3.02 | 1.52 | — |
| ZrO₂ | — | — | — |
| SnO₂ | 0.10 | 0.11 | 0.1 |
| Sum | 100 | 100 | 100 |
| RO | 8.97 | 8.43 | 7.8 |
| (Na₂O + RO)/Al₂O₃ | 1.07 | 1.06 | 0.26 |
| Density (g/cm³) | 2.674 | 2.592 | 2.503 |
| CTE (×10⁻⁷/° C.) | 63.8 | 67.6 | — |
| Strain Point (° C.) | 704 | 694 | 682 |
| Anneal Point (° C.) | 748 | 740 | 729 |
| Softening Point (° C.) | — | — | 955 |
| Poisson's Ratio | 0.228 | 0.227 | 0.224 |
| Shear Modulus (GPa) | 34.9 | 33.9 | 32.7 |
| Young's Modulus (GPa) | 85.6 | 83.2 | 80.1 |
| SOC (nm/mm/MPa) | 2.683 | 2.756 | 2.802 |
| Refractive Index | 1.5461 | 1.5337 | 1.519 |
| Zircon Breakdown (° C.) | — | — | — |
| VFT A | −2.882 | −2.882 | −3.218 |
| VFT B | 5942 | 5942 | 7349 |
| VFT To | 374.8 | 374.8 | 275.1 |
| Liquidus Temp. (° C.) | 1275 | 1270 | 1290 |
| Liquidus Viscosity (P) | 5236 | 5700 | 10537 |
| Fracture Toughness (MPa · m^{1/2}) | 0.81 | — | — |

| Example | C1 | C2 |
|---|---|---|
| SiO₂ | 66.37 | 67.37 |
| B₂O₃ | 0.60 | 3.73 |
| Al₂O₃ | 10.29 | 12.65 |
| Na₂O | 13.80 | 13.72 |
| K₂O | 2.40 | 0.01 |
| MgO | 5.74 | 2.36 |
| CaO | 0.59 | 0.04 |
| SnO₂ | 0.21 | 0.10 |
| Fe₂O₃ | — | 0.01 |
| Sum | 100.00 | 100.00 |
| RO | 6.33 | 2.40 |
| (Na₂O + RO)/Al₂O₃ | 1.96 | 1.27 |
| Young's Modulus (GPa) | 72.9 | 69.3 |
| Strain Point (° C.) | 553 | 572 |
| Fracture Toughness (MPa · m^{1/2}) | 0.73 | 0.66 |

As indicated by the example glass compositions in Table 1, glass compositions and the resultant glass articles as described herein have increased Young's Modulus and fracture toughness such that the glass compositions and the resultant glass articles are more resistant to damage.

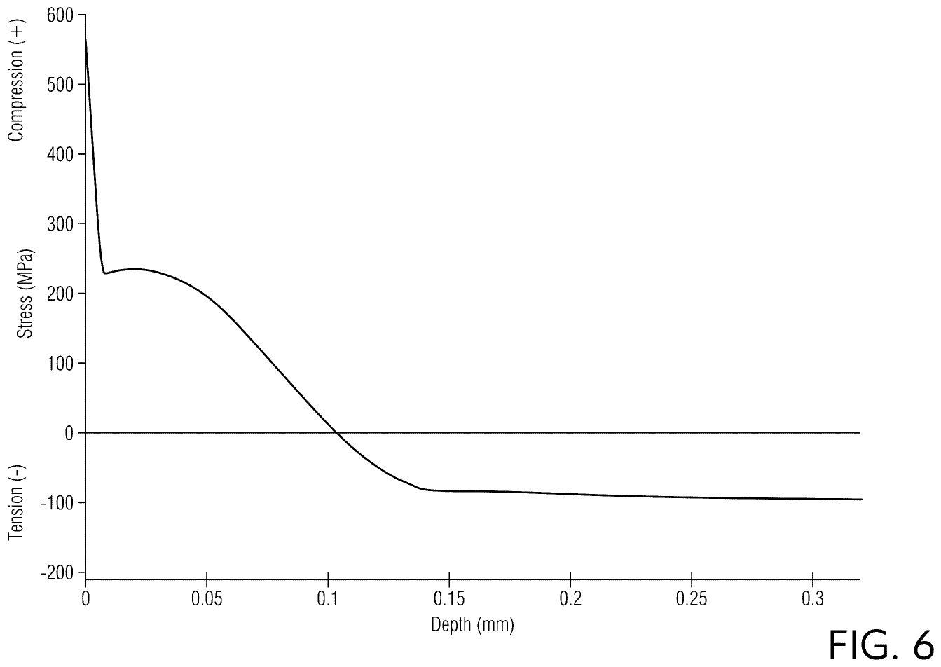

Referring now to FIG. 6, example glass composition E42 having a thickness of 0.6 mm was first ion exchanged in a 18.2% NaNO₃/54.9% KNO₃/6.6% Na₂SO₄/20.3% K₂SO₄ molten salt bath at 600° C. for 16 hours and then ion exchanged in a 100% KNO₃ molten salt bath at 370° C. for 1 hour. As shown by the grey region in FIG. 6, the stress profile had a knee region, indicated by the flat, greater-than-200 MPa compressive stress for up to 8% of the thickness of the glass. While not wishing to be bound by theory, it is believed that the knee region is the result of ion exchanging the glass article and a relatively high temperature. It is also believed that the relatively high strain point of example glass composition E42 (i.e., 696° C.) prevented the glass article from relaxing an undesirable amount during ion exchange.

Table 2 shows the CS, DOL, and CT of example ion exchanged glass articles EA1-EA36 formed by ion exchanging glass articles having a thickness of 0.6 mm and made from example glass compositions, as indicated in Table 2, at a temperature of 530° C. for 4, 9, and 16 hours. The ion exchange solution was a 88.5% KNO₃/11.5% K₂SO₄ molten salt bath.

TABLE 2

| | Example | | | | |
|---|---|---|---|---|---|
| | EA1 | EA2 | EA3 | EA4 | EA5 |
| Composition | E26 | E27 | E28 | E30 | E31 |

16 hours

| CS (MPa) | 653 | 644 | 652 | 665 | 685 |
|---|---|---|---|---|---|
| DOL (μm) | 113 | 106 | 100 | 106 | 94 |
| CT (MPa) | 148 | 137 | 124 | 145 | 111 |
| | Example | | | | |
| | EA6 | EA7 | EA8 | EA9 | EA10 |
| Composition | E32 | E33 | E35 | E36 | E37 |

4 hours

| | | | | | |
|---|---|---|---|---|---|
| CS (MPa) | 831 | 816 | 856 | — | 828 |
| DOL (μm) | 56 | 56 | 54 | — | 57 |
| CT (MPa) | 83 | 73 | 80 | — | 67 |

9 hours

| | | | | | |
|---|---|---|---|---|---|
| CS (MPa) | 766 | 751 | 773 | 783 | — |
| DOL (μm) | 83 | 87 | 82 | 80 | — |
| CT (MPa) | 118 | 128 | 124 | 120 | — |

16 hours

| CS (MPa) | — | 706 | 720 | 689 | 716 |
|---|---|---|---|---|---|
| DOL (μm) | — | 107 | 109 | 111 | 112 |
| CT (MPa) | — | 138 | 157 | 129 | 143 |
| | Example | | | | |
| | EA11 | EA12 | EA13 | EA14 | EA15 |
| Composition | E38 | E39 | E40 | E41 | E42 |

4 hours

| | | | | | |
|---|---|---|---|---|---|
| CS (MPa) | 803 | 851 | 832 | 859 | — |
| DOL (μm) | 44 | 44 | 42 | 41 | — |
| CT (MPa) | 52 | 58 | 58 | 55 | — |

9 hours

| | | | | | |
|---|---|---|---|---|---|
| CS (MPa) | 756 | 780 | 792 | 801 | 778 |
| DOL (μm) | 67 | 60 | 68 | 59 | 64 |
| CT (MPa) | 73 | 74 | 81 | 73 | 86 |

16 hours

| CS (MPa) | 701 | 725 | 738 | 750 | 725 |
|---|---|---|---|---|---|
| DOL (μm) | 92 | 83 | 85 | 79 | 89 |
| CT (MPa) | 110 | 97 | 96 | 97 | 113 |
| | Example | | | | |
| | EA16 | EA17 | EA18 | EA19 | EA20 |
| Composition | E43 | E44 | E45 | E46 | E50 |

4 hours

| | | | | | |
|---|---|---|---|---|---|
| CS (MPa) | 863 | — | — | — | 810 |
| DOL (μm) | 39 | — | — | — | 38 |
| CT (MPa) | 57 | — | — | — | 49 |

9 hours

| | | | | | |
|---|---|---|---|---|---|
| CS (MPa) | 799 | — | — | — | 765 |
| DOL (μm) | 61 | — | — | — | 58 |
| CT (MPa) | 82 | — | — | — | 77 |

16 hours

| CS (MPa) | 749 | 781 | 789 | 802 | 712 |
|---|---|---|---|---|---|
| DOL (μm) | 82 | 106 | 107 | 98 | 75 |
| CT (MPa) | 109 | 135 | 141 | 138 | 99 |
| | Example | | | | |
| | EA21 | EA22 | EA23 | EA24 | EA25 |
| Composition | E51 | E52 | E53 | E54 | E56 |

4 hours

| | | | | | |
|---|---|---|---|---|---|
| CS (MPa) | 827 | 848 | 837 | 831 | 887 |
| DOL (μm) | 29 | 37 | 38 | 36 | 48 |
| CT (MPa) | 44 | 56 | 53 | 42 | 69 |

9 hours

| | | | | | |
|---|---|---|---|---|---|
| CS (MPa) | 789 | 788 | 790 | 769 | 812 |
| DOL (μm) | 55 | 56 | 56 | 51 | 73 |
| CT (MPa) | 66 | 73 | 79 | 74 | 104 |

16 hours

| CS (MPa) | 737 | 727 | 736 | 733 | 750 |
|---|---|---|---|---|---|
| DOL (μm) | 74 | 75 | 74 | 52 | 98 |
| CT (MPa) | 96 | 107 | 94 | — | 125 |
| | Example | | | | |
| | EA26 | EA27 | EA28 | EA29 | EA30 |
| Composition | E57 | E58 | E59 | E60 | E61 |

4 hours

| | | | | | |
|---|---|---|---|---|---|
| CS (MPa) | 879 | 894 | 885 | 886 | 905 |
| DOL (μm) | 39 | 49 | 44 | 38 | 44 |
| CT (MPa) | 60 | 76 | 73 | 59 | 68 |

9 hours

| | | | | | |
|---|---|---|---|---|---|
| CS (MPa) | 820 | 802 | — | 811 | 831 |
| DOL (μm) | 73 | 75 | — | 69 | 67 |
| CT (MPa) | 113 | 128 | — | 115 | 97 |

16 hours

| | | | | | |
|---|---|---|---|---|---|
| CS (MPa) | 755 | 738 | 752 | 781 | 783 |
| DOL (μm) | 96 | 90 | 87 | 87 | 88 |
| CT (MPa) | 138 | 136 | 131 | 119 | 104 |

| | Example | | | | | |
|---|---|---|---|---|---|---|
| | EA31 | EA32 | EA33 | EA34 | EA35 | EA36 |
| Composition | E74 | E75 | E76 | E77 | E78 | E79 |

16 hours

| | | | | | | |
|---|---|---|---|---|---|---|
| CS (MPa) | 830 | 849 | 787 | 804 | 810 | 845 |
| DOL (μm) | 79 | 73 | 102 | 50 | 41 | 69 |
| CT (MPa) | 108 | 93 | 128 | 62 | 72 | 88 |

As indicated by the example ion exchanged glass articles in Table 2, glass articles formed from the glass compositions having increased Young's Modulus and K_{Ic} fracture toughness as described herein may be ion exchanged in one step to achieve desired stress profiles.

Table 3 shows the CS, DOL, and CT of example ion exchanged glass articles EA37-EA75 formed by ion exchanging glass articles having a thickness of 0.6 mm and made from example glass compositions, as indicated in Table 3, at a temperature of 600° C. for 4, 9, and 16 hours. The ion exchange solution was a 88.5% KNO₃/11.5% K₂SO₄ molten salt bath.

TABLE 3

| | Example | | | | |
|---|---|---|---|---|---|
| | EA37 | EA38 | EA39 | EA40 | EA41 |
| Composition | E3 | E4 | E32 | E33 | E34 |

4 hours

| | | | | | |
|---|---|---|---|---|---|
| CS (MPa) | 479 | — | 581 | 521 | 543 |
| DOL (μm) | 127 | — | 105 | 110 | 102 |
| CT (MPa) | 109 | — | 119 | 145 | 116 |

9 hours

| | | | | | |
|---|---|---|---|---|---|
| CS (MPa) | — | — | 481 | 454 | 379 |
| DOL (μm) | — | — | 162 | 176 | 172 |
| CT (MPa) | — | — | 170 | 182 | — |

16 hours

| CS (MPa) | 336 | 247 | 376 | 377 | 359 |
|---|---|---|---|---|---|
| DOL (μm) | 228 | 262 | 207 | 211 | 206 |
| CT (MPa) | 239 | 249 | 211 | 194 | 212 |
| | Example | | | | |
| | EA42 | EA43 | EA44 | EA45 | EA46 |
| Composition | E35 | E36 | E37 | E38 | E39 |

4 hours

| | | | | | |
|---|---|---|---|---|---|
| CS (MPa) | 551 | 547 | 523 | 539 | 525 |
| DOL (μm) | 108 | 109 | 112 | 88 | 84 |
| CT (MPa) | 122 | 116 | 119 | 84 | 74 |

9 hours

| | | | | | |
|---|---|---|---|---|---|
| CS (MPa) | 423 | — | 521 | 442 | 439 |
| DOL (μm) | 160 | — | 165 | 135 | 124 |
| CT (MPa) | 177 | — | 161 | 133 | 112 |

16 hours

| CS (MPa) | 376 | — | — | 363 | 491 |
|---|---|---|---|---|---|
| DOL (μm) | 210 | — | — | 171 | 164 |
| CT (MPa) | 220 | 196 | 196 | 170 | 155 |
| | Example | | | | |
| | EA47 | EA48 | EA49 | EA50 | EA51 |
| Composition | E40 | E41 | E42 | E43 | E44 |

4 hours

| | | | | | |
|---|---|---|---|---|---|
| CS (MPa) | 530 | 547 | 530 | 572 | — |
| DOL (μm) | 94 | 83 | 91 | 84 | — |
| CT (MPa) | 88 | 85 | 86 | 83 | — |

9 hours

| | | | | | |
|---|---|---|---|---|---|
| CS (MPa) | 460 | 551 | 518 | 464 | — |
| DOL (μm) | 139 | 129 | 135 | 120 | — |
| CT (MPa) | 125 | 122 | 135 | 116 | — |

16 hours

| CS (MPa) | 391 | 515 | 376 | 428 | 411 |
|---|---|---|---|---|---|
| DOL (μm) | 175 | 152 | 164 | 157 | 217 |
| CT (MPa) | 165 | 141 | 166 | 153 | 221 |
| | Example | | | | |
| | EA52 | EA53 | EA54 | EA55 | EA56 |
| Composition | E45 | E46 | E50 | E51 | E52 |

4 hours

| | | | | | |
|---|---|---|---|---|---|
| CS (MPa) | — | — | 523 | 645 | 549 |
| DOL (μm) | — | — | 75 | 84 | 80 |
| CT (MPa) | — | — | 85 | 93 | 79 |

9 hours

| | | | | | |
|---|---|---|---|---|---|
| CS (MPa) | — | — | 489 | 509 | 528 |
| DOL (μm) | — | — | 110 | 111 | 111 |
| CT (MPa) | — | — | 137 | 131 | 108 |

16 hours

| CS (MPa) | 399 | 387 | — | 410 | 412 |
|---|---|---|---|---|---|
| DOL (μm) | 203 | 188 | — | 148 | 140 |
| CT (MPa) | 218 | 208 | — | 174 | 155 |
| | Example | | | | |
| | EA57 | EA58 | EA59 | EA60 | EA61 |
| Composition | E53 | E54 | E56 | E57 | E58 |

4 hours

| | | | | | |
|---|---|---|---|---|---|
| CS (MPa) | 558 | 530 | 534 | 607 | — |
| DOL (μm) | 78 | 71 | 100 | 102 | 81 |
| CT (MPa) | 81 | 57 | 114 | 129 | 120 |

9 hours

| | | | | | |
|---|---|---|---|---|---|
| CS (MPa) | 449 | 455 | 498 | 516 | 490 |
| DOL (μm) | 111 | 114 | 138 | 137 | 142 |
| CT (MPa) | 124 | 98 | 158 | 175 | 185 |

16 hours

| CS (MPa) | 409 | 451 | 396 | 423 | 424 |
|---|---|---|---|---|---|
| DOL (μm) | 142 | 148 | 179 | 194 | 188 |
| CT (MPa) | 175 | 150 | 212 | 226 | 234 |
| | Example | | | | |
| | EA62 | EA63 | EA64 | EA65 | EA66 |
| Composition | E59 | E60 | E61 | E62 | E63 |

4 hours

| | | | | | |
|---|---|---|---|---|---|
| CS (MPa) | 604 | 554 | 611 | — | — |
| DOL (μm) | 95 | 84 | 92 | — | — |
| CT (MPa) | 131 | 113 | 120 | — | — |

9 hours

| | | | | | |
|---|---|---|---|---|---|
| CS (MPa) | 490 | 519 | 499 | — | — |
| DOL (μm) | 129 | 129 | 127 | — | — |
| CT (MPa) | 168 | 144 | 147 | — | — |

16 hours

| CS (MPa) | 430 | 388 | 469 | 448 | 480 |
|---|---|---|---|---|---|
| DOL (μm) | 169 | 154 | 166 | 126 | 127 |
| CT (MPa) | 211 | 207 | 188 | 148 | 148 |
| | Example | | | | |
| | EA67 | EA68 | EA69 | EA70 | EA71 |
| Composition | E64 | E70 | E72 | E74 | E75 |

4 hours

| | | | | | |
|---|---|---|---|---|---|
| CS (MPa) | — | 576 | 553 | 724 | 652 |
| DOL (μm) | — | 71 | 67 | 79 | 75 |
| CT (MPa) | — | 87 | 83 | 95 | 81 |

9 hours

| | | | | | |
|---|---|---|---|---|---|
| CS (MPa) | — | — | 454 | — | — |
| DOL (μm) | — | — | 88 | — | — |
| CT (MPa) | — | — | 105 | 135 | 95 |

16 hours

| | | | | | |
|---|---|---|---|---|---|
| CS (MPa) | 511 | 482 | — | — | — |
| DOL (μm) | 128 | 129 | — | — | — |
| CT (MPa) | 131 | 142 | — | 160 | 138 |

Example

| | | | | |
|---|---|---|---|---|
| | EA72 | EA73 | EA74 | EA75 |
| Composition | E76 | E77 | E78 | E79 |

4 hours

| | | | | |
|---|---|---|---|---|
| CS (MPa) | — | 598 | 674 | 642 |
| DOL (μm) | — | 56 | 45 | 69 |
| CT (MPa) | 91 | 59 | 46 | 80 |

9 hours

| | | | | |
|---|---|---|---|---|
| CT (MPa) | 125 | 82 | 101 | 112 |

16 hours

| | | | | |
|---|---|---|---|---|
| CT (MPa) | 169 | 107 | 136 | 133 |

As indicated by the example ion exchanged glass articles in Table 3, glass articles formed from the glass compositions having increased Young's Modulus and K_{Ic} fracture toughness as described herein may be ion exchanged in one step to achieve desired stress profiles.

Table 4 shows the CS, DOL, and CT example ion exchanged glass articles EA76-EA90 formed by ion exchanging glass articles having a thickness of 0.6 mm and made from example glass compositions, as indicated in Table 4, in a first ion exchange step at a temperature of 600° C. for 4, 9, and 16 hours in a 18.2% NaNO₃/54.9% KNO₃/6.6% Na₂SO₄/20.3% K₂SO₄ molten salt bath.

TABLE 4

| | Example | | | | |
|---|---|---|---|---|---|
| | EA76 | EA77 | EA78 | EA79 | EA80 |
| Composition | E38 | E39 | E40 | E42 | E43 |

4 hours

| CS (MPa) | 385 | 394 | 387 | 396 | 413 |
|---|---|---|---|---|---|
| DOL (μm) | 84 | 77 | 81 | 81 | 74 |
| CT (MPa) | 53 | 49 | 50 | 55 | 50 |
| | Example | | | | |
| | EA81 | EA82 | EA83 | EA84 | EA85 |
| Composition | E38 | E39 | E40 | E42 | E43 |

9 hours

| CS (MPa) | 408 | 305 | 396 | 373 | 315 |
|---|---|---|---|---|---|
| DOL (μm) | 107 | 103 | 116 | 120 | 102 |
| CT (MPa) | 69 | 68 | 76 | 75 | 69 |
| | Example | | | | |
| | EA86 | EA87 | EA88 | EA89 | EA90 |
| Composition | E38 | E39 | E40 | E42 | E43 |

16 hours

| | | | | | |
|---|---|---|---|---|---|
| CS (MPa) | — | — | 404 | 408 | 306 |
| DOL (μm) | — | — | 146 | 143 | 120 |
| CT (MPa) | 102 | 87 | 100 | 99 | 94 |

As indicated by the example ion exchanged glass articles in Table 4, glass articles formed from the glass compositions having increased Young's Modulus and K_{Ic} fracture toughness as described herein may be ion exchanged in a single step to achieve desired stress profiles.

Table 5 shows the CS, DOL, and CT example ion exchanged glass articles EA91-EA96 formed by ion exchanging glass articles having a thickness of 0.6 mm and made from example glass compositions, as indicated in Table 5, in a first ion exchange step at a temperature of 600° C. for 4, 9, and 16 hours in a 18.2% NaNO₃/54.9% KNO₃/6.6% Na₂SO₄/20.3% K₂SO₄ molten salt bath. Table 5 also shows the CS, DOL, DOC, CT, Knee, and Knee Stress of the glass articles achieved by subjecting the glass articles to a second ion exchange step at a temperature of 410° C. for 1 hour. DOL, Knee, and Knee Stress were measured by RNF.

TABLE 5

| Example | EA91 | EA92 |
|---|---|---|
| Composition | E3 | E4 |

Step 1-4 hours

| | | |
|---|---|---|
| CS (MPa) | 403 | 371 |
| DOL (μm) | 95 | 118 |
| CT (MPa) | 80 | 97 |

Step 2-1 hour

| CS (MPa) | 706 | 641 |
|---|---|---|
| Knee (μm) | 12 | 13 |
| Knee Stress (MPa) | 332 | 318 |
| DOC (μm) | 70 | 78 |
| CT (MPa) | 89 | 107 |
| Example | EA93 | EA94 |
| Composition | E3 | E4 |

Step 1-9 hours

| | | |
|---|---|---|
| CS (MPa) | 348 | 323 |
| DOL (μm) | 137 | 165 |
| CT (MPa) | 115 | 142 |

Step 2-1 hour

| CS (MPa) | 653 | 567 |
|---|---|---|
| Knee (μm) | 12 | 16 |
| Knee Stress (MPa) | 307 | 254 |
| DOC (μm) | 93 | 101 |
| CT (MPa) | 125 | 149 |
| Example | EA95 | EA96 |
| Composition | E3 | E4 |

Step 1-16 hours

| | | |
|---|---|---|
| CS (MPa) | 290 | 243 |
| DOL (μm) | 209 | 248 |
| CT (MPa) | 159 | 168 |

Step 2-1 hour

| | | |
|---|---|---|
| CS (MPa) | 602 | 507 |
| Knee (μm) | 14 | — |
| Knee Stress (MPa) | 244 | — |
| DOC (μm) | 112 | — |
| CT (MPa) | 169 | 184 |

As indicated by the example ion exchanged glass articles in Table 5, glass articles formed from the glass compositions having increased Young's Modulus and K_{Ic} fracture toughness as described herein may be ion exchanged in two steps to achieve desired stress profiles.

Table 6 shows the CS, DOL, and CT of example ion exchanged glass articles EA97-EA120 formed by ion exchanging glass articles having a thickness of 0.8 mm and made from example glass compositions, as indicated in Table 6, in a first ion exchange step at a temperature of 600° C. for 4, 9, and 16 hours in a 18.2% NaNO₃/54.9% KNO₃, 6.6% Na₂SO₄, 20.3% K₂SO₄ molten salt bath. Table 6 also shows the CS, DOL, DOC, CT, Knee, and Knee Stress of the glass articles achieved by subjecting the glass articles to a second ion exchange step at a temperature of 410° C. for 1 hour. DOL, Knee, and Knee Stress were measured by RNF.

TABLE 6

| Example | EA97 | EA98 | EA99 | EA100 |
|---|---|---|---|---|
| Composition | E20 | E22 | E23 | E24 |

Step 1-4 hours

| | | | | |
|---|---|---|---|---|
| CS (MPa) | 409 | 389 | 401 | 373 |
| DOL (μm) | 128 | 139 | 127 | 134 |
| CT (MPa) | 71 | 77 | 68 | 69 |

Step 2-1 hour

| CS (MPa) | 840 | 802 | 827 | 852 |
|---|---|---|---|---|
| Knee (μm) | 18 | 22 | 15 | 14 |
| Knee Stress (MPa) | 332 | 305 | 346 | 330 |
| DOC (μm) | 95 | 101 | 101 | 87 |
| CT (MPa) | 78 | 79 | 76 | 78 |
| Example | EA101 | EA102 | EA103 | EA104 |
| Composition | E20 | E22 | E23 | E24 |

Step 1-9 hours

| | | | | |
|---|---|---|---|---|
| CS (MPa) | 345 | 324 | 329 | 346 |
| DOL (μm) | 204 | 209 | 220 | 205 |
| CT (MPa) | 92 | 94 | 100 | 83 |

Step 2-1 hour

| CS (MPa) | 825 | 826 | 813 | 880 |
|---|---|---|---|---|
| Knee (μm) | 14 | 22 | 19 | 14 |
| Knee Stress (MPa) | 249 | 255 | 304 | 220 |
| DOC (μm) | 124 | 127 | 134 | 129 |
| CT (MPa) | 83 | 93 | 97 | 87 |
| Example | EA105 | EA106 | EA107 | EA108 |
| Composition | E20 | E22 | E23 | E24 |

Step 1-16 hours

| | | | | |
|---|---|---|---|---|
| CS (MPa) | 249 | 263 | 265 | 237 |
| DOL (μm) | 242 | 276 | 281 | 262 |
| CT (MPa) | 123 | 125 | 135 | 135 |

Step 2-1 hour

| | | | | |
|---|---|---|---|---|
| CS (MPa) | 786 | 763 | 755 | 777 |
| Knee (μm) | 20 | 21 | 16 | 20 |
| Knee Stress (MPa) | 214 | 233 | 253 | 218 |
| DOC (μm) | 158 | 167 | 169 | 154 |
| CT (MPa) | 132 | 149 | 140 | 140 |

As indicated by the example ion exchanged glass articles in Table 6, glass articles formed from the glass compositions having increased Young's Modulus and K_{Ic} fracture toughness as described herein may be ion exchanged in two steps to achieve desired stress profiles.

Table 7 shows the DOC and CT of example ion exchanged glass articles EA109-EA123 formed by ion exchanging glass articles having a thickness of 0.5 mm and made from example glass compositions, as indicated in Table 7, at a temperature of 600° C. for 16 hours or 25 hours in each of a 88.5% KNO₃/11.5% K₂SO₄ molten salt bath, 8.2% NaNO₃/74.1% KNO₃/1.7% Na₂SO₄/16.0% K₂SO₄ molten salt bath, 14.6% NaNO₃/58.5% KNO₃/5.3% Na₂SO₄/21.6% K₂SO₄ molten salt bath, 22.0% NaNO₃/51.2% KNO₃/7.9% Na₂SO₄/18.9% K₂SO₄ molten salt bath, and 29.3% NaNO₃/44.0% KNO₃/10.5% Na₂SO₄/16.2% K₂SO₄ molten salt bath.

TABLE 7

| Example | EA109 | EA110 | EA111 |
|---|---|---|---|
| Composition | E34 | E72 | E78 |
| | 16 hours \| 88.5% KNO₃/11.5% K₂SO₄ | | |
| CT (MPa) | 274 | 176 | 121 |
| | 25 hours \| 88.5% KNO₃/11.5% K₂SO₄ | | |
| CT (MPa) | 291 | 207 | 128 |
| | — | | |
| Example | EA112 | EA113 | EA114 |
| Composition | E34 | E72 | E78 |
| | 16 hours \| 8.2% NaNO₃/74.1% KNO₃/ | | |
| | 1.7% Na₂SO₄/16.0% K₂SO₄ | | |
| DOC (μm) | — | — | 55 |
| CT (MPa) | 178 | 103 | 69 |
| | 25 hours \| 8.2% NaNO₃, 74.1% KNO₃, | | |
| | 1.7% Na₂SO₄, 16.0% K₂SO₄ | | |
| DOC (μm) | — | 88 | 64 |
| CT (MPa) | 217 | 124 | 87 |
| Example | EA115 | EA116 | EA117 |
| Composition | E34 | E72 | E78 |
| | 16 hours \| 14.6% NaNO₃/58.5% KNO₃/ | | |
| | 5.3% Na₂SO₄/21.6% K₂SO₄ | | |
| DOL (μm) | 157 | — | — |
| DOC (μm) | 101 | 74 | 55 |
| CT (MPa) | 150 | 81 | 53 |
| | 25 hours \| 14.6% NaNO₃/58.5% KNO₃/ | | |
| | 5.3% Na₂SO₄/21.6% K₂SO₄ | | |
| DOL (μm) | 188 | — | — |
| DOC (μm) | 122 | 86 | 65 |
| CT (MPa) | 173 | 97 | 71 |

| Example | EA118 | EA119 |
|---|---|---|
| Composition | E34 | E72 |
| | 16 hours \| 22.0% NaNO₃/51.2% KNO₃/ | |
| | 7.9% Na₂SO₄/18.9% K₂SO₄ | |
| DOL (μm) | 151 | — |
| DOC (μm) | 103 | 69 |
| CT (MPa) | 116 | 57 |
| | 25 hours \| 22.0% NaNO₃/51.2% KNO₃/ | |
| | 7.9% Na₂SO₄/18.9% K₂SO₄ | |
| DOL (μm) | 171 | |
| DOC (μm) | 112 | 80 |

| Example | EA120 |
|---|---|
| Composition | E34 |
| | 16 hours \| 29.3% NaNO₃/44.0% KNO₃/ |
| | 10.5% Na₂SO₄/16.2% K₂SO₄ |
| DOL (μm) | 143 |
| DOC (μm) | 98 |
| CT (MPa) | 85 |
| | 25 hours \| 29.3% NaNO₃/44.0% KNO₃/ |
| | 10.5% Na₂SO₄/16.2% K₂SO₄ |
| DOL (μm) | 162 |
| DOC (μm) | 106 |
| CT (MPa) | 112 |

As indicated by the example ion exchanged glass articles in Table 7, glass articles formed from the glass compositions having increased Young's Modulus and K_{Ic} fracture toughness as described herein may be ion exchanged in two steps to achieve desired stress profiles.

Table 8 shows the DOC and CT of example ion exchanged glass articles EA121-EA131 formed by ion exchanging glass articles having a thickness of 0.6 mm and made from example glass compositions, as indicated in Table 8, in a first ion exchange step at a temperature of 600° C. 16 hours or 25 hours in each of a 88.5% KNO₃/11.5% K₂SO₄ molten salt bath, 8.2% NaNO₃/74.1% KNO₃/1.7% Na₂SO₄/16.0% K₂SO₄ molten salt bath, 14.6% NaNO₃/58.5% KNO₃/5.3% Na₂SO₄/21.6% K₂SO₄ molten salt bath, 22.0% NaNO₃/51.2% KNO₃/7.9% Na₂SO₄/18.9% K₂SO₄ molten salt bath, and 29.3% NaNO₃/44.0% KNO₃/10.5% Na₂SO₄/16.2% K₂SO₄ molten salt bath.

TABLE 8

| Example | EA121 | EA122 | EA123 |
|---|---|---|---|
| Composition | E34 | E72 | E78 |
| | 16 hours \| 88.5% KNO₃/11.5% K₂SO₄ | | |
| DOL (um) | 187 | — | — |
| DOC (μm) | 128 | 90 | 68 |
| CT (MPa) | 219 | 121 | 99 |
| | 25 hours \| 88.5% KNO₃/11.5% K₂SO₄ | | |
| DOC (μm) | — | 97 | 80 |
| CT (MPa) | 276 | 141 | 120 |
| Example | EA124 | EA125 | EA126 |
| Composition | E34 | E72 | E78 |
| | 16 hours \| 8.2% NaNO₃/74.1% KNO₃/ | | |
| | 1.7% Na₂SO₄/16.0% K₂SO₄ | | |
| DOL (um) | 177 | — | — |
| DOC (μm) | 116 | 80 | 60 |
| CT (MPa) | 154 | 80 | 62 |
| | 25 hours \| 8.2% NaNO₃/74.1% KNO₃/ | | |
| | 1.7% Na₂SO₄/16.0% K₂SO₄ | | |
| DOL (μm) | 222 | — | — |
| DOC (μm) | 136 | 94 | 69 |
| CT (MPa) | 192 | 97 | 72 |

| Example | EA127 | EA128 |
|---|---|---|
| Composition | E34 | E72 |
| | 16 hours \| 14.6% NaNO₃/58.5% KNO₃/ | |
| | 5.3% Na₂SO₄/21.6% K₂SO₄ | |
| DOL (μm) | 161 | — |
| DOC (μm) | 110 | 74 |
| CT (MPa) | 114 | 67 |
| | 25 hours \| 14.6% NaNO₃/58.5% KNO₃/ | |
| | 5.3% Na₂SO₄/21.6% K₂SO₄ | |
| DOL (μm) | 194 | — |
| DOC (μm) | 128 | 89 |
| CT (MPa) | 135 | 74 |
| Example | EA129 | EA130 |
| Composition | E34 | E72 |
| | 16 hours \| 22.0% NaNO₃/51.2% KNO₃/ | |
| | 7.9% Na₂SO₄/18.9% K₂SO₄ | |
| DOL (μm) | 142 | — |
| DOC (μm) | 106 | 72 |
| CT (MPa) | 87 | 46 |

| Example | EA131 |
|---|---|
| Composition | E34 |
| | 16 hours \| 29.3% NaNO₃/44.0% KNO₃/ |
| | 10.5% Na₂SO₄/16.2% K₂SO₄ |
| DOL (μm) | 120 |
| DOC (μm) | 103 |
| CT (MPa) | 68 |

As indicated by the example ion exchanged glass articles in Table 8, glass articles formed from the glass compositions having increased Young's Modulus and K_{Ic} fracture toughness as described herein may be ion exchanged in two steps to achieve desired stress profiles.

Table 9 shows the DOC and CT of example ion exchanged glass articles EA132 and EA133 formed by ion exchanging glass articles having a thickness of 0.5 mm and made from example glass compositions, as indicated in Table 9, in a first ion exchange step at a temperature of 600° C. 22 and 16 hours in each of a 29.3% NaNO₃/44.0% KNO₃/10.5% Na₂SO₄/16.2% K₂SO₄ molten salt bath and 25.6% NaNO₃/47.6 KNO₃/9.2% Na₂SO₄/17.6% K₂SO₄ molten salt bath, respectively. Table 9 also shows the DOC and CT of the glass articles achieved by subjecting the glass articles to a second ion exchange step at a temperature of 370° C. for 0.25 hours in a 100% KNO₃ molten salt bath.

TABLE 9

| Example | EA132 |
|---|---|
| Composition | E34 |
| | Step 1-22 hours \| 29.3% NaNO₃/44.0% KNO₃/ |
| | 10.5% Na₂SO₄/16.2% K₂SO₄ |
| DOC (μm) | 109 |
| CT (MPa) | 95 |
| | Step 2-0.25 hours \| 100% KNO₃ |
| Knee (μm) | 6 |
| Knee Stress (MPa) | 135 |
| DOC (μm) | 103 |
| CT (MPa) | 100 |
| Example | EA133 |
| Composition | E34 |
| | Step 1-16 hours \| 25.6% NaNO₃/47.6 KNO₃/ |
| | 9.2% Na₂SO₄/17.6% K₂SO₄ |
| DOC (μm) | 100 |
| CT (MPa) | 97 |
| | Step 2-0.25 hours \| 100% KNO₃ |
| Knee (μm) | 7 |
| Knee Stress (MPa) | 143 |
| DOC (μm) | 98 |
| CT (MPa) | 91 |

As indicated by the example ion exchanged glass articles in Table 9, a glass article formed from the glass composition having increased Young's Modulus and K_{Ic} fracture toughness as described herein may be ion exchanged in two steps to achieve desired stress profiles.

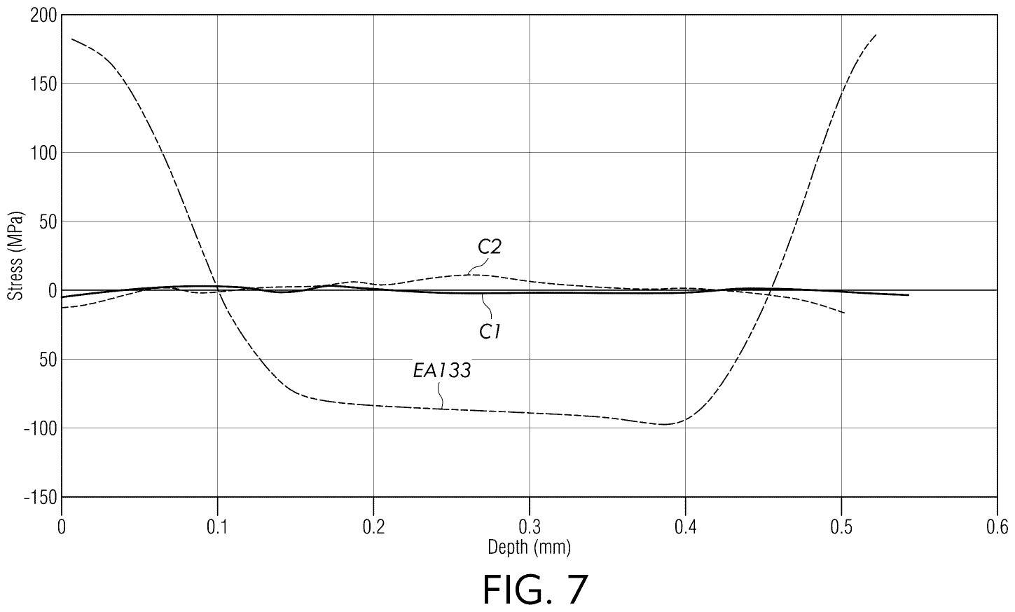

Referring now to FIG. 7, the stress profile of glass article EA133 having a thickness 0.5 mm were compared to the stress profiles of C1 and C2. The graph shows that after the 600° C. ion exchange step, the C1 and C2 examples exhibit more stress relaxation than E140. C1 and C2 have strain points of 553° C. and 572° C., respectively. Without wishing to be bound by any theory, it is believed that the relatively low strain points of C1 and C2 resulted in stress relaxation of C1 and C2. In contrast, E133, having a strain point of 690° C., did not show the same undesirable amount of stress relaxation. The relatively high strain point is at least partially the result of the relatively high alumina content. For example, E133 contains 19.05 mol % alumina, while C1 and C2 contain 10.29 mol % and 12.69 mol % alumina, respectively. Additionally, the relatively high strain is also at least partially attributed to the high alkaline earth oxide content of the glass, such as CaO and MgO. For example, E133 contains a combined CaO and MgO content of 7.96 mol %. In contrast, C1 and C2 contain CaO and MgO in amounts of 6.33 mol % and 2.40 mol %, respectively. The alumina content and alkaline-earth content of the compositions disclosed herein, such as E133, allow for highly polymerized glass networks to form with higher bond strengths, which yields higher strain points, resulting in the knee region seen in the stress profile of E133 of FIG. 7.

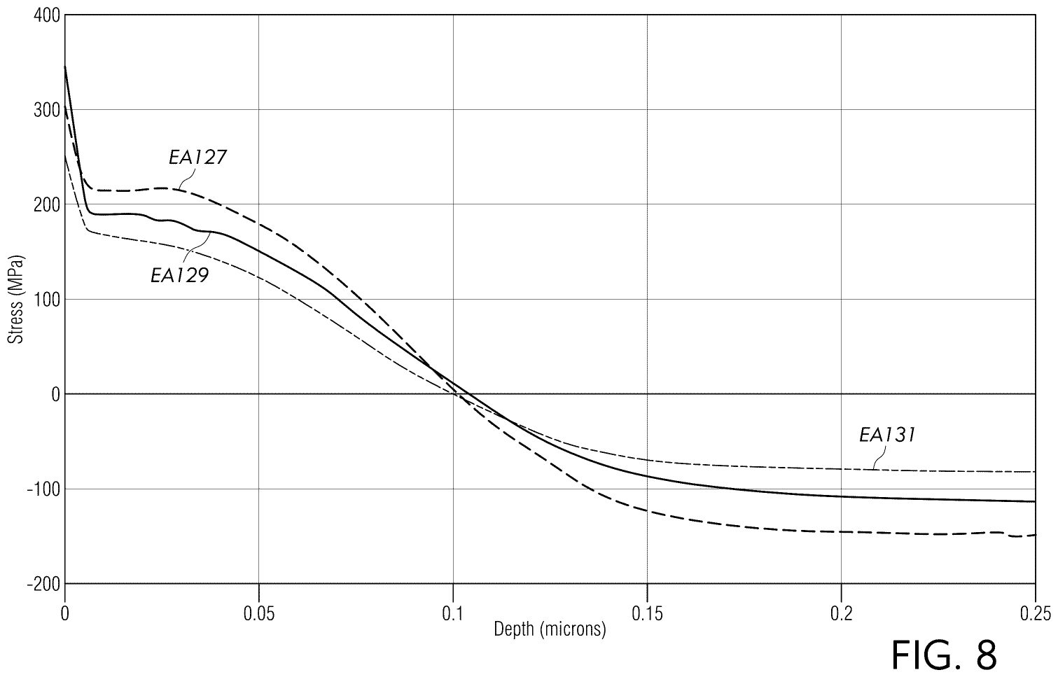

Referring now to FIG. 8, the stress profile of glass articles EA127, EA129, and EA131 with 0.5 mm thickness are comparatively displayed. The glass articles were ion exchanged at 600° C. for 16 hours in each of a 14.6% NaNO₃/58.5% KNO₃/5.3% Na₂SO₄/21.6% K₂SO₄ molten salt bath, 22.0% NaNO₃/51.2% KNO₃/7.9% Na₂SO₄/18.9% K₂SO₄ NaNO₃ molten salt bath, and 29.3% NaNO₃/44.0% KNO₃/10.5% Na₂SO₄/16.2% K₂SO₄ molten salt bath, respectively. As shown in FIG. 8, all of the glass articles included a knee region.

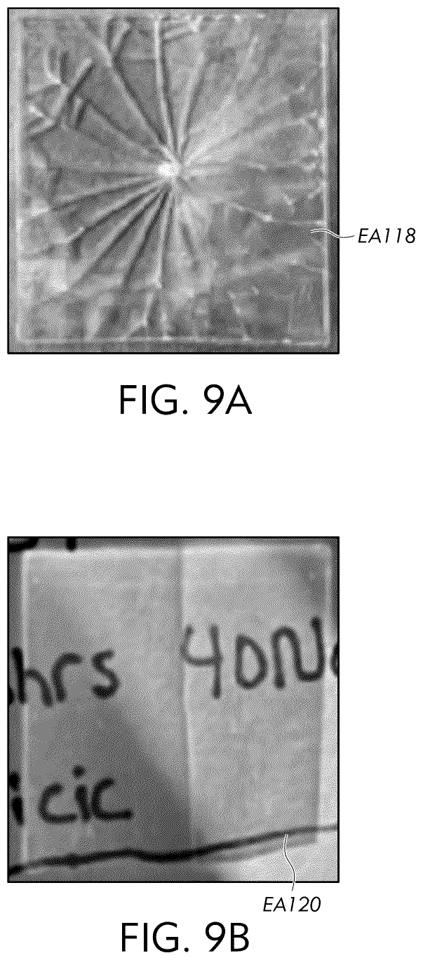

As shown in FIG. 9A, the glass article EA118 was frangible. Referring now to FIG. 9B, the glass article EA120 was non-frangible. Both EA118 and EA120 were both formed from example glass composition E34, but subjected to different molten salt baths. As indicated by the examples ion exchanged glass articles in FIGS. 9A and 9B, a glass article formed from a glass composition having increased Young's Modulus and K_{Ic} fracture toughness as described herein may be subjected to various ion exchange conditions to produced non-frangible glass articles.

Table 10 below shows EA134 after being ion exchanged at 600° C. for 16 hours in a 25.6% NaNO₃/47.6 KNO₃/9.2% Na₂SO₄/17.6% K₂SO₄ molten salt bath.

TABLE 10

| Example | EA134 |
|---|---|
| Composition | E34 |
| | 16 hours \| 25.6% NaNO₃/47.6 KNO₃/ |
| | 9.2% Na₂SO₄/17.6% K₂SO₄ |
| DOL (μm) | 146 |
| DOC (μm) | 100 |
| CT (MPa) | 97 |

As indicated by the example ion exchanged glass articles in Table 10, a glass article formed from the glass composition having increased Young's Modulus and K_{Ic} fracture toughness as described herein may be ion exchanged in two steps to achieve desired stress profiles.

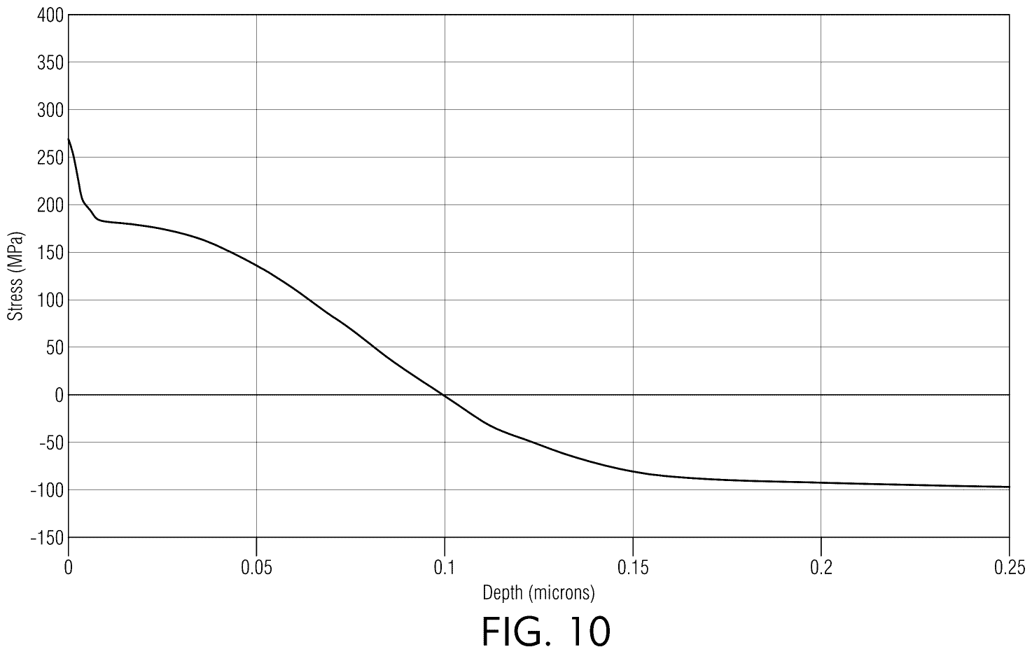

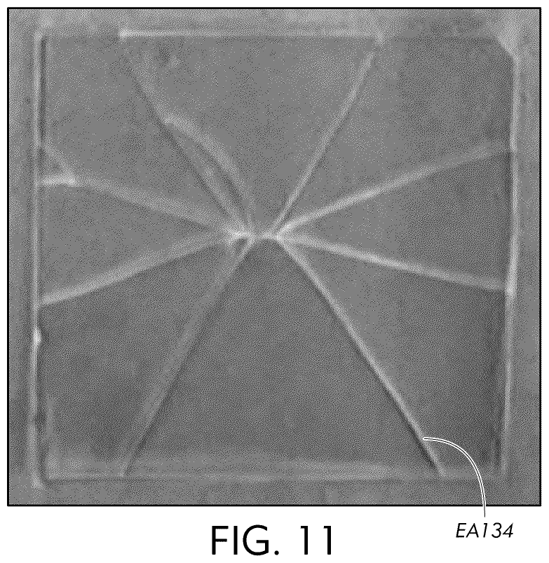

Referring now to FIG. 10, the stress profile of EA134 is shown. As shown in FIG. 10, the glass article EA134 has a knee region. FIG. 11 shows the glass article EA134 is borderline frangible.

Table 11 below shows glass articles EA121 and EA135-EA138 when subjected to a varying time of 16, 19, 22, and 25 hours at 600° C. in a 29.3% NaNO₃/44.0% KNO₃/10.5% Na₂SO₄/16.2% K₂SO₄ molten salt bath.

TABLE 11

| | IOX Time (hours) | | | | |
|---|---|---|---|---|---|
| | 16 | 19 | 22 | 22 | 25 |
| Example | EA120 | EA135 | EA136 | EA137 | EA138 |
| Composition | E34 | | | | |
| DOL (μm) | 143 | 153 | 160 | 154 | 162 |
| DOC (μm) | 98 | 102 | 109 | 107 | 106 |
| CT (MPa) | 85 | 90 | 95 | 88 | 112 |

As indicated by the example ion exchanged glass articles in Table 11, a glass article formed from the glass composition having increased Young's Modulus and K_{Ic} fracture toughness as described herein may be ion exchanged in two steps to achieve desired stress profiles.

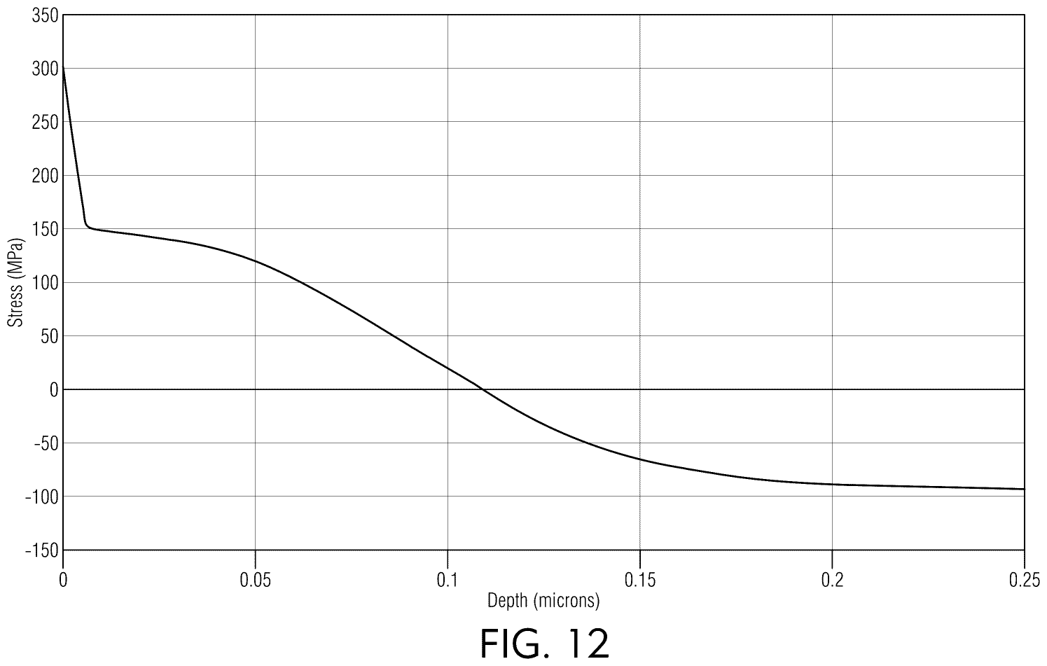

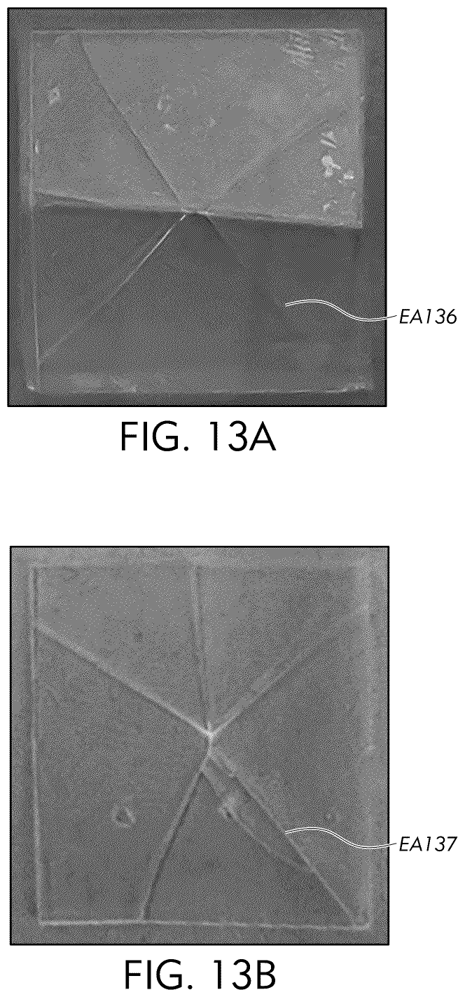

Referring now to FIG. 12, the stress profile of EA136 is shown. As shown in FIG. 12, the glass article EA136 has a knee region. FIG. 13A shows the glass article EA136 is borderline frangible. FIG. 13B shows the glass article EA137 is also borderline frangible.

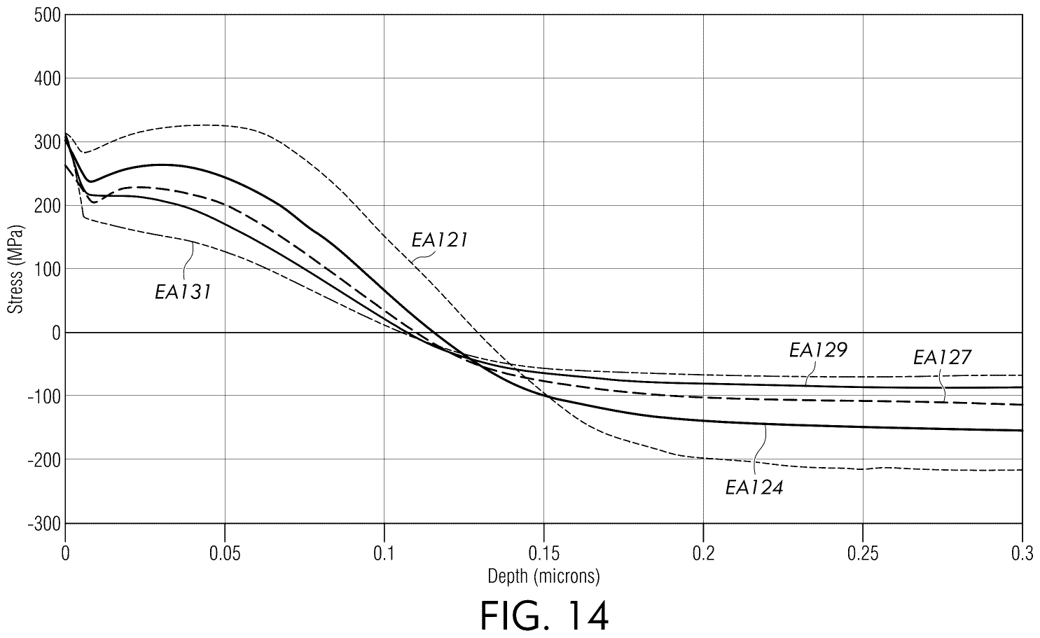

Referring now to FIG. 14, the stress profile of glass articles EA121, EA124, EA127, EA 129, and EA131 with 0.6 mm thickness are comparatively displayed. The glass articles were ion exchanged at 600° C. for 16 hours in each of a 88.5% KNO₃/11.5% K₂SO₄ molten salt bath, 8.2% NaNO₃/74.1% KNO₃/1.7% Na₂SO₄/16.0% K₂SO₄ molten salt bath, 14.6% NaNO₃/58.5% KNO₃/5.3% Na₂SO₄/21.6% K₂SO₄ molten salt bath, 22.0% NaNO₃/51.2% KNO₃/7.9% Na₂SO₄/18.9% K₂SO₄ molten salt bath, and 29.3% NaNO₃/44.0% KNO₃/10.5% Na₂SO₄/16.2% K₂SO₄ molten salt bath, respectively. As shown in FIG. 14, all of the glass articles included a knee region.

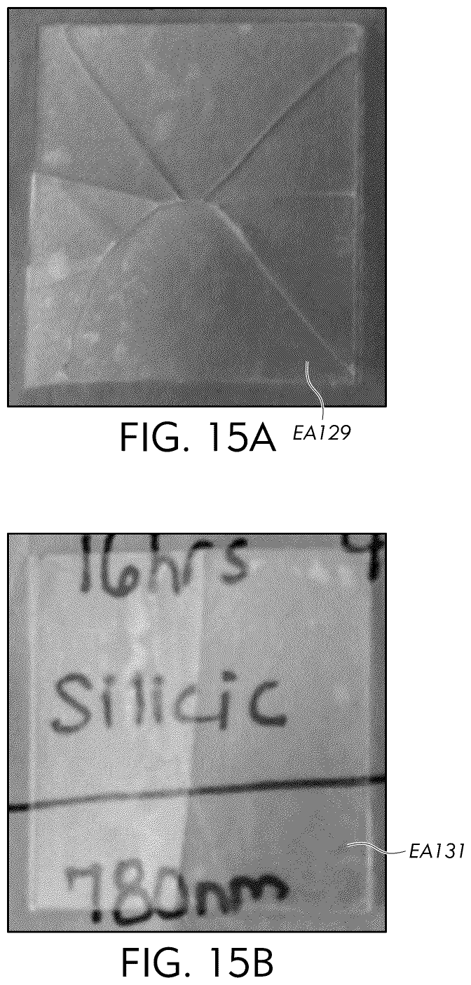

As shown in FIG. 15A, the glass article EA129 was frangible. Referring now to FIG. 15B, the glass article EA131 was non-frangible. Both EA129 and EA131 were both formed from example glass composition E34, but subjected to different molten salt baths. As indicated by the examples ion exchanged glass articles in FIGS. 14A and 14B, a glass article formed from a glass composition having increased Young's Modulus and K_{Ic} fracture toughness as described herein may be subjected to various ion exchange conditions to produce non-frangible glass articles.

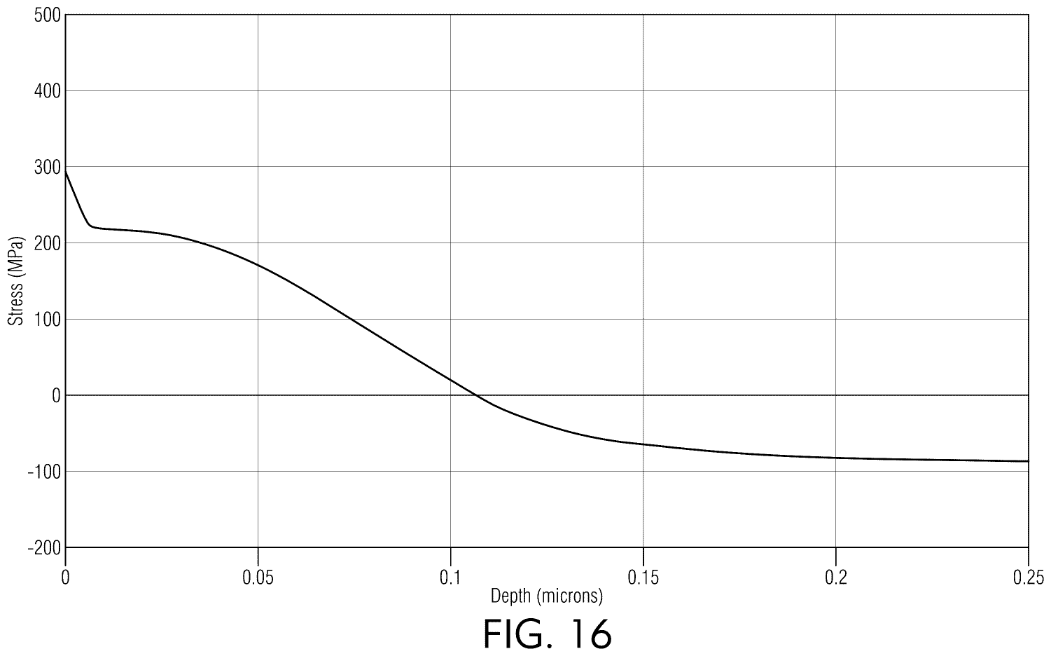

Referring now to FIG. 16, the stress profile of EA129 is shown. As shown in FIG. 16, the article EA133 has a knee region.

Table 12 below shows glass articles EA139 when subjected to an ion exchange time of 20 hours at 600° C. in a 25.6% NaNO₃/47.6 KNO₃/9.2% Na₂SO₄/17.6% K₂SO₄ molten salt bath.

TABLE 12

| IOX Time (hours) | 20 |
|---|---|
| Example | EA139 |
| Composition | E34 |
| DOL (μm) | 145 |
| DOC (μm) | 112 |
| CT (MPa) | 94 |

As indicated by the example ion exchanged glass articles in Table 12, a glass article formed from the glass composition having increased Young's Modulus and K_{Ic} fracture toughness as described herein may be ion exchanged in two steps to achieve desired stress profiles. RNF was used to measure the DOL value reported in Table 12.

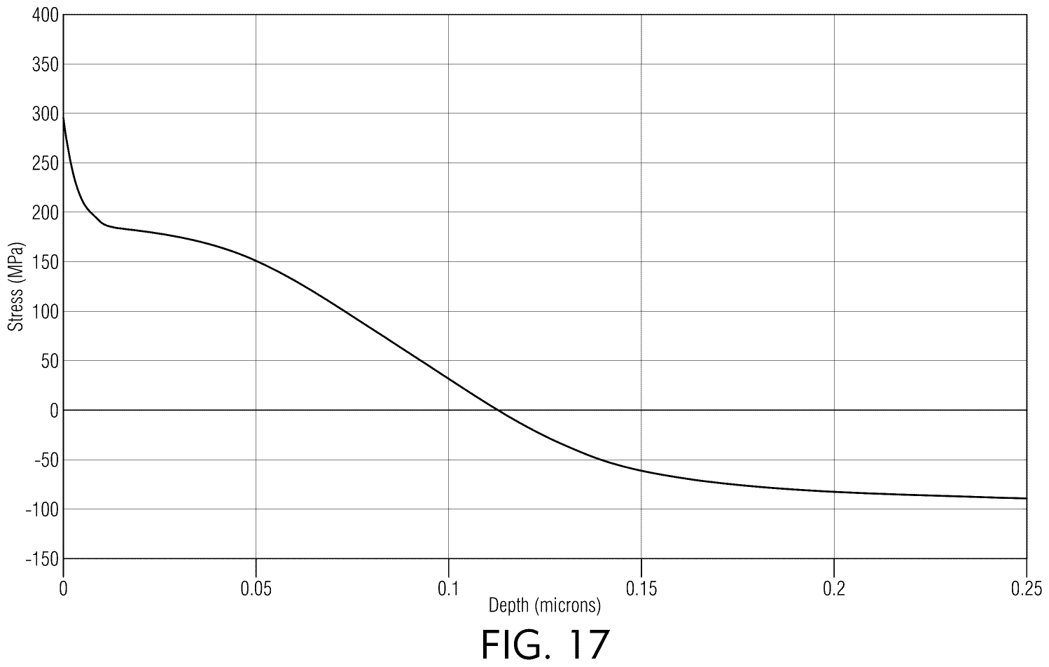

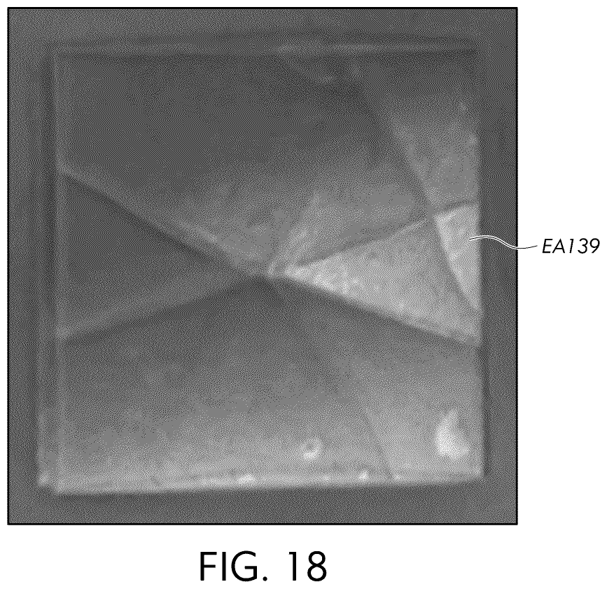

Referring now to FIG. 17 the stress profile of EA139 is shown. As shown in FIG. 17, the article EA139 has a knee region. FIG. 18 shows the glass article EA139 is borderline frangible.

Referring now to FIG. 19, example ion exchanged glass articles EA140 and EA141 were formed by ion exchanging glass articles having a thickness of 0.5 mm and made from example glass compositions E34 and E80, respectively, for a first ion exchange in a 25.6% NaNO₃/47.6 KNO₃/9.2% Na₂SO₄/17.6% K₂SO₄ molten salt bath at 600° C. for 16 hours and then second ion exchange in a 100% KNO₃ molten salt bath at 370° C. for 0.17 hour (10 minutes). Table 13 shows the DOC, CT, Knee, and Knee Stress of ion exchanged glass articles EA140 and EA141. Knee and Knee Stress were measured by RNF.

TABLE 13

| Example | EA140 | EA141 |
|---|---|---|
| Composition | E34 | E80 |
| Knee (μm) | 8 | 7 |
| Knee Stress (MPa) | 172 | 167 |
| DOC (μm) | 97 | 88 |
| CT (MPa | 101 | 89 |

Example glass composition E34, a glass composition including 0.24 mol % P₂O₅, had a liquidus viscosity 60° C. less than example glass composition E80, a glass composition including 0 mol % P₂O₅. Moreover, example ion exchanged glass article EA140, formed from example glass composition E34 including 0.24 mol % P₂O₅, had a greater DOC and CT than example ion exchanged glass article EA141, formed from example glass composition E80 including 0 mol % P₂O₅. While not wishing to be bound by theory, it is believed that the relatively increased DOC and CT of example ion exchanged glass article EA140 was imparted by P₂O₅ increasing the diffusivity of the glass article.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A glass composition comprising:
greater than or equal to 50 mol % and less than or equal to 70 mol % SiO₂;
greater than or equal to 15 mol % and less than or equal to 30 mol % Al₂O₃;
greater than or equal to 5 mol % and less than or equal to 20 mol % Na₂O;
greater than or equal to 0 mol % and less than or equal to 15 mol % MgO; and
greater than or equal to 0 mol % and less than or equal to 15 mol % CaO, wherein the glass composition is free or substantially free of Li; and
RO is greater than 0 mol % and less than or equal to 30 mol %, wherein RO is the sum of MgO and CaO.

2. The glass composition of claim 1, wherein the glass composition comprises greater than or equal to 16 mol % and less than or equal to 28 mol % Al₂O₃.

3. The glass composition of claim 1, wherein the glass composition comprises greater than or equal to 7 mol % and less than or equal to 18 mol % Na₂O.

4. The glass composition of claim 1, wherein the glass composition comprises greater than 0 mol % and less than or equal to 13 mol % MgO.

5. The glass composition of claim 1, wherein the glass composition comprises greater than 0 mol % and less than or equal to 13 mol % CaO.

6. The glass composition of claim 1, wherein RO is greater than or equal to 1 mol % and less than or equal to 25 mol %.

7. The glass composition of claim 1, wherein (Na₂O+RO)/Al₂O₃ is greater than or equal to 0.5 and less than or equal to 1.5.

8. The glass composition of claim 1, wherein the glass composition comprises greater than 0 mol % and less than or equal to 5 mol % P₂O₅.

9. The glass composition of claim 1, wherein the glass composition comprises greater than 0 mol % and less than or equal to 10 mol % Y₂O₃.

10. The glass composition of claim 1, wherein the glass composition comprises greater than 0 mol % and less than or equal to 5 mol % ZrO₂.

11. The glass composition of claim 1, wherein the glass composition comprises greater than 0 mol % and less than or equal to 1 mol % SnO₂.

12. The glass composition of claim 1, wherein the glass composition has a Young's Modulus greater than or equal to 60 GPa.

13. The glass composition of claim 1, wherein the glass composition has a fracture toughness greater than or equal to 0.75 MPa·m^{1/2}.

14. The glass composition of claim 1, wherein the strain point is greater than or equal to 600° C.

15. A method of forming a glass article, the method comprising:
heating a glass composition, the glass composition comprising:
greater than or equal to 50 mol % and less than or equal to 70 mol % SiO₂;
greater than or equal to 15 mol % and less than or equal to 30 mol % Al₂O₃;
greater than or equal to 5 mol % and less than or equal to 20 mol % Na₂O;
greater than or equal to 0 mol % and less than or equal to 15 mol % MgO; and
greater than or equal to 0 mol % and less than or equal to 15 mol % CaO, wherein the glass composition is free or substantially free of Li; and
RO is greater than 0 mol % and less than or equal to 30 mol %, wherein RO is the sum of MgO and CaO; and
cooling the glass composition to form the glass article.

16. The method of claim 15, further comprising strengthening the glass article in a first ion exchange bath at a temperature greater than or equal 500° C. for a time period greater than or equal to 1 hour and less than or equal to 32 hours to form an ion exchanged glass article.

17. The method of claim 16, further comprising strengthening the glass article in a second ion exchange bath at a temperature greater than or equal to 300° C. for a time period greater than or equal to 1 hour and less than or equal to 32 hours to form an ion exchanged glass article.

18. The method of claim 16, wherein the ion exchanged glass article comprises a surface compressive stress greater than or equal to 350 Mpa and less than or equal to 900 MPa, and a depth of compression greater than or equal to 80 μm.

19. The method of claim 15, wherein the first ion exchange bath, the second ion exchange bath, or both comprises KNO₃.

20. The method of claim 15, wherein the first ion exchange bath, the second ion exchange bath, or both comprises NaNO₃.
